(19) United States
(12) Patent Application Publication
(10) Pub. No.: US 2026/0366922 A1
(43) Pub. Date: Nov. 19, 2026

(54) SPECTROGRAPHY OF PHOTONIC QUANTUM STATES

(71) Applicant: California Institute of Technology, Pasadena, CA (US)

(72) Inventors: Thomas Zacharias, San Gabriel, CA (US); Elina M. Sendonaris, Pasadena, CA (US); Robert M. Gray, Pasadena, CA (US); Alireza Marandi, Pasadena, CA (US)

(73) Assignee: California Institute of Technology, Pasadena, CA (US)

(21) Appl. No.: 19/666,832

(22) Filed: May 4, 2026

Related U.S. Application Data
(60) Provisional application No. 63/799,019, filed on May 2, 2025.

(51) Int. Cl. G01J 3/40; G01J 3/12; G01J 3/28; G02F 1/35; G02F 1/39; G06N 10/40

(52) U.S. Cl. CPC G01J 3/40; G01J 3/12; G01J 3/2823; G02F 1/3507; G02F 1/392; G06N 10/40

(57) ABSTRACT

A system for extracting information about an unknown photonic quantum state by making inferences on its measured spectrogram. Information gained from this technique can include modal structure, entanglement properties, quantum state tomographic information, among others. The scheme offers an experimentally simpler, hardware-efficient route for photonic quantum state characterization.

### CROSS REFERENCE TO RELATED APPLICATIONS

This application claims the benefit under 35 U.S.C. Section 119(e) of U.S. Provisional Application No. 63/799,019, filed May 2, 2025, by Thomas Zacharias, Elina Sendonaris, Robert M. Gray, Alireza Marandi, entitled “SPECTROGRAPHY OF PHOTONIC QUANTUM STATES” (CIT-9310-P), which application is incorporated by reference herein.

### STATEMENT REGARDING FEDERALLY SPONSORED RESEARCH AND DEVELOPMENT

This invention was made with government support under Grant No. FA9550-23-1-0755 awarded by the Air Force and under Grant no. W911NF-23-1-0048 awarded by the Army and under Grant no. D23AP00158-00 awarded by the Department of the Interior. The government has certain rights in the invention.

### BACKGROUND OF THE INVENTION

### 1. Field of the Invention

The present disclosure relates to systems and methods for characterizing quantum states.

### 2. Description of the Related Art

Ultrafast optics offers substantial opportunities for quantum electromagnetic field measurements [1-3], spectroscopy and microscopy [4-6], light-matter interactions [7-9], and information processing [10-12] by providing access to terahertz-scale bandwidths. Such bandwidths have enabled the creation of entangled quantum states in the form of broadband frequency combs [10, 11, 13-19]. Moreover, the large peak powers available in ultrashort pulses combined with dispersion-engineered nonlinear nanophotonic platforms provide an additional opportunity for enhanced nonlinear processes [20], placing non-Gaussian operations and states in the horizon [21].

Despite substantial progress in a wide range of quantum optics experiments using ultrashort pulses [13-16, 22-25], these experiments typically fall short of utilizing the temporal characteristics of quantum fluctuations in the few-cycle and sub-cycle regime. Such a capability requires advancing the current measurement schemes which would greatly broaden the scope and scalability of ultrafast quantum optics. The most common techniques for characterization of ultrashort-pulse quantum states rely on projective measurements using pulse shaping, whose bandwidth and resolution are limited by the local oscillator and ultrafast pulse shaper [11, 13-16, 22, 23, 26-28]. Most detection strategies require mode-matched local oscillators [16] or reconfigurable mode projections with optimization through feedback loops [26, 64]. Some techniques have a tradeoff between the amount of information gained about the state and the modes [60], and others rely on prior knowledge about the state [12, 61]. Quantum pulse gates can decompose the state into multiple modes by shaping a pump pulse [25, 62, 63] and have been used to decompose a state into its component modes adaptively [61, 29], but they require engineered nonlinearities and precise control of the pump in addition to knowledge of the modes. Decomposition of data measured using homodyne detection [11, 16] can also be used to identify the principal modes of a state. In parallel, electro-optic sampling [30] is also used for this purpose, but has been so far restricted to mid-infrared [1, 2] and terahertz quantum pulses [3] while requiring probe pulses shorter than the wavelength of interest.

By contrast, for classical characterization of ultrashort pulses, FROG [31] has been one of the most widely used techniques [32], standing out for its experimental simplicity and high performance. FROG involves measuring a spectrogram followed by 2D phase retrieval to find the complex field profile of the ultrashort pulse. This technique has inspired an entire class of spectrographic measurement tools that have become the standard for classical ultrafast pulse characterization. Examples include the measurement of ultrabroadband pulses [33], single cycle pulses [34, 35], ultraweak pulses [36, 37], attosecond pulses [38], and more [31].

Using FROG for multimode quantum pulse characterization has remained challenging because it requires: (1) analytically formulating the quantum pulse spectrograms; (2) developing suitable phase-retrieval algorithms; (3) meeting measurement sensitivity requirements; and (4) accessing quadrature statistics of associated states. Although the analytical form of a quantum spectrogram has been observed to be distinct from that of a classical spectrogram, finding appropriate retrieval algorithms and measuring microscopic states has remained an outstanding problem [39]. Phase retrieval techniques using single photon coincidence measurements [40, 41] have enabled ultrafast photon-pair characterization, but the experimentally simpler spectrographic techniques have remained elusive. Importantly, these techniques [39-41] do not access quadrature information required for continuous-variable quantum optics.

What is needed are techniques that leverage the experimental simplicity, hardware efficiency, and wide availability of spectrographic measurement tools for temporal mode tomography to measure photonic quantum states. The present disclosure satisfies this need.

### SUMMARY OF THE INVENTION

Illustrative embodiments include, but are not limited to, the following.
1. A system, comprising an optical system outputting a spectrogram comprising time dependent magnitudes of frequency components in response to, and dependent on, an input photonic quantum state; and a processor inferring information about the input photonic quantum state from the spectrogram, wherein the information includes temporal and/or frequency structure and/or quantum state information about the input photonic quantum state.
2. The system of clause 1 wherein the optical system comprises a delay mechanism delaying the input photonic quantum state relative to an auxiliary photonic state; one or more nonlinear media interacting the input photonic state and the auxiliary photonic state states through one or more nonlinear optical processes to generate a third photonic state; and a spectrometer measuring the spectrum of the third photonic state for different relative delays.
3. The system of clause 1 wherein the inferring comprises the processor executing an algorithm through non-iterative, iterative, phase-retrieval, machine learning, or deep learning techniques.
4. The system of clause 1 wherein the processor calculates quantum state properties by comparing the measured spectrogram to a calculated spectrogram using optimization, estimation, or inverse methods.
5. The system of clause 2, wherein the delay mechanism comprises a mechanically moving (e.g,. translation) stage.
6. The system of clause 2, wherein the delay mechanism is produced using a photonic dual-comb configuration.
7. The system of clause 2, wherein the delay mechanism further comprises a system to map temporal delays to distinct spatial locations.
8. The system of clause 2 wherein auxiliary photonic state is a copy of the input photonic quantum state, Gaussian or non-Gaussian, and may or may not be characterized apriori.
9. The system of clause 2 wherein the spectrometer can measure the spectrum of the third photonic state in the photon number basis using one or more single photon detectors or one or more photon number resolving detectors.
10. The system of clause 2 wherein the spectrometer can measure the spectrum of the third photonic state in a quadrature basis using homodyne, heterodyne, or a phase-sensitive nonlinear interaction with auxiliary radiation as a local oscillator/gate/pump.
11. The system in clause 2 wherein the spectrometer is operable to measure the spectrogram in a pulse-by-pulse format and wherein at least one of the photonic states comprises periodic pulses.
12. The system in clause 2 wherein the temporal delays are mapped to distinct spatial locations within a nonlinear crystal followed by an imaging spectrometer that measures the spectrogram of the resulting photonic state.
13. The system of clause 2 wherein the optical system comprises one or more of the nonlinear media implementing at least two nonlinear processes, where one or more of the nonlinear processes map physical parameters of the input quantum state to physical parameters of intermediate states generated through these processes to prepare the state for spectrographic measurement using a final nonlinear optical process, wherein physical parameters being mapped include at least one of quadrature information, photon number, frequency, polarization, temporal characteristics, or spatial characteristics.
14. The system of clause 1 wherein the optical system comprises a Frequency Resolved Optical Gating (FROG)- based scheme comprising a nonlinear medium wherein the optical nonlinear process comprises a phase-sensitive parametric amplification process such that the information inferred includes the expectation values of second order polynomials of quadrature operators (second-order quadrature moments) and the complex temporal envelope describing a temporally localized quantum state (temporal mode profiles).
15. The system of clause 1 wherein the optical system comprises a FROG-based scheme comprising a nonlinear medium wherein the nonlinear optical process comprises a phase-insensitive process, such as sum-frequency generation, such that the information inferred includes the temporal mode profiles and mean photon number per mode.
16. The system of clause 1 wherein the optical system comprises a FROG-based scheme comprising a nonlinear medium wherein the nonlinear process is a second- or higher-order process in which the state interacts with itself, giving information on fourth- or higher-order operator moments.
17. The system of clause 1 wherein the optical system comprises one or more nonlinear media wherein the input photonic state goes through a phase sensitive amplification process followed by sum frequency generation cross-FROG wherein the information inferred includes at least one of (1) characterization of the phase sensitive amplification process, (2) characterization of the second order quadrature moments of the input photonic quantum state in the temporal, amplifier, and/or independent bases, or (3) the temporal mode profiles.
18. The system of clause 2 wherein the information extracted can characterize the auxiliary photonic state used for the spectrogram measurement.
19. The system of clause 1 wherein the information extracted can include correlations of multimode annihilation and quadrature operators in the temporal, frequency, independent, or an arbitrary basis along with the associated unitary transformations describing the associated mode profiles.
20. The system of clause 1 wherein the information extracted can include multimode entanglement criteria and entanglement structure reconstruction including those for Gaussian or non-Gaussian states.
21. The system of clause 1 wherein the information extracted can include quantum quasi-probability distribution functions, such as the Wigner, Q-, and P-functions.
22. The system of clause 1 configured or implemented as sub-system for implementing quantum information processing, communication, or sensing.

In one embodiment, FROG is demonstrated for characterizing ultrafast squeezed vacuum. By combining phase-sensitive amplification on a nanophotonic OPA with an SFG-XFROG and a multimode retrieval algorithm, we retrieve complex principal modes, fractional mode energies, and temporal-basis correlation matrices of an amplified quantum pulse. Calibrating for the OPA allows us to reconstruct the squeezed quadrature correlation matrix and to recover four temporal modes with squeezing levels −7.1, —5.9, −2.3, +0.9 dB on chip. Given its experimental simplicity, compatibility with integrated platforms, and intrinsic high bandwidth and resolution, quantum FROG provides a versatile measurement tool and naturally interfaces with applications in temporal-mode quantum information processing, nonclassical sensing, and nonlinear quantum optics.

In another embodiment, a system is disclosed for characterizing temporally multimode squeezed states useful for applications in quantum communication, information processing, and sensing). Characterizing the mode shapes is crucial for effectively manipulating these states, but current mode shape and state characterization techniques necessitate constraining assumptions and complicated experimental setups. In this embodiment, a characterization technique that simultaneously recovers the complex temporal mode shapes and quadrature variances of ultrafast multimode squeezed states based on frequency resolved optical gating (FROG) using an optical parametric amplifier (OPA). FROG is a promising tool for quantum state characterization due to its flexibility of implementation and high temporal resolution. Using an OPA as the nonlinear process in FROG has the benefit of amplifying weak quantum states to a detectable level while preserving quantum information. Numerical simulations demonstrate the recovery of the mode shapes and levels of squeezing and anti-squeezing of ultrafast multimode squeezed states. This scheme offers a practical experimental approach to measuring arbitrary temporal mode shapes and characterizing large-scale multimode ultrafast Gaussian quantum states.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1A: General scheme for using spectrographic measurement techniques to extract information about an arbitrary quantum state. In one example, the optical system performs a spectrographic measurement scheme that records any information about frequency content ω of the quantum state a(t) with a delay τ in the photon number basis N(ω, τ). The processor or inference engine can perform direct or indirect inference, for example. In an embodiment of the direct inference, the quantum state is within a spectro-temporal time bin. In an embodiment of the indirect inference, the spectrogram can be processed algorithmically to provide additional information about the quantum state e.g., temporal mode shapes. Example information includes any information that cannot be inferred by a direct spectrum measurement of the quantum state.

FIG. 1B: SFG XFROG scheme using existing SFG-XFROG for temporal mode tomography of separable quantum states. Example output information about the quantum state include Schmidt number, Schmidt coefficients, Schmidt modes, Normalized quantum correlation, matrix, spectral purity, unitary transformation between principal mode basis and complex temporal/frequency correlation matrix.

FIG. 1C: Generalized FROG based scheme. We propose using different possible combinations of delays, nonlinearities, spectrometers, and algorithms to extract useful information about the quantum state. Example output information includes nth order correlations, entanglement criteria, unitary transformation between principal mode basis and complex temporal frequency correlation matrix.

FIGS. 2A-2E show the Quantum FROG concept. FIG. 2A is a microscopic squeezed vacuum pulse to be characterized being sent through a phase-sensitive amplifier, generating a macroscopic pulse whose spectrogram is measured using FROG. FIG. 2B is the microscopic pulse represented by its temporal modes and their Gaussian quadrature statistics, illustrated as phase space ellipses. FIG. 2C shows phase-sensitive amplification transforming both the mode structure and quadrature statistics according to the amplifier mode transformation, gain transformation, and pump phase. The output macroscopic pulse has transformed temporal modes, mode energies (determined by the variance of the amplified quadrature), and Gaussian phase space distributions. FIG. 2D shows each mode having an associated single-mode spectrogram, and the sum of these spectrograms yielding the measured multimode trace. FIG. 2E shows a multimode phase-retrieval algorithm recovering the temporal modes and energies of the macroscopic pulse, wherein applying the known amplifier transformation enables recovery of quantum pulse modes and quadrature statistics.

FIGS. 3A-3H show measurement and characterization of macroscopic pulses. FIG. 3A is the experimental scheme for ultrafast squeezed vacuum generation and phase-sensitive amplification on a lithium niobate nanophotonic chip, wherein the spectrogram of the amplified pulse is measured using an SFG-XFROG. BS: High transmission beam splitter; PDH: Pound Drever Hall locking. FIG. 3B shows measured spectrograms of the amplified vacuum and amplified squeezed quadrature pulses, respectively. FIG. 3C shows the recovered spectrogram for the amplified vacuum pulse. FIG. 3D shows the recovered complex orthonormal temporal modes for the amplified vacuum pulse, wherein each inset shows the single-mode spectrogram associated with that mode. FIG. 3E shows the temporal correlation matrix amplitude and phase (inset) for the amplified vacuum pulse, wherein double arrows indicate prominent intermode correlations. FIG. 3F shows the recovered spectrogram for the amplified squeezed quadrature pulse. FIG. 3G shows the recovered complex orthonormal temporal modes for the amplified squeezed quadrature pulse, wherein each inset shows the single-mode spectrogram associated with that mode. FIG. 3H shows the temporal correlation matrix amplitude and phase (inset) for the amplified squeezed-quadrature pulse, wherein double arrows indicate prominent intermode correlations.

FIGS. 4A-4B show microscopic pulse characterization. FIG. 4A is the recovered squeezed quadrature correlation matrix of the quantum pulse in the amplifier basis, wherein diagonal terms give quadrature variances in this basis, and the off-diagonal terms represent inter-mode quadrature correlations. FIG. 4B shows the recovered temporal modes and their squeezing levels in the principal basis.

FIGS. 5A-5C show ultrabroadband measurement and recovery. FIG. 5A is the measured spectrogram of an ultrabroadband macroscopic pulse. FIG. 5B shows the recovered mode energy normalized to the total energy. FIG. 5C shows the recovered temporal correlation matrix amplitude and phase (inset).

FIGS. 6A-6C show the Separable State Generalized Projections Algorithm. FIG. 6A is the simulated multimode spectrogram expressed as a sum of single-mode spectrograms, wherein the simulated complex temporal profiles of the associated modes are displayed as solid lines in FIG. 6C. FIG. 6B is the recovered spectrogram expressed as a sum of single-mode recovered spectrograms, wherein the recovered complex temporal profiles of the associated modes are displayed as dashed lines in FIG. 6C.

FIGS. 7A-7C show SSGPA example 1. FIG. 7A shows spectrograms of the individual modes and the resulting multimode spectrogram. FIG. 7B shows retrieved spectrograms of the individual modes and the resulting multimode spectrogram. FIG. 7C shows a comparison of the retrieved (solid lines) complex mode profiles with the actual modes (dashed lines).

FIGS. 8A-8C show SSGPA example 2. FIG. 8A shows spectrograms of the individual modes and the resulting multimode spectrogram. FIG. 8B shows retrieved spectrograms of the individual modes and the resulting multimode spectrogram. FIG. 8C shows a comparison of the retrieved (solid lines) complex mode profiles with the actual modes (dashed lines).

FIGS. 9A-9H show temporal mode tomography experiment and results. FIG. 9A is the experimental scheme in which a nanophotonic OPA is pumped with an ultrashort pulse to generate an ultrafast amplified vacuum macroscopic pulse whose spectrogram is measured using an SFG-XFROG. PM: Parabolic mirror; BB: Beam block. FIG. 9B is the measured spectrogram.

FIG. 9C is the retrieved spectrogram using SSGPA. FIG. 9D shows the retrieved orthonormal complex mode profiles with their corresponding spectrograms inset. FIG. 9E shows the recovered Schmidt coefficients which are used to calculate the normalized principal correlation matrix. FIG. 9F shows normalized principal correlation matrix. FIG. 9G shows the amplitude and phase of the temporal correlation matrix calculated from the recovered Schmidt coefficients and complex temporal modes. FIG. 9H shows temporal correlation matrix phase.

FIG. 10A-10B show ultrabroadband measurement and recovery. FIG. 10A is the measured spectrogram. FIG. 10B is the recovered spectrogram.

FIG. 11: Temporally multimode Gaussian (MMG) state reconstruction process using OPA FROG. S The pulsed quantum input state and a gate pulse are put through an OPA FROG setup, and the resulting spectrogram is put into the MMG-OPA-FROG algorithm, which splits the input state up into its component modes and second-order moments.

FIG. 12: Overview of the vacuum-subtracted spectrogram, which is the measured spectrogram minus the vacuum spectrogram, which is the output when the input state is vacuum. All color bars are shared and are normalized to the maximum of the measured spectrogram. For multimode squeezed states, the vacuum-subtracted spectrogram is composed of positive elements for the anti-squeezed quadratures and negative elements corresponding to the squeezed quadratures, with two terms per mode (one positive and one negative). Negative values indicate the presence of squeezing.

FIGS. 13A-13G show simulated retrieval of an ultrafast multimode squeezed state using the MMG-OPA-FROG algorithm using a chirped Gaussian gating pulse. FIG. 13A is the simulated spectrogram, normalized such that the peak value is 1. FIG. 13B is the retrieved spectrogram, also normalized, wherein the root mean square distance loss is 0.0026. FIG. 13C is a plot of actual (black circles) and recovered (blue crosses) squeezing and anti-squeezing for each mode. FIG. 13D-FIG. 13G show recovered (colored) and actual (black) mode shapes, with the solid lines portraying amplitude and the dashed lines phase, wherein the fidelity between the actual and recovered modes is written in each plot.

FIGS. 14A-14H show performance of the algorithm in the presence of noise. FIG. 14A shows loss vs. iteration number for different amounts of noise in the spectrogram. FIG. 14B shows distributions of mode fidelity for different SNRs. FIG. 14C is an example noisy spectrogram with 15 dB SNR. FIG. 14D is the recovered spectrogram, with the noisy one as input. FIG. 14E shows actual (dots) and recovered (crosses) squeezing and anti-squeezing values from the noisy spectrogram. FIGS. 14F-FIG. 14H show recovered mode intensity (solid lines) and phase (dashed lines) from the noisy spectrogram, averaged over successful retrievals, wherein the shaded region indicates one standard deviation based on bootstrapping, and the fidelity of the recovered mode with the actual mode is inset.

FIG. 15: An experimental setup to measure the OPA FROG multimode spectrogram. The quantum pulse is amplified by a delayed gating pulse in a broadband high-gain OPA. The resulting amplified pulse is measured in a spectrometer and these spectra are combined to form the spectrogram.

FIGS. 16A-16C show spectrograms changing with rotating quadratures and adding a phase to the mode, wherein all spectrograms are generated with one 30-fs Gaussian mode and a 100-fs pump pulse, both with no chirp, and wherein the red lines are aligned to the peaks of FIG. 16A as a visual guide. FIG. 16A is the spectrogram with no rotations. FIG. 16B is the spectrogram with the quadratures rotated. FIG. 16C is the spectrogram with the quadratures rotated and a phase on the mode, wherein this action undoes the quadrature rotation such that this spectrogram is identical to FIG. 16A.

FIG. 17: Block diagram of the MMG OPA FROG algorithm. The data constraint uses the measured data to update the guess in frequency space. The nonlinear constraint enforces the form of the spectrogram based on the nonlinear action of the OPA. The mode orthonormalization step ensures the validity of the modes. An initial (usually random) guess for the shapes of the modes begins the algorithm.

FIG. 18A shows the correspondence between the squeezing angle in phase space and the relative phase between a mode and a reference point (usually another mode).

FIG. 18B shows the recovered relative phase between two modes vs. the actual relative phase, wherein unity (perfect reconstruction) is shown in gray.

FIGS. 19A-19C show recovery of the number of modes in a state. FIG. 19A shows final loss after 10,000 iterations vs. number of modes recovered for various numbers of modes in the initial spectrogram. FIG. 19B shows recovered squeezing and anti-squeezing for various numbers of modes recovered, for four modes in the spectrogram, wherein the error bars are over five recoveries with different initial guesses for the mode shapes. FIG. 19C shows loss vs. iteration number for different numbers of modes recovered for four modes in the spectrogram, wherein the filled in regions represent the standard deviation over five recoveries.

FIG. 20: Retrieval time vs. number of modes in the retrieval.

FIG. 21: Example Hardware environment.

FIG. 22: Example network environment.

FIG. 23: Flowchart illustrating a method of making a system.

FIG. 24: Flowchart illustrating a method of measuring a quantum state.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

### TERMINOLOGY

Optical: any electromagnetic signal (across the entire electromagnetic spectrum) that can be probed with spectrographic techniques to recover information about the signal. Examples include but are not limited to pulses of light, frequency modulated continuous wave (FMCW), etc.
Spectrogram: any record of information (through a direct experimental measurement, series of measurements, through processing of measurements) about frequency variations of an optical signal over time.
Quantum: any electromagnetic signal that exhibits non-classical properties and cannot be modeled sufficiently by Maxwell's equations.
Temporal mode tomography: Any information obtained from a spectrogram about the time-frequency structure of the quantum state that cannot be learnt by a direct spectrum measurement.

### General Scheme

A quantum optical state is measured using an experimental spectrographic measurement technique and inferences are made on the measured state to learn some information about the measured quantum state.

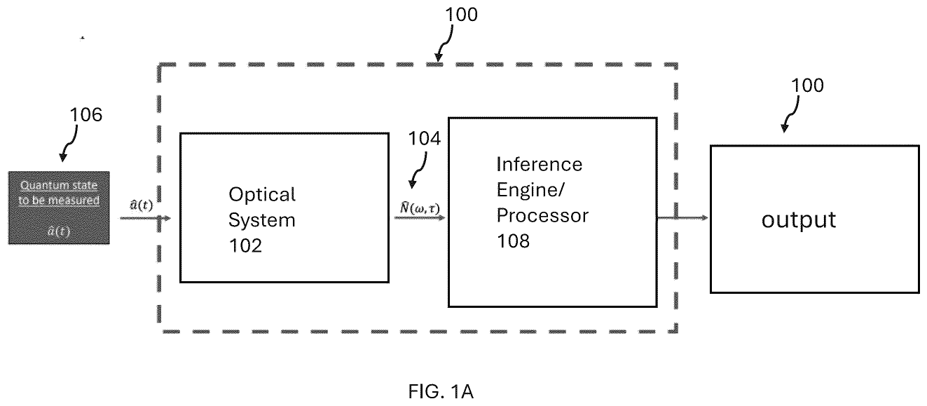

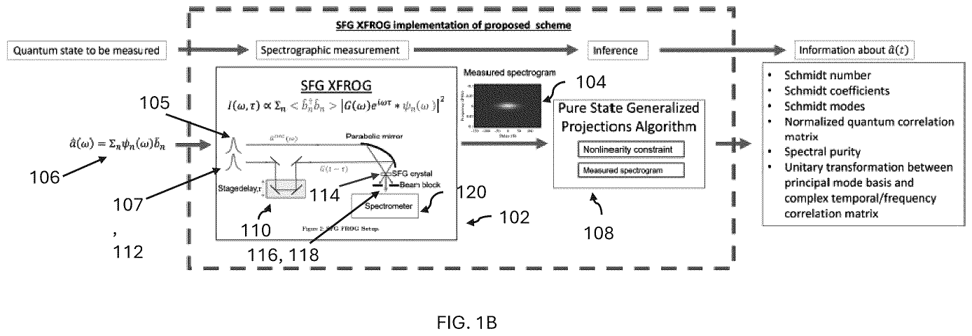

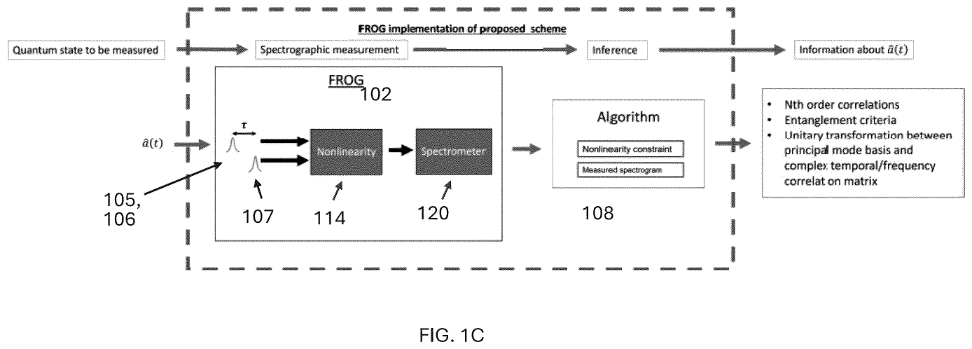

FIG. 1A provides an overview of a scheme for measuring a quantum state. The spectrogram of a quantum optical state contains information about the frequency variations of the state over time. This can be used to learn about the structure of the quantum state in the time-frequency domain. This may be done by directly making inferences on the spectrogram or by processing the spectrogram through various algorithms.

FIGS. 1A-1C illustrate various embodiments of a system 100, comprising an optical system 102 outputting a spectrogram 104 comprising time dependent magnitudes of frequency components in response to, and dependent on, an input photonic quantum state 106; and a processor 108 inferring information about the input photonic quantum state from the spectrogram, wherein the information includes temporal frequency structure and/or quantum state information about the input photonic quantum state. In the embodiments shown in FIGS. 1A-1C, the optical system comprises one or more delay mechanisms 110 delaying an optical pulse 105 comprising the input photonic quantum state 106 relative to one or more auxiliary optical pulses 107 comprising an auxiliary photonic state 112; and one or more nonlinear media 114 interacting the two states 106, 112 through nonlinear optical processes to generate an output pulse 116 comprising a third photonic state 118; and a detector or detection system 120 (e.g., spectrometer) measuring the spectrum (the spectrogram 104) of the third photonic state for different relative time delays.

Each component of the scheme is described detail in the following sections.

### Example Quantum States to be Measured

The quantum state to be measured can be described by its annihilation operator in the time domain as â(t). Our technique extracts information about a quantum state in the time-frequency domain. The quantum state being measured can be arbitrary and may be:
Pure or mixed;
Separable or inseparable;
Single-mode or multi-mode;
Gaussian or non-Gaussian;
Microscopic (low average photon number) mesoscopic (intermediate average photon number), or macroscopic (high average photon number).

Examples of physical processes generating such quantum states include, but are not limited to:
Spontaneous parametric down-conversion for generating biphotons or squeezed vacuum;
Quadratic or Kerr squeezing of arbitrary input quantum states;
Quantum dots;
Color centers;
Heralded schemes generating non-Gaussian states (fock states, cat states, GKP states).

### Variants of Measurement Schemes

Providing a specific variant as an example of quantum spectrography—The spectrogram of a quantum pulse train is usually generated by combining three components:
Control or knowledge of relative delay, τ, between the quantum pulse to be measured, â(t) and the reference gate pulse, G(t, τ).
Nonlinear optical process, â^{NL} (t)=NL(â(t), G(t, τ)) enabling some form of nonlinear interaction.
Frequency domain measurement of the resulting field through some form of optical spectrum measurement i.e. any direct/indirect measurement of â^{NL}(ω). The spectral measurement may be single-shot or multi-shot.
The relative delay can be static (as in spectral interferometry [21] or SPIDER [11]).
The relative delay can be dynamic as a function of time (as in FROG, SPIDER).
The relative delay may be known or unknown.
The reference gate pulse, G(t, τ), can be classical or quantum.
The gate may be apriori known or unknown e.g. the unknown quantum pulse itself.
The nonlinear optical system includes any parametric/non-parametric nonlinear process.
The nonlinearity can be interferometric enabling probing phase-sensitive quadrature information of the quantum state.
The nonlinearity can be an amplifier enabling probing the shot-noise level of the optical system.
The nonlinear optical process may be known or unknown.
The spectral measurement may be complete (across the entire bandwidth) or incomplete (a part of the spectrum).
The spectrum may be obtained by any frequency domain measurement technique. Examples include but are not limited to grating based spectrometers, dispersive spectrometers, Fourier transform infrared spectrometers.
The spectrum measurement can be an average photon number measurement over multiple instances of a quantum state. Examples include but are not limited to traditional room-temperature spectrometers with sufficiently high integration times.
The spectrum measurement can be single-shot in the photon number basis. Examples include but are not limited to spectrometers with threshold detectors (SNSPDs, APDs) or detectors that can differentiate between photon numbers (PNRs, EMCCD, SiPMτ).

### Example Inference Schemes

Inferences include any information about the quantum state that can be gathered from the measurement. Examples of making direct and indirect inferences from the spectrogram include:
Direct inference: The spectrogram I(ω, τ) is localized within the spectral bin Δω and temporal bin Δt, implying that the energy distribution of the quantum state is localized accordingly.
Indirect inference: Any information about the energy distribution of the quantum state in the time-frequency domain that can be recovered through any additional processing of the spectrogram I(ω, τ).

Indirect inference techniques may further comprise:
Temporal correlation of the quantum state, measured by taking the marginal over the frequency dimension.
Spectral correlation of the quantum state, measured by taking the marginal over the temporal dimension.
Algorithmic inference. The measurement is passed through some algorithm that enables learning more about the temporal structure and quantum characteristics of the quantum state. Examples of algorithmic techniques include but are not limited to iterative, non-iterative, learning-based techniques.

### Example Information Extracted

This may include:
nth order operator moments of the modes of the multi-mode quantum state. This may include any or all of the first, second, and higher-order moments, including correlations;
The measured correlations may be in the temporal/frequency mode basis, in the principal mode basis (basis of uncorrelated modes), or in the mode basis representing a complex graph state;
The unitary transformation from the principal mode basis to the temporal/frequency mode basis, or to the mode basis representing a complex graph state;
Schmidt modes, Schmidt coefficients;
Different entanglement criteria including but not limited to Schmidt number;
Partial information about the state including but not limited to approximate wavefunction duration, approximate wavefunction shape, approximate number of modes, quadrature variance in the time/frequency domain, etc.

### Example Platforms

Schemes can be implemented on any platform including:
Bulk platform: light passes through bulk materials or undergoes free space propagation. Examples include but are not limited to light reflecting from free space mirrors, passing through nonlinear crystals, etc.
Integrated photonics platform: light is guided through optical waveguides on a chip (any material). Examples include but are not limited to light passing through waveguides in silicon nanophotonics, lithium niobate nanophotonics, etc.
Fiber platform: light is guided through optical fibers. Examples include but are not limited to light passing through optical fibers for communication.
Hybrid platform—combining elements from the bulk, integrated photonics, and fiber platforms.

### Example Applications

Knowledge about the temporal structure of a quantum state is necessary for leveraging time-frequency dimension of quantum states for various applications including but not limited to
Quantum sensing
Quantum communication
Quantum key distribution
Quantum information processing
Quantum networks

Our scheme provides a simple, hardware efficient method to create and measure different types of quantum networks in the temporal-frequency mode basis. These networks can be used for various quantum information processing which we elaborate on here:
Measurement based quantum computation in the time-frequency basis is an attractive hardware efficient alternative to existing quantum computation schemes. Building a fault tolerant quantum computer in the time-frequency basis requires explicit control and knowledge of the temporal modes and the ability to measure these modes.
Precise knowledge of the modal structure of the quantum state in the time-frequency domain can enable Boson sampling and Gaussian Boson sampling in the time-frequency domain.

### Specific Scheme Examples

### First Example: Temporal Mode Tomography Using an SFG XFROG According to a First Embodiment

FIG. 1B illustrates an example wherein the optical system 102 comprises a FROG-based scheme comprising the nonlinear medium 114 wherein the nonlinear optical process comprises a phase-insensitive process, such as sum-frequency generation, such that the information inferred includes the temporal mode profiles and mean photon number per mode.
A pure, separable, broadband, multimode quantum optical state, â(ω) can be uniquely expressed in its principal mode basis [7] as a linear combination of N independent single-mode states,

$$\hat{a} ( ω ) = {\sum }_{m = 1}^{N} {ψ}_{m} ( ω ) {\hat{b}}_{m} ,$$

where \hat{b}ₘ denotes the broadband annihilation operator of mode m with spectral envelope ψₘ(ω)} and {ωₘ(ω)}forms a set of vectors belonging to an orthonormal basis.

The intensity spectrogram of this state using a Sum Frequency Generation—XFROG (SFG-XFROG) is derived to be a weighted sum of the intensity spectrograms of the individual modes—

$$〈 \hat{N} ( ω , τ ) 〉 ∝ {{\sum }^{N}}_{m = 1} = 〈 {\hat{b}}_{m}^{†} {\hat{b}}_{m} 〉 {\vert G ( ω ) {e}^{i ωτ} * {ψ}_{m} ( ω ) \vert}^{2} , \qquad ( 1 )$$

where G(ω)e^{iωτ} represents a classical gate pulse with temporal delay τ and the weights

$$〈 {\hat{b}}_{m}^{†} {\hat{b}}_{m} 〉$$

correspond to the average photon number occupancy of mode m.
The classical SFG-XFROG uses a 2D phase retrieval algorithm to recover the complex pulse profile, P(t), from a spectrogram of the form, I(ω, τ)=|G(ω)e^{iωτ}P(t) |². The generalized projections algorithm, a commonly used retrieval technique, iteratively searches for the complex electric field that can produce the measured intensity spectrogram while satisfying the optical nonlinearity constraint. Note that the spectrogram of a quantum optical pulse (Eq. 1) can be expressed as a sum of N classical spectrograms. This is mathematically analogous to the spectrograms generated by a classical train of non-repeating pulses [6]. For this case, the standard FROG algorithm is known to fail [15] and custom algorithms have been demonstrated using different methods [6,9,20]. We introduce a custom recovery algorithm inspired by the Mixed-State Generalized Projections Algorithm (MSGPA) [1] to recover the complex modes ψₘ(co) along with the average photon number occupancy

$$〈 {\hat{b}}_{m}^{†} {\hat{b}}_{m} 〉 .$$

Our custom recovery algorithm adds an orthogonality constraint for the recovered modes in each iteration by applying the Gram-Shmidt process in each iteration to the complex pulses recovered by the MSGPA. As this constraint is valid for pure, separable, quantum states, we name our technique the Pure-State Generalized Projections Algorithm (PSGPA). The number of modes N can be recovered by overestimating the number of modes M in our recovery algorithm (i.e. M >N). In this case, the photon number occupancy of modes m >N is found to be negligible. If the number of modes is underestimated, the retrieved loss is higher. Knowledge of the average photon number

$$〈 {\hat{b}}_{m}^{†} {\hat{b}}_{m} 〉 ,$$

and the complex frequency modes {ωₘ(ω)}, gives us access to the first order quantum correlation matrix in the principal mode basis as well as the unitary that transforms the correlation matrix to the frequency mode basis. In the principal mode basis, the correlation matrix,

$${Γ}_{P}^{( 1 )}$$

is simply an N×N diagonal sub-matrix with elements representing the average photon number occupancy,

$$〈 {\hat{b}}_{m}^{†} {\hat{b}}_{m} 〉 .$$

The correlation matrix in the frequency domain can be derived to be

$${( {Γ}^{( 1 )} )}_{ω , {ω}^{′}} = 〈 {\hat{a}}^{†} ( ω ) \hat{a} ( {ω}^{′} ) 〉 = {\sum }_{m} 〈 {\hat{b}}_{m}^{†} {\hat{b}}_{m} 〉 {ψ}_{m}^{*} ( ω ) {ψ}_{m} ( {ω}^{′} ) .$$

For multimode Gaussian states with squeezing parameter m the intensity spectrogram simplifies to,

$$〈 \hat{N} ( ω , τ ) 〉 ∝ {{\sum }^{N}}_{m = 1} {sinh}^{2} {ξ}_{m} {\vert G ( ω ) {e}^{i ωτ} * {ψ}_{m} ( ω ) \vert}^{2} , \qquad ( 2 )$$

where ξₘ is the squeezing parameter of mode m. Knowledge of the proportionality constant can give access to the exact squeezing parameter. However, even without the proportionality constant, the SHG-XFROG gives access to the Schmidt modes, ψₙ(ω), and the Schmidt coefficients,

$${Λ}_{m} = \frac{{sinh}^{2} {ξ}_{m}}{{\sum }_{m = 1}^{N} {sinh}^{2} {ξ}_{m}} \qquad ( 3 )$$

from which the Schmidt number,

$$K = \frac{1}{{\sum }_{m = 1}^{N} {Λ}_{m}^{2}} [ 17 ]$$

and the spectral purity [symbol] =1/K[18,3,23] can be determined. Note that in certain cases, the Schmidt modes are identical to the principal modes. For nondegenerate parametric down-conversion, the Schmidt modes are distinct from the principal modes and can be inferred by measuring the spectrogram for the signal and idler separately followed by PSGPA.

### Second Example: Generalized FROG Based Scheme: Extending to any Nonlinearity, Delay Mechanism, Spectrometer

FIG. 1C illustrates a more generalized FROG-based implementation and an implementation wherein the optical system 102 comprises a Frequency Resolved Optical Gating (FROG)- based scheme comprising one or more auxiliary pulses 107, relative delay mechanisms, and nonlinear media 114 such that the information inferred includes quantum state statistics and/or temporal-frequency structure.
The input quantum state may be arbitrary;
The delay may be arbitrary including mechanically induced delay (as in a linearized motor stage) or optically induced delay (as in dual frequency comb schemes);
The spectrometers may be arbitrary including spectrometers with different frequency separation schemes (dispersive, grating based, delay based, etc.), and different detectors (slow, fast, threshold photon number resolving, etc.);
The nonlinearity may be arbitrary—including but not limited to interferometric nonlinearities (for quadrature sensitive measurements); and amplification-based nonlinearities (for shot-noise sensitive measurements);
The degenerate parametric amplifier-based FROG [22] is especially useful for quantum spectrography as it provides quadrature sensitivity, can measure shot-noise, and can be used to amplify microscopic quantum states for measurements with room temperature detectors;
Using the degenerate parametric amplifier in conjunction with a temporal mode tomography scheme can provide quadrature sensitivity, shot-noise sensitivity, and amplification;
The spectrometers may be arbitrary including spectrometers with different frequency separation schemes (dispersive, grating based, delay based, etc.), and different detectors (slow, fast, threshold photon number resolving, etc.);
The algorithms may be iterative using the nonlinearity and spectral measurement constraints including but not limited to gradient descent-based algorithms, generalized projections algorithms, ptychographic algorithms, etc.
The information obtained may include nth order correlations, different entanglement criteria, complex mode profiles in the time/frequency domain, etc.

### Third Example: Quantum Frequency Resolved Optical Gating of Few-Cycle Squeezed Vacuum

The technique was experimentally demonstrated by characterizing the temporal modes and squeezing levels of ultrashort pulse squeezed vacuum generated on a lithium niobate nanophotonic chip. The technique demonstrates the viability of quantum pulse measurement and temporal mode quantum state engineering for continuous variable quantum optics, while providing a practical and accessible tool to harness ultrafast quantum pulses for enhanced sensing and nonlinear optics.

### A. Motivation

Here, we overcome these challenges and introduce a quantum variant of FROG enabling high-bandwidth, high-resolution measurement of ultrafast squeezed vacuum. Our quantum FROG used loss-tolerant phase-sensitive amplification [42, 43] followed by a FROG-based spectrogram measurement and retrieval that enabled recovering the quadrature covariances and temporal mode structure of quantum pulses. We experimentally demonstrated our technique by characterizing the temporal modes and squeezing levels of ultrashort pulse squeezed vacuum generated on a lithium niobate nanophotonic chip.

Our work opens new avenues for quantum pulse measurement and temporal mode quantum state engineering for continuous variable quantum optics, while providing a practical and accessible tool to harness ultrafast quantum pulses for enhanced sensing and nonlinear optics.

### B. Concept

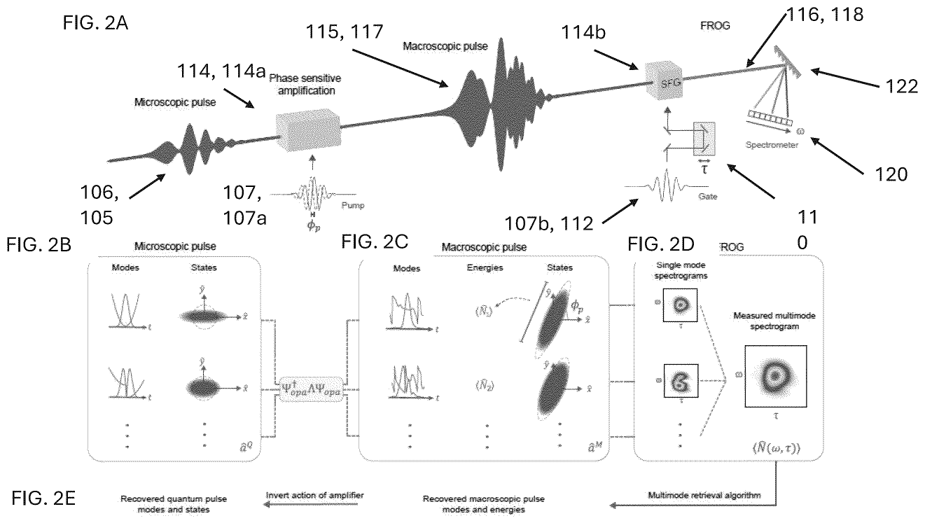

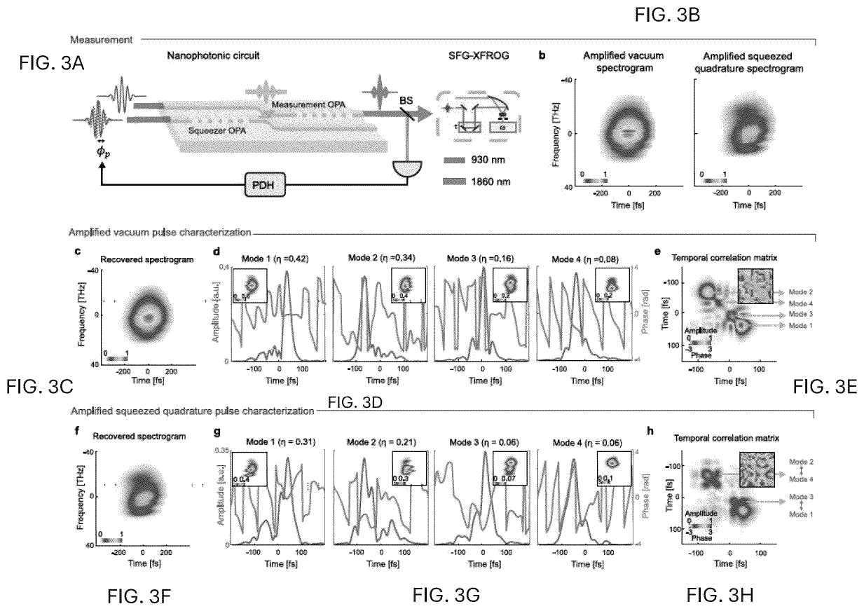

Quantum FROG, displayed in FIG. 2, includes two key physical processes: phase sensitive amplification and frequency resolved optical gating. The quantum pulse to be measured can be expressed as a collection of independent single-mode states living in distinct temporal modes. Phase-sensitive amplification maps information about the temporal mode structure and quadrature statistics of the quantum pulse to the temporal mode structure and energy distribution of a macroscopic multimode pulse. The generated macroscopic pulse can also be expressed as a collection of independent multimode states. Due to the independent nature of the states, the FROG spectrogram generated by such a multimode pulse is equivalent to the sum of the associated single-mode spectrograms. This physical constraint is used to implement a phase retrieval algorithm that enables the reconstruction of the temporal mode profiles and energies of the macroscopic pulse. The mapping of information between the properties of the macroscopic pulse and quantum pulse is determined by the characteristic mode and gain transformations of the amplifier. Amplifying vacuum fluctuations followed by the FROG measurement and recovery procedure enables the reconstruction of these transformations, characterizing the phase-sensitive amplifier. Calibrating for the transformations enables quantum pulse reconstruction.

FIG. 2E shows an embodiment wherein the FROG-based scheme comprises one or more nonlinear media 114a 114b wherein the nonlinear process 114a generates an intermediary state to prepare the quantum state for spectrographic measurement using the final nonlinear process 114b. The system comprises at least two nonlinear media 114a, 114b wherein phase sensitive amplification process in the first nonlinear medium 114a is followed by sum frequency generation cross FROG using the second nonlinear medium 114b, wherein the information inferred includes at least one of characterization of the phase sensitive amplification process, second order quadrature moments of the input photonic quantum state in the temporal, amplifier, and independent bases, and the temporal mode profiles.

FIG. 2 further illustrates an embodiment wherein the optical system comprises nonlinear media 114a, 114b implementing at least two nonlinear processes, where one or more processes map physical parameters of the input quantum state 106 to other parameters of an intermediate state 115 in an intermediate pulse 117 to prepare the input state 106 for spectrographic measurement using a final nonlinear optical process in a second nonlinear medium 114b, wherein physical parameters being mapped include at least one of quadrature information, photon number, frequency, polarization, and temporal or spatial characteristics.

As illustrated in FIG. 2, the optical system 102 comprises a diffractive element 122 (e.g., grating) implementing an optical Fourier transform (the detector and grating implement a spectrometer as different wavelengths are spread to different locations on the detector).

### C. Example Theory

We consider ultrafast squeezed vacuum, a multimode, zero-mean field, Gaussian quantum pulse whose structure is fully determined by its temporal modes and their quadrature covariances. We describe the key relations connecting quantum pulse, macroscopic pulse, and the experimentally measured spectrogram that enable complete quantum pulse reconstruction.

We represent the microscopic quantum pulse by its annihilation operators

â^{Q}=\hat{b}^{Q}Ψ^{Q}, (1)
where â^{Q} and \hat{b}^{Q} are row vectors containing annihilation operators in the temporal and principal (eigenmode) basis respectively. The rows of matrix Ψ^{Q} contain the principal temporal mode functions, while the quantum statistics reside in the quadrature variances of \hat{b}^{Q}.

A phase-sensitive optical parametric amplifier (OPA) [44] maps the microscopic quadrature fluctuations onto measurable photon number in the macroscopic field. The OPA acts diagonally in its characteristic basis, characterized by unitary matrix Ψₒₚₐ, in which each mode experiences independent quadrature-selective amplification. The amplified quadrature is determined by the pump-signal relative phase φₚ. Expressing the annihilation operators of the quantum pulse in this basis as

$${\hat{c}}^{Q} = {\hat{a}}^{Q} {Ψ}_{opa}^{†} ,$$

the amplified quadrature operator is \hat{x}^{Q}(φₚ)=e^{-iφ}^{ₚ}ĉ^{Q}+e^{iφ}^{ₚ}ĉ^{Q,†}. The macroscopic output field is then,

â^{M}=\hat{x}^{Q}(φₚ)ΛΨₒₚₐ, (2)
where Λ is the diagonal gain matrix containing mode-dependent amplification values We measure a spectrogram using sum-frequency-generation cross-FROG (SFGXFROG), where the spectrum of the sum frequency signal between the macroscopic pulse and a classical gate pulse is recorded as a function of their relative delay. Because the amplified field remains Gaussian, it is separable into its principal basis, making it possible to express the measured SFG-XFROG spectrogram, [symbol] \hat{N}(ω, τ) [symbol] , as an incoherent sum of single-mode spectrograms,

$$〈 \hat{N} ( ω , τ ) 〉 ∝ {\sum }_{m} 〈 {\hat{b}}_{m}^{† , M} {\hat{b}}_{m}^{M} 〉 {\vert ℱ \{ G ( t - τ ) {ψ}_{m}^{M} ( t ) \} \vert}^{2} . \qquad ( 3 )$$

Here

$${ψ}_{m}^{M} and 〈 {\hat{b}}_{m}^{†} {\hat{b}}_{m} 〉 .$$

denote the temporal profile and mean photon number of principal mode m of the macroscopic pulse, and G(t−τ) represents the classical optical gating pulse.

In classical SFG-XFROG, an iterative two-dimensional phase retrieval algorithm is used to reconstruct a classical pulse envelope from a measured spectrogram. While standard algorithms would work on a single-mode spectrogram, they fail on the multimode spectrogram considered here. By incorporating the constraints for a separable multimode state, we develop a custom retrieval algorithm (see Methods for details) enabling recovery of the complex temporal modes, ψₘ(t), and mean photon numbers,

$$〈 {\hat{b}}_{m}^{†} {\hat{b}}_{m} 〉 .$$

These recovered quantities specify the macroscopic temporal correlation matrix, [symbol] â^{M,†}â^{M} [symbol] .

Using the amplification relation, this macroscopic correlation matrix relates to the quantum quadrature correlation matrix:

$$( {\hat{a}}^{M , †} , {\hat{a}}^{M} 〉 = {Ψ}_{opa}^{†} Λ 〈 {{\hat{x}}^{Q} ( {ϕ}_{p} )}^{T} {\hat{x}}^{Q} ( {ϕ}_{p} ) 〉 {ΛΨ}_{opa} . \qquad ( 4 )$$

To determine the unknown amplifier transformations, Λ and Ψₒₚₐ, we amplify vacuum ( [symbol] \hat{x}^{Q}(φₚ)^{T}\hat{x}^{Q}(φₚ) [symbol] = [symbol] ), measure the corresponding spectrogram, and retrieve its modes and energies. This calibration enables inverting for the amplifier transformation in Eq. 4 giving access to the quadrature correlation matrix of the quantum pulse in the amplifier basis. Diagonalizing this matrix yields the quadrature variances of the quantum pulse in its principal basis and the corresponding change-of-basis transformation. For real basis transformations, this enables recovering Ψ^{Q}.

### D. Experimental Implementation

FIG. 3 shows the experimental implementation of quantum FROG (see Methods for details). Our scheme utilized two OPAs on a nanophotonic chip followed by an SFG-XFROG setup. The squeezer OPA generated a multimode squeezed state and the measurement OPA enables high-gain multimode phase-sensitive amplification. On-chip amplification enabled tolerance to off-chip coupling losses [20] that can limit the maximum measurable squeezing on the nanophotonic platform. We utilized a Pound-Drever-Hall locking scheme to control the relative phase between the pump and the multimoded squeezed state enabling quadrature selection.

We began by measuring amplified vacuum and amplified squeezed quadrature spectrograms. The measurement OPA was pumped with an ultrashort pulse at 930 nm and the spectrogram of the amplified vacuum fluctuations generated at 1860 nm was measured. FIG. 3b (Left) shows the corresponding spectrogram which indicates the shot noise level and is used for characterization of the measurement OPA's modes and gain parameters. Next, the squeezer OPA was pumped to create a microscopic squeezed vacuum state which is then amplified by the measurement OPA to a macroscopic state. The squeezed quadrature was selected by locking the pump phase to the trough of the detected signal, and the corresponding macroscopic pulse was measured using the SFG-XFROG. FIG. 3b (Right) shows the measured spectrogram of the amplified squeezed quadrature which has been normalized with respect to the shot-noise spectrogram. A visual comparison of the two measured spectrograms confirms clear sub-shot noise intensity values characteristic of squeezing.

The amplified vacuum spectrogram was passed through the multimode phase retrieval algorithm and the recovered spectrogram is shown in FIG. 3c. FIG. 3d displays the recovered orthonormal complex temporal modes with their spectrograms inset and the fractional mode energy η. Note that the sum of the inset spectrograms would yield the recovered spectrogram. Additionally, the complex orthonormal modes and the mode energies correspond directly to the amplifier mode and gain transformations, thus characterizing the measurement OPA. Using the temporal modes and energies, the complex temporal correlation matrix is calculated and shown in FIG. 3e. The elements of this complex-valued matrix give information about the degree of correlation as well as the phase relationship between these two time instances. The highly non-diagonal nature indicates correlations between different time instances. Note that most of the correlations exist within the temporal features corresponding to the individual modes and there are no prominent inter-mode correlations.

Passing the amplified squeezed quadrature spectrogram through the retrieval algorithm yields the recovered spectrogram shown in FIG. 3f, and mode information displayed in FIG. 3g. The displayed fractional mode energy, η, is still with respect to the total amplified vacuum energy for comparison purposes. The distinct orthonormal mode profiles and lower fractional mode energies of the amplified squeezed quadrature pulse with respect to amplified vacuum pulse carry signatures of the quadrature statistics and temporal mode structure of the microscopic squeezed vacuum pulse. The amplified squeezed vacuum pulse temporal correlation matrix, shown in FIG. 3h, reveals prominent inter-mode correlations missing in the amplified vacuum temporal correlation matrix. Additionally, the lower amplitude values for the amplified squeezed quadrature compared to the amplified vacuum temporal correlation matrix indicates time domain sub-shot noise characteristics.

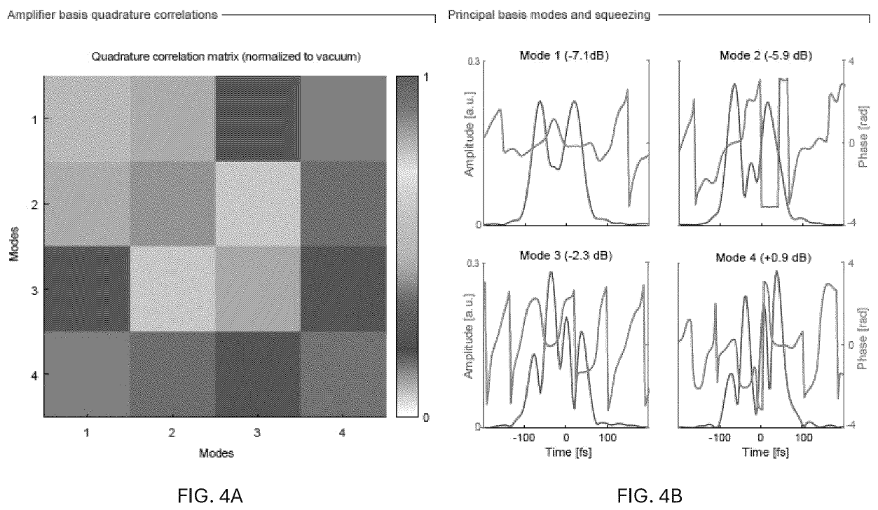

Using the squeezed quadrature temporal correlation matrix with the characterized measurement OPA gain and mode transformations enables quantum pulse reconstruction. FIG. 4a shows the squeezed quadrature correlation matrix obtained by calibrating for the output amplifier temporal modes and gain transformations. This matrix carries information about quadrature correlations of the quantum pulse when projected to the basis of the measurement OPA. It is noted that all diagonal elements in this matrix (corresponding to quadrature variances in this basis) are below the vacuum level. The prominent non-diagonal terms reveal strong inter-mode quadrature correlations of the quantum pulse in this basis.

Inverting the input temporal mode transformation of the amplifier reveals the temporal mode structure of the quantum pulse (FIG. 4b). The squeezing level per mode was calculated from the diagonalized squeezed quadrature correlation matrix. We measure 4 temporal modes of the quantum pulse with squeezing levels of {-7.1, -5.9, -2.3, +0.9}dB. The first 3 modes are observed to have quadrature variances well below shot noise and the fourth mode is observed to have a quadrature variance greater than vacuum level.

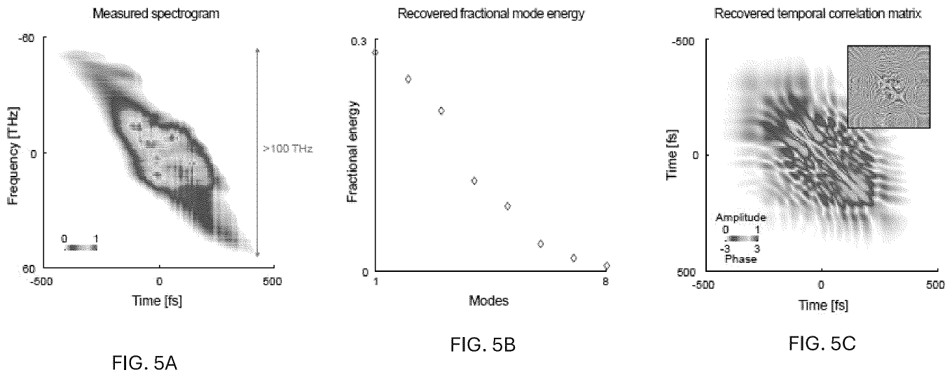

To highlight the high-bandwidth capabilities of FROG, we experimentally generated and measured an ultrabroadband pulse obtained by amplifying vacuum fluctuations (see Methods for experimental details). For ultrabroadband generation, we pumped a lithium niobate nanophotonic OPA that had been dispersion-engineered to support near-single-cycle pulses [45]. The measured SFG-XFROG spectrogram in FIG. 5a shows spectral content spanning more than 100 THz. Multimode retrieval yields an 8-mode pulse, with the fractional energy per mode displayed in FIG. 5b. FIG. 5c shows the recovered temporal correlation matrix revealing prominent non-diagonal temporal correlations.

These results close a long-standing gap between the tools routinely used for classical ultrafast pulse characterization and what has been available in the quantum regime.

In close analogy to the family of classical FROG variants, the presented technique can be extended to work with other spectrographic schemes. Combining the retrieval technique with established classical FROG-based attosecond pulse characterization schemes [38] could enable reconstruction of quantum fluctuations at the attosecond timescale. Utilizing retrieval techniques based on ptychographic [46] and learning based algorithms [47] may offer benefits in retrieval accuracy/time complexity. Moreover, nanophotonic FROG implementations [48, 49], where the optical nonlinearity is on the nanophotonic platform, demonstrates that this approach is naturally suited to integrated platforms.

The measurement and recovery techniques presented here can measure the temporal modes, mean photon numbers, and quadrature covariances of zero-mean field separable quantum pulses. Non-zero-mean field Gaussian states such as squeezed coherent states would have a different analytical formulation for the spectrogram requiring an adapted retrieval algorithm. For biphoton characterization, the SFG-XFROG technique presented here can measure complex-valued joint spectral amplitude, Schmidt modes, Schmidt-coefficients, spectral purity, and Schmidt number. While the techniques presented here can measure the temporal modes and quadrature covariances of separable non-Gaussian states [15], they do not have access to the higher order correlations required to characterize non-Gaussian states completely. Bringing single-shot FROG techniques [50, 51], well developed in the classical domain, suggests routes to measuring shot-to-shot fluctuating quantum fields enabling access to higher order correlations required for multimode non-Gaussian pulse measurements.

The OPA-based mapping from microscopic quadrature fluctuations to the macroscopic state realizes a specific class of measurement-induced graph states in the temporal domain [13, 16]. Engineering the pump profile [52] and phase-matching function [53] opens a new path for large-scale temporal mode entanglement engineering. This has the advantage of broadband operation enabled by the nonlinear interaction, unavailable in current schemes [10, 13, 14, 16]. Additionally, widespread availability of FROG can be exploited for pulsed sub-shot-noise sensing, such as nonlinear microscopy [5] and nonlinear interferometery [54], as well as for applications leveraging the anti-squeezed quadrature for enhanced nonlinear conversion efficiencies [7].

### E. Methods

### Multimode Retrieval Algorithm

The classical SFG-XFROG uses a 2D phase retrieval algorithm to recover the complex pulse profile, P(t), from a spectrogram, I(ω, τ)=| [symbol] {G(t−τ)P(t)}|². Here τ indicates the delay between gate pulse G(t) and unknown pulse P(t) and [symbol] Fourier transforms from time t to frequency ω. The spectrogram of a separable pulse (Eq. 3) is mathematically distinct and therefore cannot be used with standard 2D phase-retrieval algorithms, necessitating a custom algorithm. The spectrogram defined by Eq. 3 is mathematically analogous to the equation defining the spectrogram generated by a classical train of non-repeating pulses [55]. This allows us to utilize phase retrieval techniques that have recently been developed for noisy pulse measurements [46, 55-58]. We develop a custom recovery algorithm, Separable State Generalized Projections Algorithm (SSGPA), that builds on the Mixed-State Generalized Projections Algorithm (MSGPA) [58]. MSGPA enable phase retrieval of a spectrogram, Sₘₑₐₛ (ω, τ), that is generated as an incoherent sum of spectrograms,

$${S}_{meas} ( ω , τ ) = {\sum }_{k}^{N} {\vert {s}_{k} ( ω , τ ) \vert}^{2} .$$

In each iteration of MSGPA, the algorithm reconstructs N spectrograms in parallel and applies a data constraint, \sqrt{Sₘₑₐₛ/ Σₖ |sₖ|²} per spectrogram that ensures the spectrogram equation validity. SSGPA incorporates an orthogonality constraint enforced by applying the Gram-Schmidt process in each iteration to the complex pulses recovered by the MSGPA. Additionally, SSGPA works with normalized modes, keeping track of the normalization constant. Thus SSGPA is specifically designed to work with Eq. 3, enabling the recovery of mean photon number per mode and the complex temporal mode profile. We note that we use mean photon number per mode and mode energy interchangeably in this work, as they are proportional for a fixed optical carrier frequency.

### F. Experiment Details

Design and fabrication details about the device used for the results presented in FIGS. 3 and 4 can be found in [20,59]. Here, we elaborate on the measurement apparatus displayed in FIG. 3 a. The optical pumps and gate used in the experiment are derived from a 100-fs TiS mode-locked laser operated at a central wavelength of 930 nm. The laser was split into three paths, with two paths going to the chip and the third path going to the SFG-XFROG. The two paths to the chip were aligned to the squeezer and measurement OPA waveguides. The squeezer optical path contained a moving mirror that sits on a piezo-electric actuator for tuning the pump phase. Light was coupled on and off the chip using reflective objectives to prevent distortions of the pump and signal temporal profiles. Pumping the squeezer OPA generates a microscopic multimode squeezed state at 1860 nm, which coupled to the measurement amplifier through an adiabatic coupler. Temporally overlapping the measurement pump with the squeezed state results in phase-sensitive-amplification, generating a macroscopic pulse at 1860 nm. The macroscopic pulse was passed through a long-pass filter that filters out the pump. The resulting signal has [symbol] \hat{N} [symbol] ≤10⁶, ten percent of which is directed to a detector using a high transmission beam splitter. The detected signal is fed back to the piezo-electric actuator through a PDH locking scheme and locked to the signal trough, corresponding to the squeezed quadrature. The transmitted light entered the SFG-XFROG and is gated on a 1 mm Lithium Iodate nonlinear crystal. The gate pulse energy was 5.2 nJ. Spectrum of the upconverted light was measured using a compact CMOS spectrometer (Thorlabs CCS200) for different gate delays controlled by a motorized linear translation stage. The spectrometer integration time was 200 ms and 300 ms for the amplified vacuum spectrogram and amplified squeezed vacuum spectrogram measurements respectively. The measured spectrograms are downsampled to a 512×512 grid and scaled to the same intensity axis (by accounting for the difference in integration time) before being processed by the multimode phase retrieval algorithm. The RMS loss between the measured and recovered spectrograms normalized to their peak intensities are 0.003 and 0.004 for amplified vacuum and amplified squeezed quadratures respectively.

Design and fabrication details about the device used for the results presented in FIG. 5 can be found in [45]. An ultrafast macroscopic pulse was generated by amplifying vacuum fluctuations using a broadband lithium niobate nanophotonic parametric amplifier. A macroscopic pulse, centered at 2090 nm, was generated by pumping the device with 100-fs pulses centered at 1045 nm. The spectrogram was then measured using the SFG-XFROG using a 100-fs gate pulse at 1045 nm. We use a thin 100 μm Lithium Iodate crystal that enables broadband FROG operation. The measured spectrogram was downsampled to a 256×256 grid before being processed by the multimode phase retrieval algorithm. The RMS loss between the measured and recovered spectrograms normalized to their peak intensities is 0.02.

### F. Temporal Mode Tomography with SFG-XFROG: Theory

### 1.1 Analytical Framework for the Spectrogram of a Quantum State

### 1.1.1 Separable Quantum State

The spectrogram generated by a multimode, zero-mean-field, separable quantum pulse can be derived in four steps:
Step 1—Describing an arbitrary multimode broadband quantum state, â(ω) as a linear combination of independent broadband single-mode states (i.e. in its principal mode basis [1])—

$$\hat{a} ( ω ) = {\sum }_{m} {ψ}_{m} ( ω ) {\hat{b}}_{m} \qquad ( 1 )$$

Here, ψₘ(ω) denotes the broadband envelope associated with principal mode m.
Step 2—gating â(ω) with classical pulse G(t−τ) through an SFG process (for more details see section on Broadband SFG nonlinearity) results in

â^{SFG}(ω,τ)=G(ω)e^{iωτ}* â(ω) (2)
where G(ω) is the Fourier transform of G(t).
Step 3—applying the spectrometer operator, [symbol] \hat{N}(ω) [symbol] on â^{SFG}(ω, τ) for arbitrary input âⁱⁿ(ω)—

$$〈 {\hat{a}}^{SFG , †} ( ω , τ ) {\hat{a}}^{SFG} ( ω , τ ) 〉 = 〈 {( G ( ω ) {e}^{i ω τ} * \hat{a} ( ω ) )}^{†} ( G ( ω ) {e}^{i ω τ} * \hat{a} ( ω ) ) 〉 , \qquad ( 3 )$$

$$〈 {\hat{a}}^{SFG , †} ( ω , τ ) {\hat{a}}^{SFG} ( ω , τ ) 〉 = 〈 ( {G}^{*} ( ω ) {e}^{- i ω τ} * {\sum }_{m} {ψ}_{m}^{*} ( ω ) {\hat{b}}_{m}^{†} ) ( G ( ω ) {e}^{i ω τ} * {\sum }_{n} {ψ}_{n} ( ω ) {\hat{b}}_{n} ) 〉 , \qquad ( 4 )$$

$$〈 {\hat{a}}^{SFG , †} ( ω , τ ) {\hat{a}}^{SFG} ( ω , τ ) 〉 = {\sum }_{m} {\sum }_{n} 〈 {\hat{b}}_{m}^{†} {\hat{b}}_{n} 〉 {( G ( ω ) {e}^{i ω τ} * {ψ}_{m} ( ω ) )}^{*} ( G ( ω ) {e}^{i ωτ} * {ψ}_{n} ( ω ) ) . \qquad ( 5 )$$

Step 4—Using uncorrelatedness of modes in the principal basis and applying zero mean field constraint i.e.

$$〈 {\hat{b}}_{m}^{†} {\hat{b}}_{n} 〉 = 〈 {\hat{b}}_{n}^{†} {\hat{b}}_{n} 〉 δ [ m - n ]$$

$$〈 {\hat{a}}^{SFG , †} ( ω , τ ) {\hat{a}}^{SFG} ( ω , τ ) 〉 = {\sum }_{n} 〈 {\hat{b}}_{n}^{†} {\hat{b}}_{n} 〉 {\vert G ( ω ) {e}^{i ω τ} * {ψ}_{n} ( ω ) \vert}^{2} \qquad ( 6 )$$

### 1.1.2 Broadband SFG Nonlinearity

Similar to [2], quantization of broadband sum frequency generation is done by substituting the classical amplitudes by field operators in the standard nonlinear optics description for broadband field evolution in the undepleted regime. This is given by

$$\frac{\partial \hat{a} ( ω ; z )}{\partial z} = \int d {ω}^{′} {e}^{i Δ k ( ω , {ω}^{′} ) z} G ( ω - {ω}^{′} ) \hat{a} ( {ω}^{′} ; z ) , \qquad ( 7 )$$

where we've ignored constants and only considered the nonlinear interaction term. Δk(ω, ω′)) k(ω−ω′)+k(ω′)−k(ω) where k(ω) is the wavevector of the field in the nonlinear crystal at frequency ω, G(ω) is the broadband classical gate pulse spectral envelope, and â(ω′; z) is the broadband quantum field envelope at location z in the nonlinear crystal. For the case of broadband phase matching, Δk(ω, ω′)=0, simplifying the equation to

$$\frac{\partial \hat{a} ( ω )}{\partial z} = \int d {ω}^{′} G ( ω - {ω}^{′} ) \hat{a} ( {ω}^{′} ) \qquad ( 8 )$$

which means the output annihilation operator corresponds to

â^{SFG}(ω)=G(ω) * â(ω). (9)

Note here that the z dependence has been ignored as a multiplication constant [2]. Broadband phase matching, a typical requirement for FROG-based systems [3], is experimentally achieved in our SFG-XFROG implementation by using a thin birefringent nonlinear crystal.

### 1.2 Spectrogram of an Attenuated Quantum State

Assuming uniform loss L overall frequency modes (for example from off-chip coupling), the quantum state after loss can be expressed as

$${\hat{a}}_{L} ( ω ) = \sqrt{L} \hat{a} ( ω ) + \sqrt{1 - L} \hat{d} \qquad ( 11 )$$

$${\hat{a}}_{L} ( ω ) = \sqrt{L} {\sum }_{m} {ψ}_{m} ( ω ) {\hat{b}}_{m} + \sqrt{1 - L} \hat{d}$$

where \hat{d} represents the ancilla vacuum modes coupled due to loss [1]. The spectrogram of â_{L}(ω) then becomes,

$$〈 {\hat{a}}_{L}^{SFG , †} ( ω , τ ) {\hat{a}}_{L}^{SFG} ( ω , τ ) 〉 = 〈 {( G ( ω ) {e}^{i ω τ} * {\hat{a}}_{L} ( ω ) )}^{†} ( G ( ω ) {e}^{i ω τ} * {\hat{a}}_{L} ( ω ) ) 〉 \qquad ( 12 )$$

$$〈 {\hat{a}}_{L}^{SFG , †} ( ω , τ ) {\hat{a}}_{L}^{SFG} ( ω , τ ) 〉 = 〈 ( {G}^{*} ( ω ) {e}^{- i ω τ} * ( \sqrt{L} {\hat{a}}^{†} ( ω ) + \sqrt{1 - L} {\hat{d}}^{†} ) ) \qquad ( 12 )$$

$$( G ( ω ) {e}^{i ω τ} * ( \sqrt{L} \hat{a} ( ω ) + \sqrt{1 - L} \hat{d} ) ) 〉 \qquad ( 13 )$$

$$〈 {\hat{a}}_{L}^{SFG , †} ( ω , τ ) {\hat{a}}_{L}^{SFG} ( ω , τ ) 〉 = 〈 ( {G}^{*} ( ω ) {e}^{- i ω t} * ( \sqrt{L} {\sum }_{m} {ψ}_{m}^{*} ( ω ) {\hat{b}}_{m}^{†} + \sqrt{1 - L} {\hat{d}}^{†} ) ) \qquad ( 13 )$$

$$( G ( ω ) {e}^{i ω t} * ( \sqrt{L} {\sum }_{n} {ψ}_{n}^{*} ( ω ) {\hat{b}}_{n}^{†} + \sqrt{1 - L} \hat{d} ) ) 〉 \qquad ( 14 )$$

$$〈 {\hat{a}}_{L}^{SFG , †} ( ω , τ ) {\hat{a}}_{L}^{SFG} ( ω , τ ) 〉 = L {\sum }_{n} 〈 {\hat{b}}_{n}^{†} {\hat{b}}_{n} 〉 {\vert G ( ω ) {e}^{i ω t} * {ψ}_{n} ( ω ) \vert}^{2} \qquad ( 15 )$$

$$〈 {\hat{a}}_{L}^{SFG , †} ( ω , τ ) {\hat{a}}_{L}^{SFG} ( ω , τ ) 〉 = L 〈 {\hat{a}}^{SFG , †} ( ω , τ ) {\hat{a}}^{SFG} ( ω , τ ) 〉 \qquad ( 16 )$$

Therefore, the SFG-XFROG can be use to recover the temporal modes o a quantum state even after it has experienced loss. Physically, this means that mode-independent loss does not change the temporal mode structure of the quantum state (as one might expect).

### 1.3 Correlation Functions in the Principal, Temporal, and Frequency Mode Bases

The correlation function in the principal mode basis,

$${Γ}_{P}^{( 1 )}$$

is given by an N×N diagonal submatrix with elements corresponding to the average photon number occupancy of the respective modes

$${Γ}_{P}^{( 1 )} = diag ( 〈 {\hat{b}}_{1}^{†} {\hat{b}}_{1} 〉 , 〈 {\hat{b}}_{2}^{†} {\hat{b}}_{2} 〉 , … , 〈 {\hat{b}}_{n}^{†} {\hat{b}}_{n} 〉 , 0 , … , 0 ) . \qquad ( 17 )$$

The correlation matrix in the temporal mode basis can be derived to be

$${( {Γ}^{( 1 )} )}_{t , {t}^{′}} = 〈 {\hat{a}}^{†} ( t ) \hat{a} ( {t}^{′} ) 〉 = {\sum }_{m} 〈 {\hat{b}}_{m}^{†} {\hat{b}}_{m} 〉 {ψ}_{m}^{*} ( t ) {ψ}_{m} ( {t}^{′} ) \qquad ( 18 )$$

Similarly, the correlation matrix in the frequency mode basis (where ψₘ(ω) is the Fourier transform of ψₘ(t)) can be derived to be

$${( {Γ}^{( 1 )} )}_{ω , {ω}^{′}} = 〈 {\hat{a}}^{†} ( ω ) \hat{a} ( {ω}^{′} ) 〉 = {\sum }_{m} 〈 {\hat{b}}_{m}^{†} {\hat{b}}_{m} 〉 {ψ}_{m}^{*} ( ω ) {ψ}_{m} ( {ω}^{′} ) \qquad ( 19 )$$

1.4 Schmidt decomposition and Joint Spectral Amplitude Schmidt decomposition is a common tool for characterizing parametric downconversion (PDC) [4,5]. For broadband frequency-temporal modes [6], the diagonalized interaction Hamiltonian of a degenerate PDC process, with eigenvalues λₙ, can be expressed as

$$H = i ℏ Γ {\sum }_{n} \sqrt{{λ}_{n}} {\hat{A}}_{n}^{†} {\hat{A}}_{n}^{†} + h . c . , \qquad ( 20 )$$

where Γ is the effective coupling strength and Âₙ are the Schmidt mode operators

Âₙ=∫dωψₙ(ω)â(ψ) (21)

The squeezing parameter ξₙ=G\sqrt{λₙ} where G corresponds to the parametric gain (the product of the coupling coefficient and the interaction time with the crystal). For degenerate bright squeezed vacuum, SFG-XFROG gives access to the frequency Schmidt modes, ψₙ(ω) and Schmidt coefficients,

$${Λ}_{m} = \frac{{sinh}^{2} {ξ}_{m}}{{\sum }_{m = 1}^{N} {sinh}^{2} {ξ}_{m}} \qquad ( 22 )$$

from which the Schmidt number,

$$K = \frac{1}{{\sum }_{m = 1}^{N} {Λ}_{m}^{2}}$$

and the spectral purity, [symbol] =1/K can be inferred. Measurement of the Schmidt modes and squeezing parameters gives access to the joint spectral amplitude F(ω, ω′)=Σₙ \sqrt{λₙ}ψₙ(ω)ψₙ(ω′).
2 Temporal Mode Tomography with SFG-XFROG: Algorithm and Simulations

### 2.1 Separable State Generalized Projections Algorithm

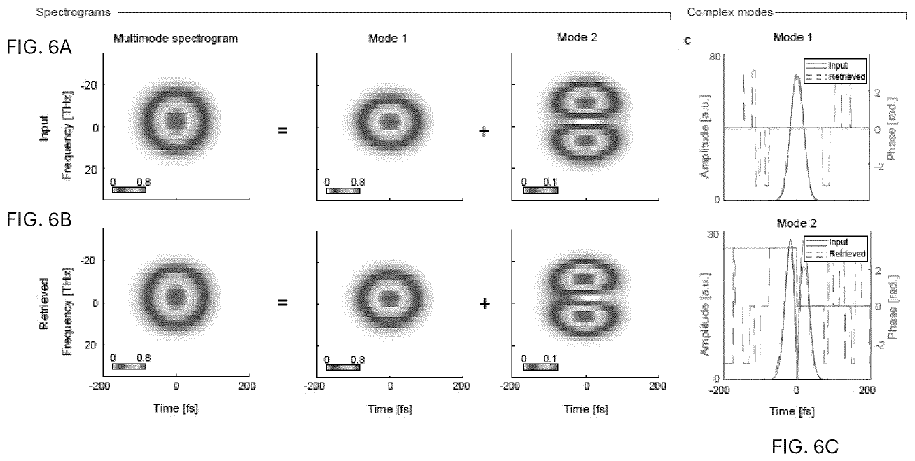

We test SSGPA using numerical simulations for different parameters (distinct bases, number of modes, photon number occupancy values, etc.). We begin by presenting the successful recovery of a two-mode state as an illustrative example. The complex modes are taken to be the first two orders of the Hermite-Gaussian basis with an intensity full-width at half-maximum of 30 fs. The gate is a Gaussian pulse with an intensity full-width at half maximum of 100 fs. The input is a squeezed vacuum state with Schmidt coefficients of 0.8 and 0.2. The Schmidt number and spectral purity are 1.47 and 0.68 respectively. FIG. 6 (a) displays the multimode spectrogram resulting as the sum of individual spectrograms of the two modes. Note that the absolute values of the mode spectrograms reflect the intensity contributions of the individual modes (sinh² ξₘ for mode m). FIG. 6 (b) displays the retrieved multimode spectrogram and individual spectrograms of retrieved modes after passing the multimode spectrogram through PSGPA. The RMS error between the input multimode spectrogram and the retrieved multimode spectrogram is 0.00019 for a 256 by 256 grid. FIG. 6 (c) shows a comparison of the amplitude and phase of the retrieved modes with the actual input. The absolute phase ambiguity of the classical single mode SFG-XFROG translates to relative phase ambiguity between different modes in the multimode case studied here ( [symbol] \hat{N}(ω, τ) [symbol] is independent of the absolute phases of the modes). We enforce the constraint that the modes of an OPA must have the same phase (valid if assuming that the associated gain matrix is real). The retrieved Schmidt coefficients are 0.83 and 0.17, with a Schmidt number and spectral purity of 1.4 and 0.7, respectively. Thus, our algorithm is successfully able to recover the complex mode profiles and squeezing parameters from a spectrogram generated by a multimode squeezed vacuum state.

### 2.2 SFG-XFROG SSGPA: Ambiguities

The SFG-XFROG for the multimode state inherits the ambiguities from its single-mode (classical) counterpart. The classical SFG-XFROG does not give access to information about the absolute phase of the individual modes. For the multimode case studied here, this directly translates to an unknown relative phase between the individual modes. We address this ambiguity by setting the absolute phase for all of the modes equal to 0 at the same time instant.

This is equivalent to assuming that the squeezing operation by the OPA acts on all of the modes at that given time instant along the same quadrature. For the more general case of characterizing relative phase between multiple squeezed modes (that is, to measure the degree of rotation between squeezed states), one could potentially use a phase-sensitive nonlinearity in the FROG (examples include [7,8]) which may provide the required information.

We note that using the OPA+SFG-XFROG configuration and measuring the entire covariance matrix (see section on covariance matrix recovery) of the input squeezed vacuum pulse enables accessing the relative angle between the squeezed states due to the phase-sensitive nature of the OPA.

### 2.3 Separable State Generalized Projections Algorithm Examples

We test our custom algorithm for different parameters (distinct bases, number of modes, photon number occupancy values, etc.) on simulated spectrograms. Here we show a few examples—all multimode spectrograms are normalized to their maximum values and the RMS loss is provided between the multimoded spectrogram and recovered spectrogram.

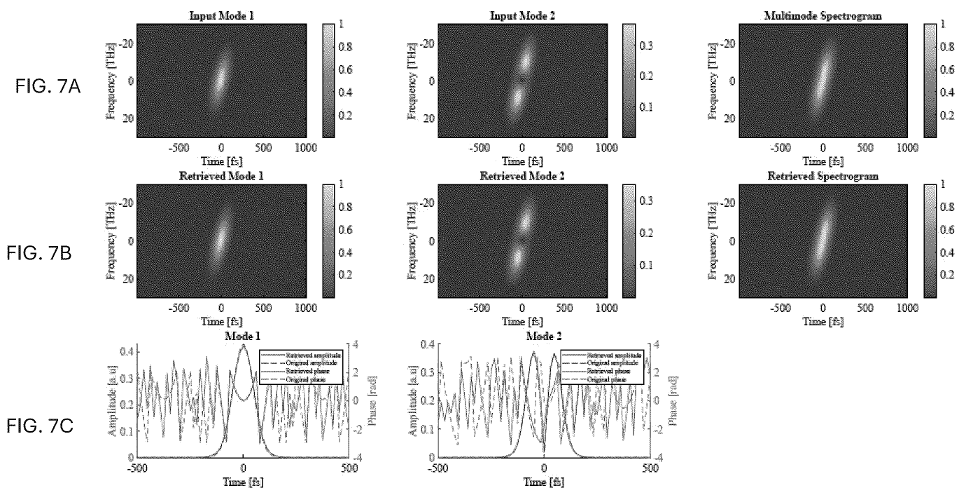

FIG. 7 displays the PSGPA recovery for a chirped 2 mode 30fs Hermite Gauss (HG) state with Schmidt coefficients 0.65 and 0.35 respectively gated with a 100 fs Gaussian pulse. The algorithm was run for 10000 iterations for a 128×128 grid size and reached an RMS loss of 0.0003 and retrieved Schmidt coefficients equal to 0.66 and 0.34 respectively.

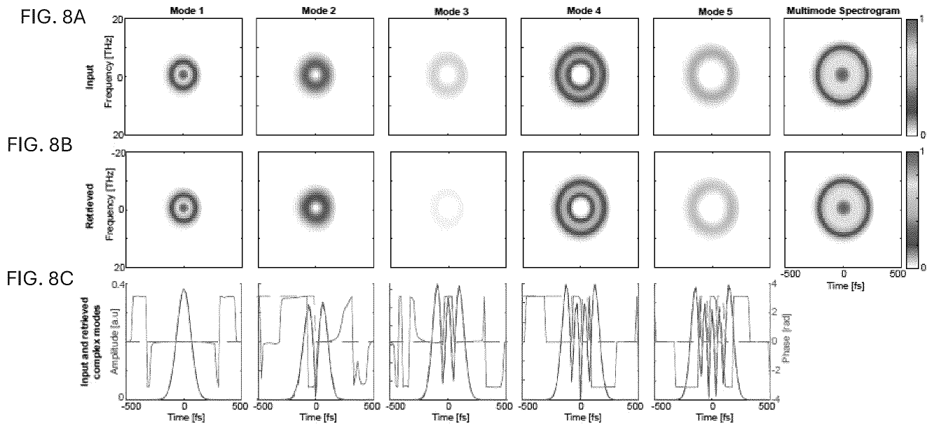

FIG. 8 displays PSGPA recovery for a 5 mode 100fs HG state with Schmidt coefficients, Λₙ={0.24,0.11,0.04, 0.47,0.11}gated with a 100 fs Gaussian pulse. The algorithm was run for 10000 iterations for a 128×128 grid size and reached an RMS loss of 0.00036 and retrieved Schmidt coefficients,

$${Λ}_{n}^{retr} = \{ 0.24 , 0.12 , 0.02 , 0.51 , 0.1 \} .$$

For multimode squeezed vacuum studied here, the individual squeezed states are symmetric in phase space when rotated by w. Equivalently, a relative phase of w between the input and recovered complex modes would describe the same state. For example, viewing the complex mode profiles for modes 4 and 5 in FIG. 8, the retrieved phase is w offset from the actual phase. However since both the actual and retrieved complex modes describe the same state, this would be considered a successful recovery.

3. Temporal Mode Tomography with SFG-XFROG: Additional Experiments

### Experiment 1

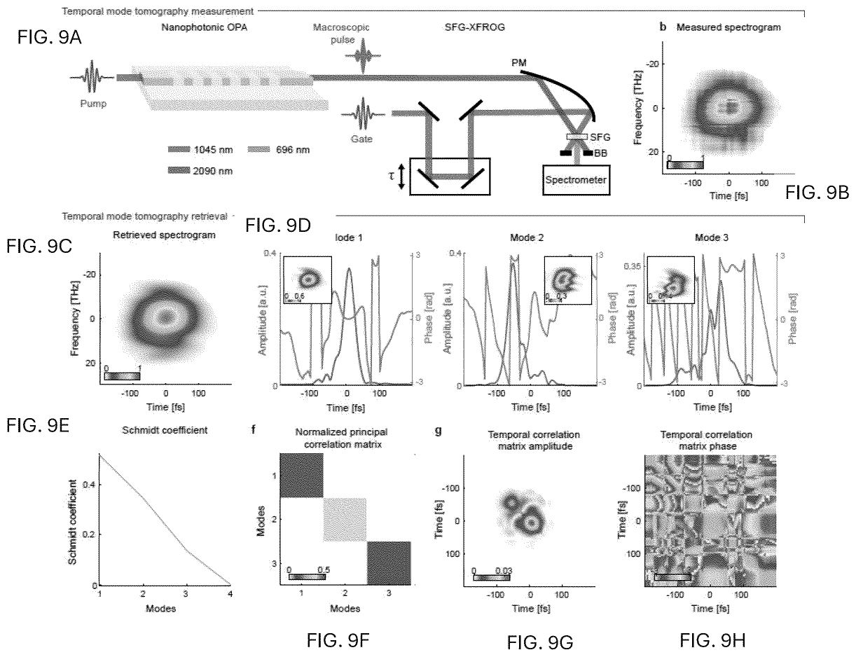

Here, we show additional measurements done using the SFG-XFROG FIG. 9 a, shows the experimental scheme used for generating and measuring ultrafast macroscopic pulse generated by amplifying vacuum fluctuations. The macroscopic state, centered at 2090 nm, is generated by pumping a lithium niobate nanophotonic OPA (device design and fabrication details can be found in [9]) with 100-fs pulses at 1045 nm. The spectrogram is then measured with a SFG-XFROG using a 100-fs gate pulse at 1045 nm. FIG. 9 b and c display the measured experimental spectrogram and recovered spectrogram, respectively. The RMS error was 0.007 for a grid size of 256 by 256 points. FIG. 9 d, displays the complex temporal modes with their corresponding spectrograms inset. The intensity full width at half maximum of the fundamental mode is measured to be 25 fs. The recovered Schmidt coefficients are displayed in FIG. 9 e illustrating the energy distribution of the multimode state. Mode 4 was found to have a negligible Schmidt coefficient leading us to truncate the modes at 3. The Schmidt coefficients were measured as {0.51,0.34, 0.13} and the associated Schmidt number was calculated to be 2.47.

### Experiment 2: Ultrabroadband High-Resolution Measurement

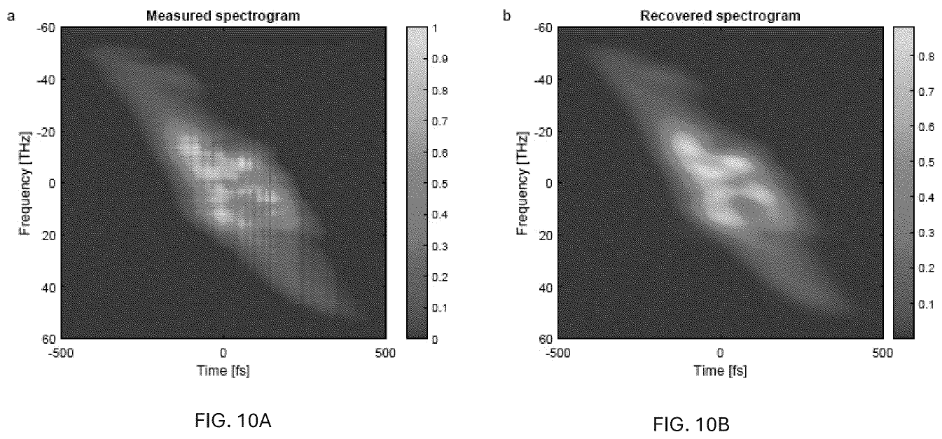

FIG. 10 displays the measurement and recovered spectrogram for the results displayed in FIG. 4 of the main text. The state was generated by pumping the nanophotonic parametric amplifier in the high gain regime to create ultrabroadband pulses.

4 Gaussian State Tomography with OPA+SFG-XFROG: Theory

### 4.1 Optical Parametric Amplifier

A broadband optical parametric amplifier can be expressed in the linear operation regime (no pump depletion) by the following linear transformations:

$${\vec{\hat{b}}}_{1 \times M}^{opa , in} = {\vec{\hat{a}}}_{1 \times T}^{opa , in} + {\vec{\hat{Φ}}}_{T \times M}^{opa , in} \qquad ( 23 )$$

$${\vec{\hat{b}}}_{1 \times M}^{opa , out} = {\vec{\hat{b}}}_{1 \times M}^{opa , in} diag ( cosh {\vec{ξ}}_{1 \times M}^{opa} ) + {ie}^{i {ϕ}_{p}} {\vec{\hat{b}}}_{1 \times M}^{opa , in , †} diag ( sinh {\vec{ξ}}_{1 \times M}^{opa} ) \qquad ( 24 )$$

$${\vec{\hat{a}}}_{1 \times T}^{opa , out} = {\vec{\hat{b}}}_{1 \times M}^{opa , out} {\vec{Ψ}}_{M \times T}^{opa , out} \qquad ( 25 )$$

where φₚ is the pump phase and diag(vec) represents a diagonal matrix with diagonal elements defined by vector vec. The subscripts denote matrix dimensions with M corresponding to the number of principal modes [1,2] and T corresponding to the number of discretized time bins.
   Expressing the amplifier in terms of quadrature operators

$$( {\vec{\hat{b}}}_{1 \times M}^{opa , in} = {\vec{\hat{x}}}_{1 \times M}^{opa , in} + i {\vec{\hat{y}}}_{1 \times M}^{opa , in} ) ,$$

we can rewrite the above equations as:

$$\begin{matrix}{\vec{\hat{b}}}_{1 \times M}^{opa , out} = ( {\vec{\hat{b}}}_{1 \times M}^{opa , in} + {ie}^{i {ϕ}_{p}} {\vec{\hat{b}}}_{1 \times M}^{opa , in , †} ) \frac{diag ( {e}^{{\vec{ξ}}_{1 \times M}^{opa}} )}{2} + \\ = ( {\vec{\hat{b}}}_{1 \times M}^{opa , in} - {ie}^{i {ϕ}_{p}} {\vec{\hat{b}}}_{1 \times M}^{opa , in , †} ) \frac{diag ( {e}^{- {\vec{ξ}}_{1 \times M}^{opa}} )}{2}\end{matrix} \qquad ( 26 )$$

$$\begin{matrix}{\vec{\hat{b}}}_{1 \times M}^{opa , out} = {e}^{i ( {ϕ}_{p} / 2 + π / 4 )} \{ ( \begin{matrix}{e}^{- i ( {ϕ}_{p} / 2 + π / 4 )} {\vec{\hat{b}}}_{1 \times M}^{opa , in} + \\ {e}^{i ( {ϕ}_{p} / 2 + π / 4 )} {\vec{\hat{b}}}_{1 \times M}^{opa , in , †}\end{matrix} ) \frac{diag ( {e}^{{\vec{ξ}}_{1 \times M}^{opa}} )}{2} + \\ ( {e}^{- i ( {ϕ}_{p} / 2 + π / 4 )} {\vec{\hat{b}}}_{1 \times M}^{opa , in} - {e}^{i ( {ϕ}_{p} / 2 + π / 4 )} {\vec{\hat{b}}}_{1 \times M}^{opa , in , †} ) \frac{diag ( {e}^{- {\vec{ξ}}_{1 \times M}^{opa}} )}{2} \}\end{matrix} \qquad ( 27 )$$

Expressing diag(e^{ξ1×M}) as

$${Λ}_{M \times M}^{opa}$$

and diag(e^{-ξ1×M}) as

$${Λ}_{M \times M}^{opa , - 1} and {ϕ}_{p}^{′} = {ϕ}_{p} / 2 + π / 4 :$$

$$\begin{matrix}{\vec{\hat{b}}}_{1 \times M}^{opa , out} = {e}^{i {ϕ}_{p}^{′}} ( {e}^{- i {ϕ}_{p}^{′}} {\vec{\hat{b}}}_{1 \times M}^{opa , in} + {e}^{i {ϕ}_{p}^{′}} {\vec{\hat{b}}}_{1 \times M}^{opa , in , †} ) \frac{{Λ}_{M \times M}^{opa}}{2} + \\ ( {e}^{- i {ϕ}_{p}^{′}} {\vec{\hat{b}}}_{1 \times M}^{opa , in} - {e}^{i {ϕ}_{p}^{′}} {\vec{\hat{b}}}_{1 \times M}^{opa , in , †} ) \frac{{Λ}_{M \times M}^{opa , - 1}}{2}\end{matrix} \qquad ( 28 )$$

$${\vec{\hat{b}}}_{1 \times M}^{opa , out} = {e}^{i {ϕ}_{p}^{′}} \{ \begin{matrix}( {\vec{\hat{x}}}_{1 \times M}^{opa , in} cos {ϕ}_{p}^{′} + {\vec{\hat{y}}}_{1 \times M}^{opa , in} sin {ϕ}_{p}^{′} ) {Λ}_{M \times M}^{opa} + \\ ( - {\vec{\hat{x}}}_{1 \times M}^{opa , in} sin {ϕ}_{p}^{′} + {\vec{\hat{y}}}_{1 \times M}^{opa , in} cos {ϕ}_{p}^{′} ) {Λ}_{M \times M}^{opa} - 1\end{matrix} \} \qquad ( 29 )$$

$${\vec{\hat{b}}}_{1 \times M}^{opa , out} \approx {e}^{i {ϕ}_{p}^{′}} ( {\vec{\hat{x}}}_{1 \times M}^{opa , in} cos {ϕ}_{p}^{′} + {\vec{\hat{y}}}_{1 \times M}^{opa , in} sin {ϕ}_{p}^{′} ) {Λ}_{M \times M}^{opa} , \qquad ( 30 )$$

where we assume ξₘ »1 allowing us to ignore the deamplified term. From here, we replace the approximation with an equality following this assumption. This results in a correlation matrix given by:

$${\vec{\hat{b}}}_{M \times 1}^{opa , out , †} = {e}^{- i {ϕ}_{p}^{′}} {Λ}_{M \times M}^{opa} ( {\vec{\hat{x}}}_{M \times 1}^{opa , in} cos {ϕ}_{p}^{′} + {\vec{\hat{y}}}_{M \times 1}^{opa , in} sin {ϕ}_{p}^{′} ) , \qquad ( 31 )$$

$$\begin{matrix}{\vec{\hat{b}}}_{1 \times M}^{opa , out} = {e}^{i {ϕ}_{p}^{′}} ( {\vec{\hat{x}}}_{1 \times M}^{opa , in} cos {ϕ}_{p}^{′} + {\vec{\hat{y}}}_{1 \times M}^{opa , in} sin {ϕ}_{p}^{′} ) {Λ}_{M \times M}^{opa} , \\ 〈 {\vec{\hat{b}}}_{M \times 1}^{opa , out , †} {\vec{\hat{b}}}_{1 \times M}^{opa , out} 〉 \\ = {Λ}_{M \times M}^{opa} 〈 ( {\vec{\hat{x}}}_{M \times 1}^{opa , in} cos {ϕ}_{p}^{′} + {\vec{\hat{y}}}_{M \times 1}^{opa , in} sin {ϕ}_{p}^{′} ) \\ ( {\vec{\hat{x}}}_{1 \times M}^{opa , in} cos {ϕ}_{p}^{′} + {\vec{\hat{y}}}_{1 \times M}^{opa , in} sin {ϕ}_{p}^{′} ) 〉 {Λ}_{M \times M}^{opa}\end{matrix} \qquad ( 32 )$$

where

$${ϕ}_{p}^{′}$$

controlled by the pump phase allows us to select the amplified quadrature. For example,

$${ϕ}_{p}^{′} = 0 ⟹ {\vec{\hat{b}}}_{1 \times M}^{opa , out} \approx {\vec{\hat{x}}}_{1 \times M}^{opa , in} {Λ}_{M \times M}^{opa} , \qquad ( 34 )$$

$${ϕ}_{p}^{′} = π / 2 ⟹ {\vec{\hat{b}}}_{1 \times M}^{opa , out} \approx {e}^{i π / 2} {\vec{\hat{y}}}_{1 \times M}^{opa , in} {Λ}_{M \times M}^{opa} , \qquad ( 35 )$$

$$\begin{matrix}{ϕ}_{p}^{′} = π / 4 ⟹ {\vec{\hat{b}}}_{1 \times M}^{opa , out} \\ \approx {e}^{i π / 4} 〈 {\vec{\hat{x}}}_{1 \times M}^{opa , in} cos π / 4 + {\vec{\hat{y}}}_{1 \times M}^{opa , in} sin π / 4 ) {Λ}_{M \times M}^{opa} ,\end{matrix} \qquad ( 36 )$$

Similarly, expressing the correlation matrices, we get:

$${ϕ}_{p}^{′} = 0 ⟹ 〈 {\vec{\hat{b}}}_{M \times 1}^{opa , out , †} {\vec{\hat{b}}}_{1 \times M}^{opa , out} 〉 = {Λ}_{M \times M}^{opa} 〈 {\vec{\hat{x}}}_{M \times 1}^{opa , in} {\vec{\hat{x}}}_{1 \times M}^{opa , in} 〉 {Λ}_{M \times M}^{opa} \qquad ( 37 )$$

$${ϕ}_{p}^{′} = π / 2 ⟹ 〈 {\vec{\hat{b}}}_{M \times 1}^{opa , out , †} {\vec{\hat{b}}}_{1 \times M}^{opa , out} 〉 = {Λ}_{M \times M}^{opa} 〈 {\vec{\hat{y}}}_{M \times 1}^{opa , in} {\vec{\hat{y}}}_{1 \times M}^{opa , in} 〉 {Λ}_{M \times M}^{opa} \qquad ( 38 )$$

$$\begin{matrix}{ϕ}_{p}^{′} = π / 4 ⟹ 〈 {\vec{\hat{b}}}_{M \times 1}^{opa , out , †} {\vec{\hat{b}}}_{1 \times M}^{opa , out} 〉 \\ = {Λ}_{M \times M}^{opa} \{ \frac{1}{2} ( 〈 {\vec{\hat{x}}}_{M \times 1}^{opa , in} {\vec{\hat{x}}}_{1 \times M}^{opa , in} 〉 + 〈 {\vec{\hat{y}}}_{M \times 1}^{opa , in} {\vec{\hat{y}}}_{1 \times M}^{opa , in} 〉\end{matrix} \qquad ( 38 )$$

$$+ 〈 {\vec{\hat{x}}}_{M \times 1}^{opa , in} {\vec{\hat{y}}}_{1 \times M}^{opa , in} 〉 + 〈 {\vec{\hat{y}}}_{M \times 1}^{opa , in} {\vec{\hat{x}}}_{1 \times M}^{opa , in} 〉 ) \} {Λ}_{M \times M}^{opa} \qquad ( 39 )$$

Note that the quantum quadrature covariance matrix [1,10], Γ_{Q} can be expressed in terms of

$$〈 {\vec{\hat{x}}}_{M \times 1}^{opa , in} {\vec{\hat{x}}}_{1 \times M}^{opa , in} 〉 ; 〈 {\vec{\hat{y}}}_{M \times 1}^{opa , in} {\vec{\hat{y}}}_{1 \times M}^{opa , in} 〉 ; \frac{1}{2} ( 〈 {\vec{\hat{x}}}_{M \times 1}^{opa , in} {\vec{\hat{y}}}_{1 \times M}^{opa , in} 〉 + 〈 {\vec{\hat{y}}}_{M \times 1}^{opa , in} {\vec{\hat{x}}}_{1 \times M}^{opa , in} 〉 ) .$$

Finally, the temporal correlation matrix can be expressed as:

$$〈 {\vec{\hat{a}}}_{T \times 1}^{opa , out , †} {\vec{\hat{a}}}_{1 \times T}^{opa , out} 〉 = {\vec{Ψ}}_{T \times M}^{opa , out , *} 〈 {\vec{\hat{b}}}_{M \times 1}^{opa , out , †} {\vec{\hat{b}}}_{1 \times M}^{opa , out} 〉 = {\vec{Ψ}}_{M \times T}^{opa , out} \qquad ( 40 )$$

### 4.2 SFG-XFROG

Any pure separable multimode quantum state can be expressed as a linear combination of independent single mode states:

$${\vec{\hat{a}}}_{1 \times T}^{FROG , in} = {\vec{\hat{b}}}_{1 \times M}^{FROG , in} {\vec{Ψ}}_{M \times T}^{FROG , in} \qquad ( 41 )$$

The SFG-XFROG can measure:

$$∝ 〈 {\vec{\hat{a}}}_{T \times 1}^{FROG , in , †} {\vec{\hat{a}}}_{1 \times T}^{FROG , in} 〉 = {\vec{Ψ}}_{T \times M}^{FROG , in , *} 〈 {\vec{\hat{b}}}_{M \times 1}^{FROG , in , †} {\vec{\hat{b}}}_{1 \times M}^{FROG , in} 〉 {\vec{Ψ}}_{M \times T}^{FROG , in}$$

$${\vec{Ψ}}_{M \times T}^{FROG , in}$$

$$∝ 〈 {\vec{\hat{b}}}_{M \times 1}^{FROG , in , †} {\vec{\hat{b}}}_{1 \times M}^{FROG , in} 〉 = diag ( {\hat{b}}_{m}^{FROG , in , †} {\hat{b}}_{m}^{FROG , in} ) ∀ m ∈ \{ 1 , … M \}$$

### 4.3 Generating Graph States

The squeezer amplifier produces a multimode squeezed state expressed as:

$${\vec{\hat{a}}}_{1 \times T}^{sq , out} = {\vec{\hat{b}}}_{1 \times M}^{sq , out} {\vec{Ψ}}_{M \times T}^{sq , out} \qquad ( 42 )$$

The projection to the measurement mode basis results in the following:

$${\vec{\hat{b}}}_{1 \times M}^{meas , in} = {\vec{\hat{b}}}_{1 \times M}^{sq , out} {\vec{Ψ}}_{M \times T}^{sq , out} {\vec{Φ}}_{T \times M}^{opa , in} \qquad ( 43 )$$

$${\vec{\hat{b}}}_{1 \times M}^{meas , in} = {\vec{\hat{b}}}_{1 \times M}^{sq , out} {\vec{P}}_{M \times M} \qquad ( 44 )$$

where unitary transformation

$${\vec{P}}_{M \times M} = {\vec{Ψ}}_{M \times T}^{sq , out} {\vec{Φ}}_{T \times M}^{opa , in}$$

enables generating measurement-based all optical quantum graphs. We note the distinction between A optical graphs based on homodyne [11] and the OPA-based graphs introduced here. Engineering the modes of the squeezer and measurement amplifiers can give access to broadband operation unachievable with homodyne-based schemes [12]. This broader bandwidth could provide access to more principal modes and hence more complex graphs than can be measured with homodyne-based schemes [11].

### 4.4 Measuring Graph States

### 4.4.1 Characterize Measurement Amplifier Using SFG-XFROG

We characterize the measurement amplifier by measuring the squeezed vacuum state generated by the measurement amplifier with SFG-XFROG, which gives us:

$$∝ {Λ}_{M \times M}^{meas}$$

$${Ψ}_{M \times T}^{meas , out}$$

All subsequent measurements are done relative to this measurement which acts as the shot noise reference.

### 4.4.2 Quadrature Selective Amplification Followed by SFG-XFROG Measurement

As was mentioned in the OPA section,

$$〈 {\vec{\hat{a}}}_{T \times 1}^{meas , out , †} {\vec{\hat{a}}}_{1 \times T}^{meas , out} 〉 = {\vec{Ψ}}_{T \times M}^{meas , out , *} {Λ}_{M \times M}^{meas} 〈 ( {\vec{\hat{x}}}_{M \times 1}^{meas , in} cos {ϕ}_{p}^{′} + {\vec{\hat{y}}}_{M \times 1}^{meas , in} sin {ϕ}_{p}^{′} ) ( {\vec{\hat{x}}}_{1 \times M}^{meas , in} cos {ϕ}_{p}^{′} + {\vec{\hat{y}}}_{1 \times M}^{meas , in} sin {ϕ}_{p}^{′} ) 〉 {Λ}_{M \times M}^{meas} {\vec{Ψ}}_{M \times T}^{meas , out} \qquad ( 45 )$$

Passing this through the SFG-XFROG gives us access to:

$$- ∝ 〈 {\vec{\hat{a}}}_{T \times 1}^{meas , out , +} {\vec{\hat{a}}}_{1 \times T}^{meas , out} 〉$$

### 4.4.3 Calibrate to Find Input Quadrature Correlation Matrix

By applying the linear transformations

$$∝ {Λ}_{M \times M}^{meas} , {Ψ}_{M \times T}^{meas , out}$$

measured during amplifier characterization, we can measure

$$〈 ( {\vec{\hat{x}}}_{M \times 1}^{meas , in} cos {ϕ}_{p}^{′} + {\vec{\hat{y}}}_{M \times 1}^{meas , in} sin {ϕ}_{p}^{′} ) ( {\vec{\hat{x}}}_{1 \times M}^{meas , in} cos {ϕ}_{p}^{′} + {\vec{\hat{y}}}_{1 \times M}^{meas , in} sin {ϕ}_{p}^{′} ) 〉 .$$

Note that the proportionality constant for the two experiments is the same and therefore can be normalized for.

### 4.4.4 Diagonalizing Quadrature Correlation Matrix

$$〈 {\vec{\hat{x}} ( {ϕ}_{p}^{′} )}_{M \times 1}^{meas , in} {\vec{\hat{x}} ( {ϕ}_{p}^{′} )}_{1 \times M}^{meas , in} 〉 = {V}_{M \times M} 〈 {\vec{\hat{x}} ( {ϕ}_{p}^{′} )}_{M \times 1} {\vec{\hat{x}} ( {ϕ}_{p}^{′} )}_{1 \times M} 〉 {V}_{M \times M}^{- 1}$$

where V_{M×M} is the matrix describing the basis change.

### 4.4.5 Covariance Matrix Measurement

The covariance matrix, Γ_{Q}, of the graph state

$${\vec{\hat{b}}}_{1 \times M}^{meas , in}$$

can be expressed in terms of its submatrices as:

$${\vec{Γ}}_{Q 2 M \times 2 M} = ( \begin{matrix}\vec{{Γ}_{11} M \times M} & \vec{{Γ}_{12} M \times M} \\ \vec{{Γ}_{21} M \times M} & \vec{{Γ}_{22} M \times M}\end{matrix} ) \qquad ( 46 )$$

The submatrices can be measured through 4 spectrographic measurements:
Amplifier characterization for calibration

$${\vec{Γ}}_{11 M \times M} = 〈 {\vec{\hat{x}}}_{M \times 1}^{meas , in} {\vec{\hat{x}}}_{1 \times M}^{meas , in} 〉$$

measurement with quadrature selective amplification with

$${ϕ}_{p}^{′} = 0.$$

$${\vec{Γ}}_{22 M \times M} = 〈 {\vec{\hat{y}}}_{M \times 1}^{meas , in} {\vec{\hat{y}}}_{1 \times M}^{meas , in} 〉$$

measurement with quadrature selective amplification with

$${ϕ}_{p}^{′} = π / 2$$

$${\vec{Γ}}_{12 M \times M} = \frac{1}{2} ( 〈 {\vec{\hat{x}}}_{M \times 1}^{meas , in} {\vec{\hat{y}}}_{1 \times M}^{meas , in} 〉 + 〈 {\vec{\hat{y}}}_{M \times 1}^{meas , in} {\vec{\hat{x}}}_{1 \times M}^{meas , in} 〉 )$$

measurement with quadrature selective amplification with

$${ϕ}_{p}^{′} = π / 4$$

and knowledge of

$$〈 {\vec{\hat{x}}}_{M \times 1}^{meas , in} {\vec{\hat{x}}}_{1 \times M}^{meas , in} 〉 and 〈 {\vec{\hat{y}}}_{M \times 1}^{meas , in} {\vec{\hat{y}}}_{1 \times M}^{meas , in} 〉 .$$

Note that \vec{Γ₂₁}_{MXM}=(\vec{Γ₁₂}_{M×M})

### 4.5 Measuring Input Quantum State

### 4.5.1 Diagonalizing Covariance Matrix of Graph State

Diagonalization of Γ_{Q} results in linear transformation O and the diagonal matrix K given as [1]

$${\vec{Γ}}_{Q 2 M \times 2 M} = {\vec{O}}_{2 M \times 2 M} {\vec{K}}_{2 M \times 2 M} {\vec{O}}_{2 M \times 2 M}^{T} \qquad ( 47 )$$

$${\vec{O}}_{2 M \times 2 M} = ( \begin{matrix}ℜ {\vec{P}}_{M \times M} & \text{?} {\vec{P}}_{M \times M} \\ - \text{?} {\vec{P}}_{M \times M} & ℜ {\vec{P}}_{M \times M}\end{matrix} ) \qquad ( 48 )$$

Here,

$${\vec{K}}_{2 M \times 2 M} = diag ( 〈 {\hat{x}}_{1}^{sq , out} {\hat{x}}_{1}^{sq , out} 〉 , .. , \\ 〈 {\hat{x}}_{M}^{sq , out} {\hat{x}}_{M}^{sq , out} 〉 ; 〈 {\hat{y}}_{1}^{sq , out} {\hat{y}}_{1}^{sq , out} 〉 , .. , 〈 {\hat{y}}_{M}^{sq , out} {\hat{y}}_{M}^{sq , out} 〉 )$$

corresponds to the covariance matrix of the squeezed vacuum state in the principal basis characterizing the multimode squeezed state input in the principal basis entirely.

Additionally, knowledge of \vec{O}_{2M×2M} gives access to complex \vec{P}_{M×M}. For the case where the OPA has been engineered so that the pump is unchirped at the center of the waveguide [2], the input temporal mode transformation is related to the output temporal mode transformation through

$${\vec{Φ}}_{T \times M}^{opa , in} = {\vec{Ψ}}_{T \times M}^{* , opa , out} .$$

In this case,

$${\vec{Ψ}}_{M \times T}^{sq , out} = {{P}_{M \times M} ( {\vec{Ψ}}_{T \times M}^{* , opa , out} )}^{†} = {P}_{M \times M} {\vec{Ψ}}_{M \times T}^{opa , out} ,$$

providing access to the temporal modes of the input multimode squeezed state. Access to

$${\vec{Ψ}}_{M \times T}^{sq , out}$$

gives access to the relative phase between the different modes which determines the angle between the different squeezed vacuum states. Our scheme provides us access to the covariance matrix of the multimode input ultrafast quantum state in the principal and temporal bases.

### 4.5.2 Expressing Amplified Squeezed Quadrature Output in Terms of Squeezer Output

Expressing the submatrices of the graph state in terms of the submatrices of the input squeezed state:

$${\vec{Γ}}_{11 M \times M} = ℜ {\vec{P}}_{M \times M}^{meas , in} 〈 {\vec{\hat{x}}}_{M \times 1}^{sq , out} {\vec{\hat{x}}}_{1 \times M}^{sq , out} 〉 ℜ {\vec{P}}_{M \times M}^{meas , in , T} + \text{?} {\vec{P}}_{M \times M}^{meas , in} 〈 {\vec{\hat{y}}}_{M \times 1}^{sq , out} {\vec{\hat{y}}}_{1 \times M}^{sq , out} 〉 \text{?} {\vec{P}}_{M \times M}^{meas , in , T} \qquad ( 49 )$$

$${\vec{Γ}}_{12 M \times M} = - ℜ {\vec{P}}_{M \times M}^{meas , in} 〈 {\vec{\hat{x}}}_{M \times 1}^{sq , out} {\vec{\hat{x}}}_{1 \times M}^{sq , out} 〉 \text{?} {\vec{P}}_{M \times M}^{meas , in , T} \qquad ( 49 )$$

$$+ \text{?} {\vec{P}}_{M \times M}^{meas , in} 〈 {\vec{\hat{y}}}_{M \times 1}^{sq , out} {\vec{\hat{y}}}_{1 \times M}^{sq , out} 〉 ℛ {\vec{P}}_{M \times M}^{meas , in , T} \qquad ( 50 )$$

$$\vec{{Γ}_{21 M \times M}^{sq , out}} = ( {\vec{{Γ}_{21 M \times M}}}^{T} \qquad ( 51 )$$

$$\vec{{Γ}_{22 M \times M}} = \text{?} {\vec{P}}_{M \times M}^{meas , in} 〈 {\vec{\hat{x}}}_{M \times 1}^{sq , out} {\vec{\hat{x}}}_{1 \times M}^{sq , out} 〉 \text{?} {\vec{P}}_{M \times M}^{meas , in , T} \qquad ( 51 )$$

$$+ ℛ {\vec{P}}_{M \times M}^{meas , in} 〈 {\vec{\hat{y}}}_{M \times 1}^{sq , out} {\vec{\hat{y}}}_{1 \times M}^{sq , out} 〉 ℛ {\vec{P}}_{M \times M}^{meas , in , T} \qquad ( 52 )$$

For the experiments conducted here, we do not measure the cross quadrature spectrogram and the direct diagonalization of the quadrature correlation matrix is valid under the assumption

$$\text{?} \{ {\vec{P}}_{M \times M}^{meas , in , T} \} = {0}_{M \times M} .$$

Under this assumption, we can diagonalize

$$\vec{{Γ}_{11 M \times M}} = 〈 {\vec{\hat{x}}}_{M \times 1}^{meas , in} {\vec{\hat{x}}}_{1 \times M}^{meas , in} 〉$$

directly to obtain

$$ℛ {\vec{P}}_{M \times M}^{meas , in} and 〈 {\vec{\hat{x}}}_{M \times 1}^{sq , out} {\vec{\hat{x}}}_{1 \times M}^{sq , out} 〉 .$$

### Fourth Example: Frequency Resolved Optical Gating Using Parametric Amplification for characterizing Ultrafast Temporally Multimode Squeezed States

### A. Motivation

Optical quantum information processing and communication have been the subjects of intense study, due to light's long coherence time and information density capacity [1-6]. Encoding quantum information in the temporal modes of ultrashort pulses, which are overlapping orthonormal modes in time and frequency, allows for multiple modes to exist within the same pulse and spatial mode [7]. This basis allows a single pulse to carry a large amount of information, making it an attractive and natural option for ultrafast time-multiplexed communication and computation [8]. High-bandwidth single-mode pulses also carry a large amount of information, and recent progress has seen quantum optics extended even to the attosecond regime [9-11].

One difficulty of working with ultrafast quantum states is that the efficiency of operations degrades rapidly with the mismatch between modes, so characterizing the mode shapes of the quantum state is paramount to manipulating these states and realizing useful computation and communication. Using squeezed states to perform continuous-variable quantum computation [12,13] and secure quantum communication [14,15] is one path to quantum advantage which has the benefit of deterministic state generation. Characterizing ultrafast quantum states has therefore been an active field of study.

In particular, the tomography of temporally multimode squeezed states using optical parametric amplifiers (OPAs) has been the subject of intense recent study [16-18]. OPAs are well-suited to generating and measuring these states due to their inherently multimode [19] and broadband nature [20], and their phase-sensitive amplification which allows for quadrature-selective measurement while preserving some quantum information [21,22]. Because of their broad bandwidth [23], many temporal modes can exist in an ultrashort multimode squeezed pulse generated by an OPA. Mode-selective squeezing measurements allow us to access the squeezing in the principal modes, which is higher than the mode-averaged (e.g. time-averaged) squeezing which is typically measured [16,17,24].

One challenge in temporal-mode continuous-variable (CV) quantum optics is that the relevant basis is typically unknown, as the principal squeezing modes depend on pump shape and phase matching and are sensitive to physical imperfections. Most detection strategies require mode-matched local oscillators [25] or reconfigurable mode projections [26,27]. Some techniques have a tradeoff between the amount of information gained about the state and the modes [28], and others rely on prior knowledge about the state [29,30]. Quantum pulse gates can decompose the state into multiple modes by shaping a pump pulse [31,32] and have been used to decompose a state into its component modes adaptively [30,33]. Electro-optic sampling has also been used to characterize the temporal nature of squeezed light [34-37], but it necessitates sub-cycle pulses, which limits it to quantum pulses with longer wavelengths. Lastly, decomposition of data measured using homodyne detection [25,38] can also be used to identify the principal modes of a state. Many of these techniques require pulse shaping and feedback loops, and their resolution and bandwidth is typically limited by pulse shaping performance. However, a technique capable of directly reconstructing both the temporal mode structure and quantum statistics of ultrafast multimode squeezed states without requiring mode-matched local oscillators or adaptive pulse shaping remains a significant challenge.

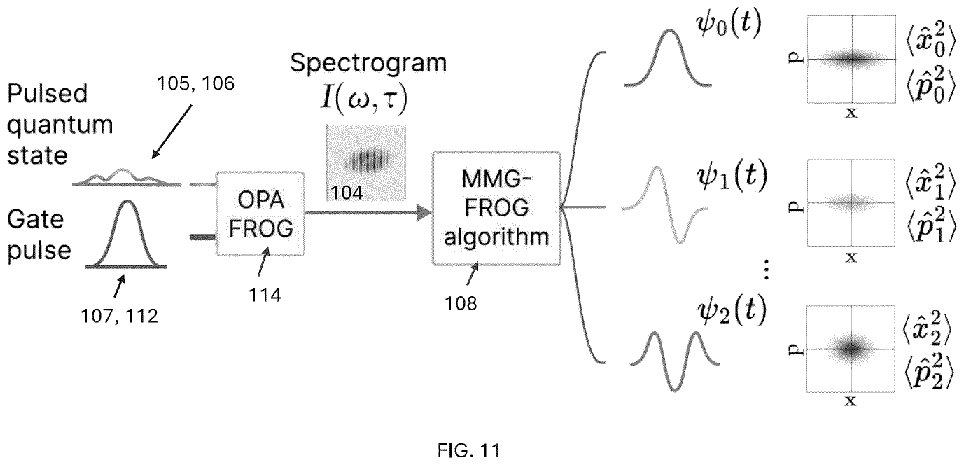

Here we introduce multimode Gaussian OPA frequency-resolved optical gating (MMG-OPA-FROG), a phase-sensitive parametric variant of FROG in which a broadband OPA serves as the nonlinear gate, and show how it can be used to characterize Gaussian states through their quadrature variances and simultaneously determine their principal temporal mode basis. We propose and numerically simulate using an OPA as the nonlinear element in a frequency-resolved optical gating (FROG) setup [39] and develop a retrieval algorithm to account for the multimode and quantum nature of the input state. The concept is illustrated in FIG. 11, which illustrates the optical system comprises a Frequency Resolved Optical Gating (FROG)- based scheme comprising the nonlinear medium 114 wherein the optical nonlinear process comprises a phase-sensitive parametric amplification process such that the information inferred includes the expectation values of second order polynomials of quadrature operators (second-order quadrature moments) and the complex temporal envelope describing a temporally localized quantum state (temporal mode profiles).

FROG is popular due to its simplicity of setup and robustness to experimental imperfections while having high resolution and bandwidth. Employing an OPA as the nonlinear process in FROG has been used to measure pulses with extremely low energy [40-42], which is possible because OPAs can amplify pulses by a factor of as large as 108 while having low dispersion. Furthermore, the complex temporal envelope of quantum correlations between twin beams has been measured using FROG [43]. Thus, an OPA-based FROG is an ideal candidate for characterizing low-photon-number ultrashort quantum states. The phase-sensitive nature of the OPA provides access to the second-order moments, from which it is possible to fully characterize Gaussian states and even partially characterize non-Gaussian states. This technique gives the full temporal mode information, including the complex mode phase, which is crucial for manipulating the modes. MMG-OPA-FROG can be applied even for single-mode ultrafast quantum states, in order to take advantage of the high resolution and flexibility in wavelength. We have recently explored multimode squeezed state reconstruction using sum-frequency generation FROG [44]. The present work instead considers the distinct measurement regime of OPA-only FROG and develops the corresponding formalism for recovering the temporal modes and second-order quadrature moments.

We show how the FROG spectrogram is related to the mode shapes and second-order moments and then show numerically how ultrafast multimode Gaussian states can be characterized using a FROG retrieval algorithm. In addition, we quantify the resiliency to noise in the spectrogram, showing a successful retrieval even in the presence of noise, and how to extract the relative squeezing angles from the mode shapes. We show how to extract information necessary for temporal mode quantum information processing and communication using a minimal experimental setup and few assumptions.

### B. Example Theory

The MMG-OPA-FROG spectrogram can be generated by sending the MMG state and gating pulse as the pump into an OPA and measuring the output spectra at various relative delays between the input state and gate. The information in the spectrogram allows for the reconstruction of the complex mode shape of a classical pulse, and it also allows for reconstruction of multiple modes in the same pulse. This spectrogram I(ω, τ) is the expectation value of the photon number of the output state at delay τ and frequency ω

I(ω, τ)= [symbol] (â^{out}(ω, τ))^{†}â^{out}(ω, τ) [symbol] , (1)

where â^{out}(ω, τ) is the annihilation operator just before the spectrometer and the expectation value is over many pulses.

We make the following assumptions on the OPA: it is high-gain and it has a much broader bandwidth than the mode basis of the input state. The large-bandwidth approximation, common in FROG reconstruction, means the OPA's principal modes are extremely narrow in time, so we approximate them as delta functions in time. We also assume that the delay z is applied to the gating pulse. The annihilation operators at the output of a broadband OPA can then be written as a function of the complex squeezing parameters ξ(t′)=r(t′)exp (iθ(t′)) and input state's annihilation operators in the time bin basis âⁱⁿ(t) as

â^{out}(t,τ)=cosh r(t′)âⁱⁿ(t)−e^{iθ(t′)}sinh r(t′)(âⁱⁿ(t))^{†}, (2)
where t′≡t−τ is the shifted time coordinate. The complex squeezing parameters are dependent on the gating pulse field E_{g}(t′) through ξ(t′)=κE_{g}(t′) for nonlinear coupling strength κ.

The high-gain approximation entails that, for the highest-gain output modes of the OPA, r»1, so cosh r≈sinh r≈exp (r)/2. We assume that the spectrometer only detects these high-gain modes. We do not make any assumptions on the gating pulse's complex phase, although it must be known.

We now define how we would like to decompose the multimode Gaussian input state. Any Gaussian state can be decomposed into a principal mode basis in which the states are uncorrelated with each other [45]. The input state's annihilation operator can be decomposed into its principal mode basis {ψₙ(t)} as:

$${\hat{a}}^{in} ( t ) = {\sum }_{n} {ψ}_{n}^{*} ( t ) {\hat{a}}_{n}^{in} \qquad ( 3 )$$

Broadband quadrature operators can also be defined:

$${\hat{x}}_{n}^{in} = \frac{1}{2} ( {\hat{a}}_{n}^{in} + {\hat{a}}_{n}^{in †} ) \qquad ( 4 )$$

$${\hat{p}}_{n}^{in} = \frac{1}{2 i} ( {\hat{a}}_{n}^{in} + {\hat{a}}_{n}^{in †} ) \qquad ( 5 )$$

This mode basis is orthonormal, such that

$$\int dt {ψ}_{m} ( t ) {ψ}_{n}^{*} ( t ) = {δ}_{mn} .$$

In this basis, the expectation values of products of the quadratures of different modes are zero for zero mean field states, such as squeezed states

$$( 〈 {\hat{q}}_{m} {\hat{q}}_{n}^{′} 〉 ∝ {δ}_{mn} for \hat{q} , {\hat{q}}^{′} ∈ \{ {\hat{x}}^{in} , {\hat{p}}^{in} \} ) .$$

Since we are focusing on the characterization of multimode squeezed states, we assume the mean-field is zero. For such states, the quadratures can always be rotated such that the covariance

$$〈 {\hat{x}}_{n}^{in} {\hat{p}}_{n}^{in} + {\hat{p}}_{n}^{in} {\hat{x}}_{n}^{in} 〉$$

is zero, and the rotation can be absorbed into the mode as a complex phase, so we set that term to zero (see Supplementary Information for further details).

With these assumptions, the spectrogram is

$$I ( ω , τ ) = {\sum }_{n} [ \begin{matrix}〈 {( {\hat{x}}_{n}^{in} )}^{2} 〉 {\vert \text{?} \{ G ( {t}^{′} ) Im [ {ψ}_{n} ( t ) {e}^{i ( δ ϕ ( {t}^{′} ) + {ω}_{s} τ} ] \} \vert}^{2} + \\ 〈 {( {\hat{p}}_{n}^{in} )}^{2} 〉 {\vert \text{?} \{ G ( {t}^{′} ) Re [ {ψ}_{n} ( t ) {e}^{i ( δ ϕ ( {t}^{′} ) + {ω}_{s} τ} ] \} \vert}^{2}\end{matrix} + \qquad ( 6 )$$

$$\frac{1}{8} ( {\vert \text{?} \{ G ( {t}^{′} ) {e}^{- i δ ϕ ( {t}^{′} )} {ψ}_{n}^{*} ( t ) \} \vert}^{2} + {\vert \text{?} \{ G ( {t}^{′} ) {e}^{i δϕ ( {t}^{′} )} {ψ}_{n} ( t ) \} \vert}^{2} ) ] , \qquad ( 6 )$$

where ωₛ is the central frequency of the input state's modes, ψₙ(t) are the input principal modes, G(t′)=e^{-iδφ(t′)+r(t′)} is a function of the gain and phase of the gating pulse, and

$$δϕ ( {t}^{′} ) = θ ( {t}^{′} ) / 2 - {ω}_{s} {t}^{′} . {\hat{x}}_{n}^{in} and {\hat{p}}_{n}^{in}$$

are the quadrature operators for the input state for mode n.

This form of the spectrogram is specific to bases in which the states in the modes are uncorrelated, so finding the modes which contribute in this way to the spectrogram will give us the principal modes, effectively diagonalizing the covariance matrix. The spectrogram is the incoherent sum of the principal-mode spectrograms, with four terms per mode. Two of the terms are weighted by the two non-zero second-order moments, and the last two are independent of the state's statistics. The angle in quadrature phase space along which the state is squeezed is encoded in the relative phase between the modes, allowing us to recover the covariance of the squeezed state.

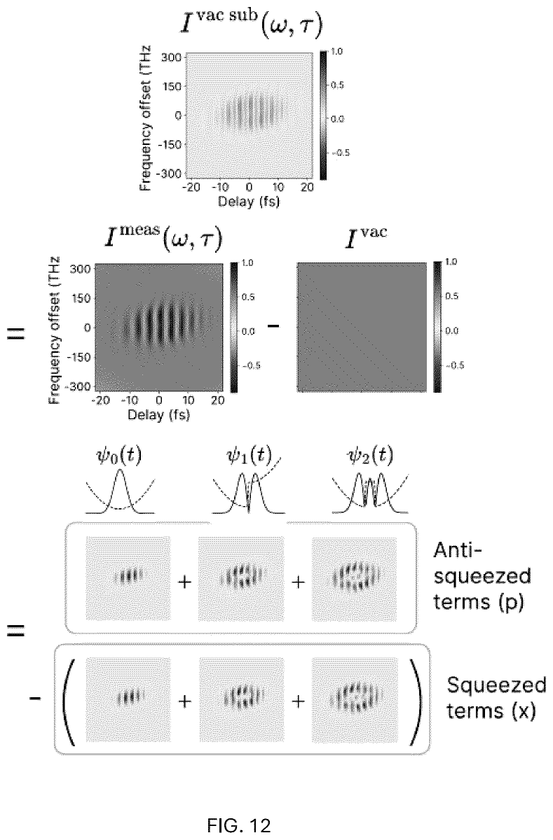

For the case of a vacuum input, the spectrogram simplifies to the constant I^{vac} (ω, τ) |∫ dtG(t)|²/4, which is just the optical parametric generation from the OPA. Because the spectrogram is non-zero for vacuum input, it is possible to extract the absolute squeezing parameters by normalizing the extracted mode shapes using the vacuum spectrogram as a reference. Furthermore, if the vacuum spectrogram is subtracted from a measured spectrogram, the last two terms and all contributions from un-squeezed modes in the input state are canceled out, truncating the sum to only those modes which are occupied by a non-vacuum state. This spectrogram I^{vac sub} (ω, τ)≡I(ω, τ)−I^{vac} (ω, τ), which we call the vacuum-subtracted spectrogram, has negative components if either quadrature has noise below the shot noise level. The negativity of the vacuum-subtracted spectrogram thus gives an indication of whether there is squeezing. An example vacuum-subtracted spectrogram for a multimode squeezed state is shown in FIG. 12 using 25-fs Hermite-Gaussian modes with a moderate chirp and a 100-fs chirped gating pulse. The modes have 3 dB, 4 dB, and 2 dB of squeezing, in order of increasing Hermite polynomial order.

### C. Results

We numerically simulated the generation of the OPA FROG spectrogram and retrieved the mode shapes and quadrature variances using an MMG-OPA-FROG algorithm. The developed retrieval algorithm is similar to the one in [46] to extract the shape of modes, the variances in \hat{x} and \hat{p}, and the relative angles of squeezing. The data constraint is adapted to handle negative terms in the vacuum-subtracted spectrogram using Lagrangian multipliers. Gradient descent is used to enforce the nonlinear constraint, which ensures that the spectrogram is indeed in the form of Eq. 6. We use one gradient term for the \hat{x}² and \hat{p}² terms for each mode to update the estimates for the mode shapes and variances, followed by a Gram-Schmidt decomposition to ensure mode orthonormality. Further details of the algorithm are in the Supplemental Information.

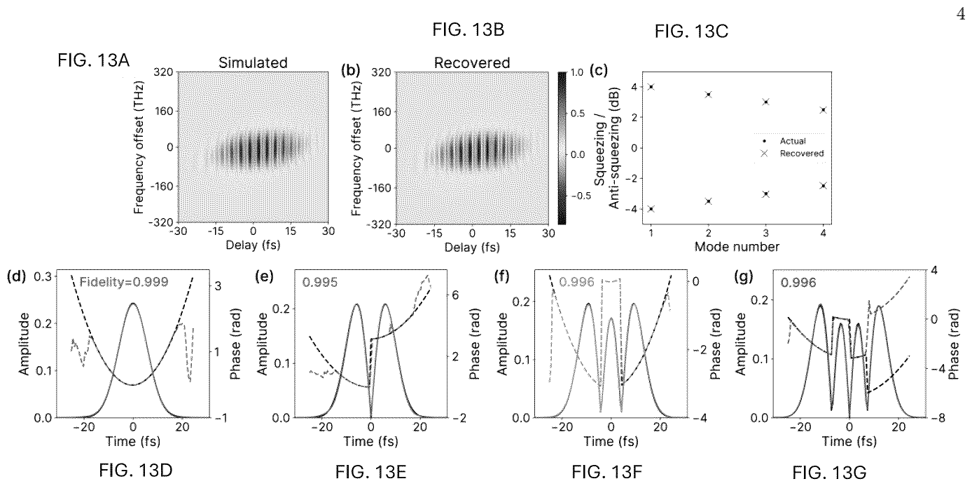

We numerically generate the spectrogram from a multimode squeezed state composed of 30-fs-long chirped Hermite Gaussian temporal modes, which are a good approximation for the modes that arise from a broadband OPA [19], using Eq. 6. The gating pulse is a mildly chirped 100-fs Gaussian pulse which amplifies the state by 50 dB. The results, after 10,000 iterations of the algorithm, are shown in FIG. 13. The loss, which is the root mean square distance between the simulated and recovered spectrograms normalized by the root mean square of the measured spectrogram, is 0.0026.

The mode fidelity of each mode, written as an inset in FIGS. 13(d)-(g), which we define as the squared overlap between the actual and recovered modes as

$${\vert \int dt {ψ}_{n}^{*} ( t ) {ψ}_{n}^{rec} ( t ) \vert}^{2} ,$$

is above 0.995 for all modes. The amount of actual and recovered squeezing and antisqueezing is shown in FIG. 13(c), with all recovered values falling within 2% of the actual values. All of these quantities indicate a successful reconstruction of the state. This demonstrates that the MMG-OPA-FROG algorithm can accurately recover both the temporal structure and quantum statistics of ultrafast multimode squeezed states directly from the measured spectrogram.

The algorithm can identify the relative phases, which is equivalent to the squeezing angles for a multimode squeezed state, which can be used to reconstruct the full covariance matrix. In this case the relative phases are zero. Recovery of arbitrary relative phase is shown in the Supplementary Information.

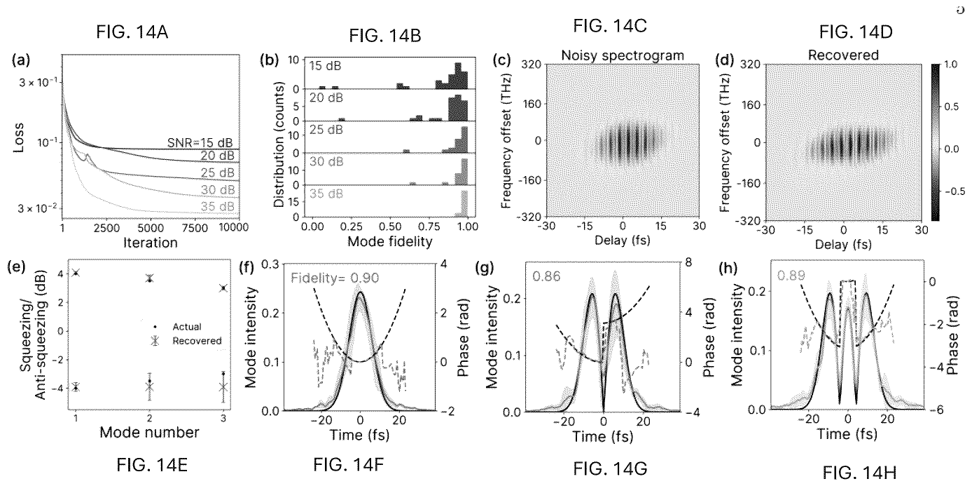

We characterize the noise-tolerance of the algorithm by adding Gaussian noise to the simulated spectrogram to achieve various signal-to-noise ratios (SNRs) and characterizing the loss and mode fidelity, as shown in FIGS. 14(a) and (b). We employ a zeroing mask over the data outside the significantly non-zero portion of the spectrogram so that the noise in the wings does not prevent convergence. In order to simulate a realistic recovery procedure, we use the common bootstrapping technique to generate the error bars from a single noisy spectrogram at each noise level [47]. We can see that the recovery decreases in effectiveness with higher noise, and that some retrievals fail (note the heavy tails of the fidelity distributions towards low fidelity for low SNR in FIG. 14(b)). These tails indicate that some retrievals fail, so we set a threshold of 10% loss for considering a state recovery successful, and the following plots are based on successful recoveries.

We show an example mode retrieval at an SNR of 15 dB in FIGS. 14(c-h). The mode retrieval is slightly less successful than in the noiseless case, with the squeezing values in particular having a large variance. However, the average mode fidelities, shown in the insets of FIGS. 14(f-h), are above 0.85, and the mode variances are within 10% of their actual values, showing that the mode shape reconstruction was successful even in the presence of noise.

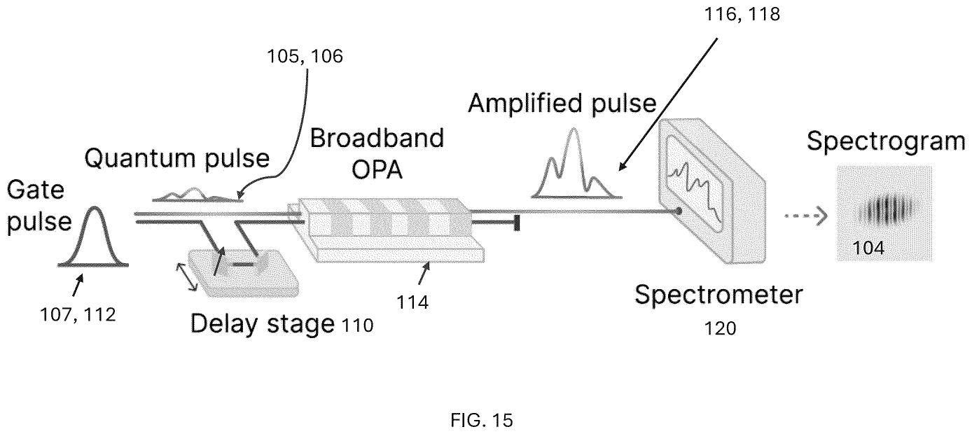

The experimental prospects for generating and characterizing a multimode squeezed state using MMG-OPAFROG are promising. A potential setup to implement it is shown in FIG. 15. Multimode squeezed states have been generated and characterized using OPAs [16-18], and OPAs have been used as the nonlinear process in FROG setups for classical pulses [40-42]. OPAs with a broad bandwidth, which is necessary for the spectrogram to be in this form, are available in integrated photonics [23]. Furthermore, the length of the pump pulse does not limit the resolution of the reconstruction, within reason, and so the pump pulse can be any pulse that allows for broadband and high-gain operation of the OPA, lifting the pulse-shaping requirement present in homodyne detection.

One difficulty of implementing this state retrieval scheme is minimizing the loss between the state generation and measurement OPA, so that the squeezing is maintained. One solution is putting both OPAs on one integrated photonic chip, which reduces loss and allows for significant squeezing to be measured [21]. Another potential difficulty lies in stabilizing the relative delay between the state and gating pulse, since the amplified state coming out of an OPA is very sensitive to the relative phase of the pulses and as such it must be very well stabilized. There are, however, techniques for calibrating the phase given instabilities [42].

Currently, except for the mode orthonormalization step, the computation time of the algorithm scales linearly with the number of modes and with the number of data points, since each data constraint and gradient descent step must be implemented mode-by-mode and data-point by data-point, leading to a scaling of [symbol] (M N_{ω}N_{τ}) for M the number of modes recovered, N_{ω} the number of frequency data points, and N_{τ} the number of delays measured. The mode orthonormalization, which is a Gram-Schmidt decomposition, scales as [symbol] (N_{ω}M²), but in practice up to M=40 modes the linear factor dominates. For retrieving five modes using 10,000 iterations, twelve minutes are required on an Apple M1 processor with no GPU speedup. Due to the linear scaling, by optimizing the algorithm further and using dedicated hardware it may be possible to scale up the retrieval to a larger number of modes with a reasonable computation time.

Further work includes advancing the measurement scheme, including the covariance. The covariance term is not in the typical form of a FROG spectrogram, so the algorithm must be adjusted to account for this. The covariance would grant us access to some information on non-Gaussian states [35]. To characterize non-Gaussian states fully, we require access to all of the statistics of the state, not just the second-order moments. If a single-shot spectrometer is available, it may be possible to perform full multimode state tomography [30].

### D. Advantages and Improvements

In summary, we propose and numerically simulate the characterization of a multimode squeezed state using OPA FROG. We derive the OPA FROG spectrogram of a multimode quantum state as a function of the second-order moments and mode shapes. We describe a multimode FROG algorithm to extract the mode shapes and \hat{x} and \hat{p} variances. This technique can be implemented using available experimental techniques and equipment, particularly the scalable platform of integrated photonics, and has the potential to characterize a wide range of mode shapes and states. Unlike existing techniques, MMG-OPA-FROG does not have demanding gating pump pulse requirements, and there are few limits on the range of wavelengths that can be characterized. There are no assumptions on the shapes of the modes or on the gating pulse, and the assumption that the OPA used in FROG is broadband and high-gain is consistent with current experiments. Tomography and access to the covariance for states beyond squeezed vacuum may become available by further adapting the algorithm.

The ability to characterize ultrafast temporally multimode Gaussian states is central to implementing an optical temporal-mode-based communication and computation system, since knowing the mode shapes is crucial for mode matching and manipulation. This technique is one possible tool in the toolbox of ultrafast optical temporal mode computing and communication.

### E. Supplementary Information on Characterizing Ultrafast Temporally Multimode Squeezed States Using Frequency Resolved Optical Gating

### 1. Theoretical Formalism

a. Quantum OPA FROG with Arbitrary OPA and Signal Modes

We start by considering a frequency-resolved optical gating (FROG) setup with an OPA as its nonlinearity, deriving the spectrogram as the expectation value of quantum operators:

I(ω,τ)= [symbol] \hat{N}(ω,τ) [symbol] = [symbol] â^{out,†}(ω,τ)â^{out}(ω,τ) [symbol] . (S1)
where I is spectrogram and â^{out} (ω, τ) is annihilation operator in the Heisenberg picture after the OPA in the frequency mode ω at gate delay τ. Expanding the output operator in terms of the temporal modes of the OPA and then in terms of the operators of the signal input into the OPA âⁱⁿ, using the Bogoliubov transform, we have

$${\hat{a}}^{out} ( ω ) = {\sum }_{m} {ψ}_{m}^{{OPA}^{*}} ( ω , τ ) {\hat{a}}_{m}^{out} \qquad ( S 2 )$$

$$= {\sum }_{m} {ψ}_{m}^{{OPA}^{*}} ( ω , τ ) ( cosh {r}_{m} ( τ ) {\hat{a}}_{m}^{in} - sinh {r}_{m} ( τ ) {e}^{i {θ}_{m} ( τ )} {\hat{a}}_{m}^{in †} ) \qquad ( S 3 )$$

where ξₙ≡rₙe^{iθm} Are the complex gain parameters of the OPA for each mode m and

$${ψ}_{m}^{OPA} ( ω )$$

are the OPA modes in the frequency basis. The modes are delay-dependent since their position in time is dependent on the relative position of the pump pulse to the signal pulse, and the gain parameters are delay-dependent because the pump phase determines which signal quadrature is amplified. The mode annihilation operators in a basis {ψₘ(ω)} are defined as

âₘ=∫dωψₘ(ω)â(ω) (S4)
which, for an orthonormal basis leads to the complementary transformation

$$\hat{a} ( ω ) = {\sum }_{m} {ψ}_{m}^{*} ( ω ) {\hat{a}}_{m} \qquad ( S 5 )$$

We can expand the spectrogram in terms of sums over the OPA modes, suppressing the delay dependence of the modes and gain parameters for now:

$$I ( ω , τ ) = {\sum }_{m , {m}^{′}} 〈 {ψ}_{m}^{OPA} ( ω ) ( cosh {r}_{m} {\hat{a}}_{m}^{in †} - sinh {r}_{m} {e}^{- i {θ}_{m}} {\hat{a}}_{m}^{in} ) {ψ}_{m}^{{OPA}^{*}} ( ω ) ( cosh {r}_{{m}^{′}} {\hat{a}}_{m}^{in} - sinh {r}_{{m}^{′}} {e}^{i {θ}_{{m}^{′}}} {\hat{a}}_{m}^{in †} ) 〉 \qquad ( S 6 )$$

We now introduce the uncorrelated signal mode basis

$$\{ {ψ}_{n}^{sig} ( ω ) \}$$

and decompose the signal into that basis (subscript n denotes an operator the signal basis while m indicates one in the OPA basis):

$${\hat{a}}_{m}^{in} = \int d ω {ψ}_{m}^{OPA} ( ω ) {\hat{a}}^{in} ( ω ) \qquad ( S 7 )$$

$$= \int d ω {ψ}_{m}^{OPA} ( ω ) {\sum }_{n} {ψ}_{n}^{sig *} ( ω ) {\hat{a}}_{n}^{in} \qquad ( S 8 )$$

$$= {\sum }_{n} {σ}_{mn} {\hat{a}}_{n}^{in} \qquad ( S9 )$$

where

$${σ}_{mn} ≡ \int d ω {ψ}_{m}^{OPA} ( ω ) {ψ}_{n}^{sig *} ( ω )$$

is the overlap of a signal and OPA mode. Now, we make the high-gain approximation, which is that the detected modes have high gain parameters rₘ such that cosh rₘ≈sinh rₘ≈exp (rₘ)/2. This approximation is relevant when using a photodetector which is not sensitive to single photons, or rather, one which is used to detect mainly classical macroscopic states. With this approximation and plugging in the definition for σₘₙ we have:

$$I ( ω , τ ) = {\sum }_{m , {m}^{′} , n , {n}^{′}} 〈 {ψ}_{m}^{OPA} ( ω ) {ψ}_{m}^{OPA *} ( ω ) \frac{{e}^{{r}_{m} + {r}_{m}^{′}}}{4} ( {σ}_{mn}^{*} {\hat{a}}_{n}^{in †} - {e}^{- i {θ}_{m}} {σ}_{mn} {\hat{a}}_{n}^{in} ) ( {σ}_{{m}^{′} {n}^{′}} {\hat{a}}_{{n}^{′}}^{in} - {e}^{i {θ}_{{m}^{′}}} {σ}_{{m}^{′} {n}^{′}}^{*} {\hat{a}}_{m}^{in †} ) 〉 \qquad ( S10 )$$

Using that the signal modes are uncorrelated, that is, that

$$〈 {\hat{q}}_{n} {\hat{q}}_{{n}^{′}}^{′} 〉 ∝ {δ}_{{nn}^{′}}$$

for \hat{q}, \hat{q}′ ϵ{âⁱⁿ, â^{in†}}, we arrive at

$$I ( ω , τ ) = {\sum }_{m , {m}^{′} , n} {ψ}_{m}^{OPA} ( ω , τ ) {ψ}_{{m}^{′}}^{{OPA}^{*}} ( ω , τ ) \frac{{e}^{{r}_{m} + {r}_{{m}^{′}}}}{4} ( {σ}_{mn}^{*} {σ}_{{m}^{′} n} 〈 {\hat{a}}_{n}^{in †} {\hat{a}}_{n}^{in} 〉 - {e}^{- i {θ}_{m}} {σ}_{mn} {σ}_{{m}^{′} n} 〈 {( {\hat{a}}_{n}^{in} )}^{2} 〉 - {e}^{- i {θ}_{{m}^{′}}} {σ}_{mn}^{*} {σ}_{{m}^{′} n}^{*} 〈 {( {\hat{a}}_{n}^{in †} )}^{2} 〉 + {e}^{i ( {θ}_{{m}^{′}} - {θ}_{m} )} {σ}_{mn} {{σ}^{*}}_{{m}^{′} n} 〈 {\hat{a}}_{n}^{in} {\hat{a}}_{n}^{in †} 〉 ) . \qquad ( S11 )$$

This shows that we need to know the overlap between the modes of the OPA and the input state in order to interpret the results. This indicates that the spectrogram contains all second-order moments of the state, which fully characterize a zero-mean-field Gaussian state.

b. Quantum OPA FROG with a Large-Bandwidth OPA

A large-bandwidth OPA has modes which approach delta functions in time and plane waves in frequency:

$${ψ}_{m}^{OPA} ( ω ) \to \text{?} \{ δ ( {t}_{m} ) \} = {e}^{- i ω {t}_{m}} \qquad ( S12 )$$

This is because the temporal width of OPA modes is inversely proportional to the product of the bandwidths of the pump laser and of the phase matching of the OPA [1].

The mode overlap then becomes

$${σ}_{mn} = \int d ω {e}^{- i ω {t}_{m}} {ψ}_{n}^{sig *} ( ω ) = {ψ}_{n}^{sig *} ( {t}_{m} ) \qquad ( S13 )$$

where ψ^{sig}(t)ₙ are the inverse Fourier transforms of the signal modes. We now drop the m subscript and simply refer to the OPA modes by their time t. Plugging all this into Eq. S11 results in

$$I ( ω , τ ) = \int \int dt {dt}^{′} {e}^{i ω ( {t}^{′} - t )} \frac{{e}^{r ( t - τ ) + r ( {t}^{′} - τ )}}{4} {\sum }_{n} ( {ψ}_{n}^{sig} ( t ) {ψ}_{n}^{sig *} ( {t}^{′} ) 〈 {\hat{a}}_{n}^{in †} {\hat{a}}_{n}^{in} 〉 - {e}^{- i θ ( t - τ )} {ψ}_{n}^{sig *} ( t ) {ψ}_{n}^{sig *} ( {t}^{′} ) 〈 {( {\hat{a}}_{n}^{in} )}^{2} 〉 - {e}^{- i θ ( {t}^{′} - τ )} {ψ}_{n}^{sig} ( t ) {ψ}_{n}^{sig} ( {t}^{′} ) 〈 {( {\hat{a}}_{n}^{in †} )}^{2} 〉 + {e}^{i ( θ ( {t}^{′} - τ ) - θ ( {t}^{′} - τ ) )} {ψ}_{n}^{sig *} ( t ) {ψ}_{n}^{sig} ( {t}^{′} ) 〈 {\hat{a}}_{n}^{in} {\hat{a}}_{n}^{in †} 〉 ) \qquad ( S14 )$$

We now assume that the signal is centered around a frequency ωₛ and that the pump is centered around a frequency ωₚ=2ωₛ. The squeezing parameter ξ(t) can be separated into

$$ξ ( t ) = r ( t ) {e}^{i θ ( t )} = r ( t ) {e}^{i ( δ θ ( t ) + {ω}_{p} t )} \qquad ( S15 )$$

with θ(t)=δθ(t)+ωₚt.

We also define the broadband quadrature operators

$${\hat{x}}_{n} = \frac{1}{2} ( {\hat{a}}_{n} + {\hat{a}}_{n}^{†} ) \qquad ( S16 )$$

$${\hat{p}}_{n} = \frac{1}{2 i} ( {\hat{a}}_{n} + {\hat{a}}_{n}^{†} ) \qquad ( S17 )$$

The spectrogram can be written in terms of the interaction picture squeezing phase and quadrature operators, dropping the superscripts sig and in, as

$$I ( ω , τ ) = \int \int dt {dt}^{′} \frac{{e}^{i ω ( t - {t}^{′} ) + r ( t - τ ) + r ( {t}^{′} - τ )}}{4} {\sum }_{n} [ ( 〈 {\hat{x}}_{n}^{2} 〉 + 〈 {\hat{p}}_{n}^{2} 〉 - \frac{1}{2} ) {ψ}_{n} ( t ) {ψ}_{n}^{*} ( {t}^{′} ) + ( 〈 {\hat{x}}_{n}^{2} 〉 + 〈 {\hat{p}}_{n}^{2} 〉 - \frac{1}{2} ) {e}^{- i ( δ θ ( t - τ ) - δ θ ( {t}^{′} - τ ) )} {ψ}_{n}^{*} ( t ) {ψ}_{n} ( {t}^{′} ) - ( 〈 {\hat{x}}_{n}^{2} 〉 - 〈 {\hat{p}}_{n}^{2} 〉 + i 〈 {\hat{x}}_{n} {\hat{p}}_{n} + {\hat{p}}_{n} {\hat{x}}_{n} 〉 ) {e}^{- i ( δ θ ( t - τ ) + {ω}_{p} τ )} {ψ}_{n}^{*} ( t ) {ψ}_{n}^{*} ( {t}^{′} ) - ( 〈 {\hat{x}}_{n}^{2} 〉 - 〈 {\hat{p}}_{n}^{2} 〉 - i 〈 {\hat{x}}_{n} {\hat{p}}_{n} + {\hat{p}}_{n} {\hat{x}}_{n} 〉 ) {e}^{i ( δ θ ( {t}^{′} - τ ) + {ω}_{p} τ )} {ψ}_{n} ( t ) {ψ}_{n} ( {t}^{′} ) ] \qquad S18$$

Moving a factor of e^{i(-δθ(t-τ)+δθt′-τ))/2} in front, we have

$$\int \int dt {dt}^{′} \frac{1}{4} {e}^{i ( ω ( {t}^{′} - t ) - δ θ ( t - τ ) / 2 + δ θ ( {t}^{′} - τ ) / 2 ) + r ( t - τ ) + r ( {t}^{′} - τ )} {\sum }_{n} [ ( 〈 {\hat{x}}_{n}^{2} 〉 + 〈 {\hat{p}}_{n}^{2} 〉 - \frac{1}{2} ) {e}^{i ( δ θ ( t - τ ) - δ θ ( {t}^{′} - τ ) ) / 2 )} {ψ}_{n} ( t ) {ψ}_{n}^{*} ( {t}^{′} ) + ( 〈 {\hat{x}}_{n}^{2} 〉 + 〈 {\hat{p}}_{n}^{2} 〉 - \frac{1}{2} ) {e}^{- i ( δ θ ( t - τ ) - δ θ ( {t}^{′} - τ ) ) / 2 )} {{ψ}^{*}}_{n} ( t ) ψ ( {t}^{′} ) ( 〈 {\hat{x}}_{n}^{2} 〉 - 〈 {\hat{p}}_{n}^{2} 〉 + i 〈 {\hat{x}}_{n} {\hat{p}}_{n} + {\hat{p}}_{n} {\hat{x}}_{n} 〉 ) {e}^{i ( - δ θ ( t - τ ) - δ θ ( {t}^{′} - τ ) / 2 - {ω}_{p} τ )} {ψ}_{n}^{*} ( t ) {ψ}_{n}^{*} ( {t}^{′} ) - ( 〈 {\hat{x}}_{n}^{2} 〉 + 〈 {\hat{p}}_{n}^{2} 〉 - i 〈 {\hat{x}}_{n} {\hat{p}}_{n} - {\hat{p}}_{n} {\hat{x}}_{n} 〉 ) {e}^{i ( ( δ θ ( t - τ ) + δ θ ( {t}^{′} - τ ) ) / 2 {ω}_{p} τ )} {ψ}_{n} ( t ) {ψ}_{n} ( {t}^{′} ) ] \qquad S19$$

Collecting the second-order moments and defining δφ(t) ≡δθ(t)/2, we get

$$I ( ω , τ ) = {\sum }_{n} \int \int dt {dt}^{′} \frac{1}{4} {e}^{i ( ω ( {t}^{′} - t ) - δ ϕ ( t - τ ) + δ ϕ ( {t}^{′} - τ ) ) + r ( t - τ ) + r ( {t}^{′} - τ )} [ 〈 {\hat{x}}_{n}^{2} 〉 ( \begin{matrix}{ψ}_{n} ( t ) {e}^{i ( δ ϕ ( t - τ ) + {ω}_{p} τ / 2 )} - \\ {ψ}_{n}^{*} ( t ) {e}^{- i ( δ ϕ ( t - τ ) + {ω}_{p} τ / 2 )}\end{matrix} ) ( \begin{matrix}{ψ}_{n}^{*} ( {t}^{′} ) {e}^{- i ( δ ϕ ( {t}^{′} - τ ) + {ω}_{p} τ / 2 )} - \\ {ψ}_{n} ( {t}^{′} ) {e}^{i ( δ ϕ ( {t}^{′} - τ ) + {ω}_{p} τ / 2 )}\end{matrix} ) + 〈 {\hat{p}}_{n}^{2} 〉 ( \begin{matrix}{ψ}_{n} ( t ) {e}^{i ( δ ϕ ( t - τ ) + {ω}_{p} τ / 2 )} ) + \\ {ψ}_{n}^{*} ( t ) {e}^{- i ( δ ϕ ( t - τ ) + {ω}_{p} τ / 2 )}\end{matrix} ) ( \begin{matrix}{ψ}_{n}^{*} ( {t}^{′} ) {e}^{- i ( δ ϕ ( {t}^{′} - τ ) + {ω}_{p} τ / 2 )} + \\ {ψ}_{n} ( {t}^{′} ) {e}^{i ( δ ϕ ( {t}^{′} - τ ) + {ω}_{p} τ / 2 )}\end{matrix} ) + \frac{1}{2} ( {ψ}_{n}^{*} ( t ) {ψ}_{n} ( {t}^{′} ) {e}^{- i ( δ ϕ ( t - τ ) - δ ϕ ( {t}^{′} - τ ) )} - {ψ}_{n} ( t ) {ψ}_{n}^{*} ( {t}^{′} ) {e}^{i ( ( δ ϕ ( t - τ ) + δ ϕ ( {t}^{′} - τ ) )} ) + i 〈 {\hat{x}}_{n} {\hat{p}}_{n} + {\hat{p}}_{n} {\hat{x}}_{n} 〉 ( {ψ}_{n}^{*} ( t ) {ψ}_{n}^{*} ( {t}^{′} ) {e}^{- i ( δ ϕ ( t - τ ) + δ ϕ ( {t}^{′} - τ ) + {ω}_{p} τ )} - {ψ}_{n} ( t ) {ψ}_{n} ( {t}^{′} ) {e}^{i ( δ ϕ ( t - τ ) + δ ϕ ( {t}^{′} - τ ) + {ω}_{p} τ )} \qquad S20$$

Finally, simplifying each term and using the definition G(t)≡e^{-iδφ(t)+r(t)}, we have

$$I ( ω , τ ) = {\sum }_{n} [ 〈 {( {\hat{x}}_{n}^{in} )}^{2} 〉 {\vert \text{?} \{ G ( t - τ ) Im [ {ψ}_{n} ( t ) {e}^{i ( δ ϕ ( t - τ ) + {ω}_{s} τ )} ] \} \vert}^{2} + 〈 {( {\hat{p}}_{n}^{in} )}^{2} 〉 {\vert \text{?} \{ G ( t - τ ) Re [ {ψ}_{n} ( t ) {e}^{i ( δ ϕ ( t - τ ) + {ω}_{s} τ )} ] \} \vert}^{2} [ \text{?} \{ G ( t - τ ) {ψ}_{n} ( t ) {e}^{i ( δ ϕ ( t - τ ) - {ω}_{s} τ )} \} {( \text{?} \{ {G}^{*} ( t - τ ) {ψ}_{n}^{*} ( t ) {e}^{- i ( δ ϕ ( t - τ ) + {ω}_{s} τ )} \} )}^{*} ] + \frac{1}{2} 〈 {\hat{x}}_{n}^{in} {\hat{p}}_{n}^{in} + {\hat{p}}_{n}^{in} {\hat{x}}_{n}^{in} 〉 Im \frac{1}{8} ( {\vert \text{?} \{ G ( t - τ ) {e}^{- i δ ϕ ( t - τ )} {ψ}_{n}^{*} ( t ) \} \vert}^{2} + {\vert \text{?} \{ G ( t - τ ) {e}^{i δ ϕ ( t - τ )} {ψ}_{n} ( t ) \} \vert}^{2} \qquad S21$$

c. Covariance Term

The term following the covariance

$$〈 {\hat{x}}_{n}^{in} {\hat{p}}_{n}^{in} + {\hat{p}}_{n}^{in} {\hat{x}}_{n}^{in} 〉$$

is not in an ideal form for using a frequency resolved optical gating (FROG) type algorithm. However, for a Gaussian state with zero meanfield (e.g. a squeezed state), the state can be rotated such that the covariance goes to zero by adding a phase to the mode shapes. This occurs because the covariance vanishes when the state is squeezed along the z or P axis. Therefore, we may set this covariance to zero without discarding physical information. The squeezing angle is not lost, but instead is absorbed into the complex phases of the recovered mode functions.

This equivalence follows from the broadband input state annihilation operator

$$\hat{a} ( t ) = {\sum }_{n} {ψ}_{n}^{*} ( t ) {\hat{a}}_{n} \qquad ( S22 )$$

and noting that multiplying either ψₙ(t) or âₙ by a complex phase e^{-iθ}^{ₙ} can be compensated by multiplying the other one by the same complex phase. Making the transformation â→e^{-iθ}â leads to the usual rotation in phase space \hat{x}→\hat{x}cos θ+\hat{p}sin θ and \hat{p}→\hat{p}cos θ−\hat{x}sin θ. Hence rotating in quadrature phase space is operationally the same as adjusting the complex phase of the mode function. We can use this freedom to choose a basis with

$$〈 {\hat{x}}_{n}^{in} {\hat{p}}_{n}^{in} + {\hat{p}}_{n}^{in} {\hat{x}}_{n}^{in} 〉 = 0 ,$$

while keeping the squeezing orientation encoded in the retrieved mode phases.

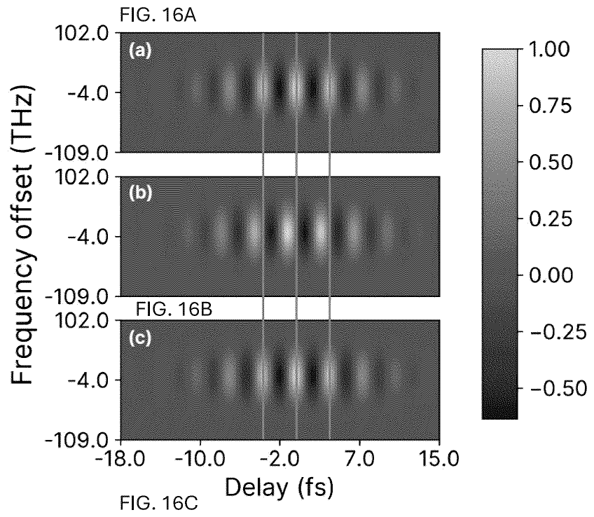

As an example, we show three spectrograms in FIG. 16, each with just one mode. We show how rotating the quadrature operators and the modes leads to the spectrogram changing. Rotating the quadrature by π/4 shifts the peaks and valleys by half a period, as can be seen in FIG. 16(b), while adding the same phase to the modes shifts it back to the original spectrogram, as can be seen in FIG. 16(c). Thus, adding a phase to the operators and the modes leads to the same effect and one can be used to absorb the effect of the other, allowing us to ignore the covariance term for squeezed states.

d. Algorithm

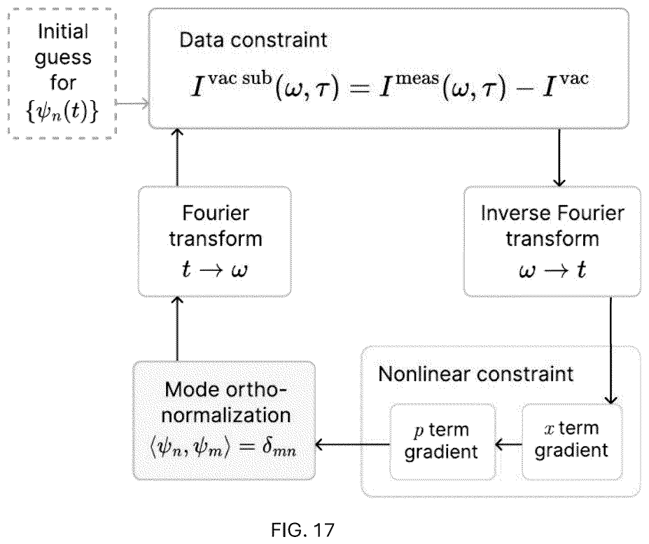

We use a similar algorithm to that developed in [2], which was for a varying probabilistic pulse train, whose spectrogram is also an incoherent sum over the potential pulses that can be emitted. Whereas their spectrogram was positive, our vacuum-subtracted spectrogram can contain negative values, so their data constraint cannot be applied directly. We use Lagrange multiplier projection to get around this issue. Furthermore, the form of the spectrogram terms is not amenable to the principal-components generalized projections algorithm, so we must use gradient descent for the nonlinear constraint step. A block diagram is shown in FIG. 17. Throughout the algorithm, as is common in FROG algorithms, we keep track of both the mode shapes (and the corresponding weights, which are based on the second-order moments) and the frequency-domain complex signal fields [3]. The aim of each iteration of the algorithm is to update the signal fields so that they match the measured data and then to update the modes and weights so that they match the signal fields. In the case of MMG-FROG, we must keep track of 2M signal fields for M modes, where for each mode there is an x and a p field corresponding to their respective term in the vacuum-subtracted spectrogram. We label these signal fields

$${E}_{n}^{x , p} ( ω , τ ) .$$

e. Data Constraint

The spectrogram is in the form of

$${I}^{vacsub} ( ω , τ ) = {\sum }_{n} \pm {\vert {E}_{n}^{x} ( ω , τ ) \vert}^{2} \pm {\vert {E}_{n}^{p} ( ω , τ ) \vert}^{2} = {\sum }_{n} {s}_{n} {\vert {E}_{n} ( ω , τ ) \vert}^{2} \qquad ( S23 )$$

with the signs in front of the fields sₙ ∈±1 depending on whether each quadrature is squeezed or anti-squeezed, and En without a superscript denotes that the field can be of either quadrature. The goal of the data constraint step is to change the signal fields as little as possible while satisfying the equation above. This can be done by the method of Lagrangian multipliers.

We define a Lagrangian to be minimized

$$ℒ = {\sum }_{n} {\vert {E}_{n} ( ω , τ ) - {E}_{n}^{′} ( ω , τ ) \vert}^{2} + λ ( ω , τ ) = ( {\sum }_{{n}^{′}} {s}_{n} {\vert {E}_{n}^{′} ( ω , τ ) \vert}^{2} - {I}^{vacsub} ( ω , τ ) ) , \qquad ( S24 )$$

with

$${E}_{n}^{′} ( ω , τ )$$

being the updated signal fields. Taking the derivative with respect to

$${E}_{n}^{′ *} ,$$

have that

$${E}_{n}^{′} ( ω , τ ) = \frac{{E}_{n} ( ω , τ )}{1 + {s}_{n} λ ( ω , τ )} \qquad ( S25 )$$

This equation represents N² equations, one for each point in the spectrogram.To determine the value of λ(ω, τ), we plug this equation into the data constraint Eq. S23:

$${\sum }_{n} {s}_{n} \frac{{\vert {E}_{n} ( ω , τ ) \vert}^{2}}{{( 1 + {s}_{n} λ ( ω , τ ) )}^{2}} = {I}^{vacsub} ( ω , τ ) . \qquad ( S26 )$$

After solving for λ(ω, τ), we simply plug it into Eq. S25 and obtain the new signal.
f. Nonlinear Constraint

The nonlinear constraint serves to enforce the form of the signal fields. That is, that

$${E}_{n}^{x} ( t , τ ) = {X}_{n} G ( {t}^{′} ) ( Re [ {ψ}_{n} ( t ) ] sin ( δϕ ( {t}^{′} ) + {ω}_{s} τ ) + Im [ {ψ}_{n} ( t ) ] cos ( δϕ ( {t}^{′} ) + {ω}_{s} τ ) ) \qquad ( S27 )$$

$${E}_{n}^{p} ( t , τ ) = {P}_{n} G ( {t}^{′} ) ( Re [ {ψ}_{n} ( t ) ] cos ( δϕ ( {t}^{′} ) + {ω}_{s} τ ) - Im [ {ψ}_{n} ( t ) ] sin ( δϕ ( {t}^{′} ) + {ω}_{s} τ ) ) \qquad ( S28 )$$

where

$${X}_{n} ≡ \sqrt{\vert 〈 {( {\hat{x}}_{n}^{in} )}^{2} 〉 - \frac{1}{4}} \vert , {P}_{n} ≡ \sqrt{\vert 〈 {( {\hat{p}}_{n}^{in} )}^{2} 〉 - \frac{1}{4}} \vert ,$$

and t′≡t −τ. These are the inverse Fourier transforms of

$${E}_{n}^{x , p} ( ω , τ )$$

in the first parameter. The way to enforce this constraint is to find the mode shape and variance that minimizes the functional loss

$${z}_{n}^{x , p} ≡ {\sum }_{t , τ} {\vert {E}_{n}^{x , p} ( t , τ ) - {E}_{n}^{x , p ′} ( t , τ ) \vert}^{2} \qquad ( S29 )$$

where

$${E}_{n}^{x , p ′} ( t , τ )$$

is a function of the mode shape and state as shown above in Eqns. S27and S28.

We can analytically find the gradient of the functional loss with respect to the real and imaginary parts of the modes:

$$\frac{\partial {Z}_{n}^{x}}{\partial Re [ {ψ}_{n} ( t ) ]} = - 2 {\sum }_{τ} Re [ {X}_{n} G ( t - τ ) sin {δϕ}^{′} ( t , τ ) {R}_{n}^{x *} ( t , τ ) ] \qquad ( S30 )$$

$$\frac{\partial {Z}_{n}^{x}}{\partial Im [ {ψ}_{n} ( t ) ]} = - 2 {\sum }_{τ} Re [ {X}_{n} G ( t - τ ) cos {δϕ}^{′} ( t , τ ) {R}_{n}^{x *} ( t , τ ) ] \qquad ( S31 )$$

$$\frac{\partial {Z}_{n}^{p}}{\partial Re [ {ψ}_{n} ( t ) ]} = - 2 {\sum }_{τ} Re [ {P}_{n} G ( t - τ ) cos {δϕ}^{′} ( t , τ ) {R}_{n}^{p *} ( t , τ ) ] \qquad ( S32 )$$

$$\frac{\partial {Z}_{n}^{p}}{\partial Im [ {ψ}_{n} ( t ) ]} = - 2 {\sum }_{τ} Re [ {P}_{n} G ( t - τ ) sin {δϕ}^{′} ( t , τ ) {R}_{n}^{p *} ( t , τ ) ] \qquad ( S33 )$$

where G(t)≡e^{r(t)+iδφ(t)}, δφ′(t, τ) ≡δφ(t−τ)+ωₛτ and

$${R}_{n}^{x} ( t , τ ) ≡ {E}_{n}^{x} ( t , τ ) - {X}_{n} G ( t - τ ) ( \begin{matrix}Re [ {ψ}_{n} ( t ) ] sin {δϕ}^{′} ( t , τ ) + \\ Im [ {ψ}_{n} ( t ) ] cos {δϕ}^{′} ( t , τ )\end{matrix} ) \qquad ( S34 )$$

$${R}_{n}^{p} ( t , τ ) ≡ {E}_{n}^{p} ( t , τ ) - {P}_{n} G ( t - τ ) ( \begin{matrix}Re [ {ψ}_{n} ( t ) ] cos {δϕ}^{′} ( t , τ ) - \\ Im [ {ψ}_{n} ( t ) ] sin {δϕ}^{′} ( t , τ )\end{matrix} ) \qquad ( S35 )$$

are the residuals between the stored signal fields and the signal fields calculated from the modes and quadrature variances. After calculating these gradients, we use an optimizer to determine the optimal step size before updating the mode shapes along the gradient direction.

In order to update the mode variance weights, we normalize the new mode shapes such that Σₜ |ωₙ (t)|²=1 for all n and multiply the variance weight by the amount we divided ψₙ(t) by. That is,

$${ψ}_{n}^{norm} ( t ) = \frac{{ψ}_{n} ( t )}{\sqrt{\int \vert {ψ}_{n} ( t ) {\vert}^{2} dt}} \qquad ( S36 )$$

$${C}_{n}^{′} = {C}_{n} \sqrt{\int \vert {ψ}_{n} ( t ) {\vert}^{2} dt} \qquad ( S37 )$$

for Cₙ being one of the mode weights Xₙ or Pₙ. Thus, the product

$${C}_{n} {ψ}_{n} ( t ) = {C}_{n}^{′} {ψ}_{n}^{norm} ( t )$$

remains constant but the mode is normalized, and enough information is gained from this gradient step (i.e. an increase or decrease in mode amplitude) to adjust the mode weight.
g. Extracting Squeezing Phase

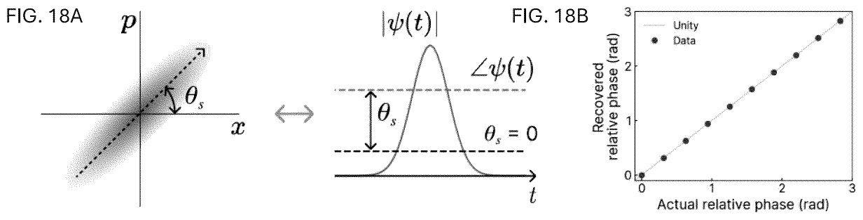

We use the algorithm to extract the relative phase between the modes, which for squeezed vacuum allows us to determine the full covariance matrix with one of the squeezing modes as the reference for squeezing angle θₛ=0. We show the correspondence in FIG. 18(a) and the relative mode phase recovery for 2 modes in S3(b). The covariance as a function of the relative mode phase and the quadrature variances can be calculated as

[symbol]

²\hat{x}² sin θₛ cos θₛ+2\hat{p}² sin θₛ cos θₛ [symbol] . (S38)

h. Determining the Number of Modes

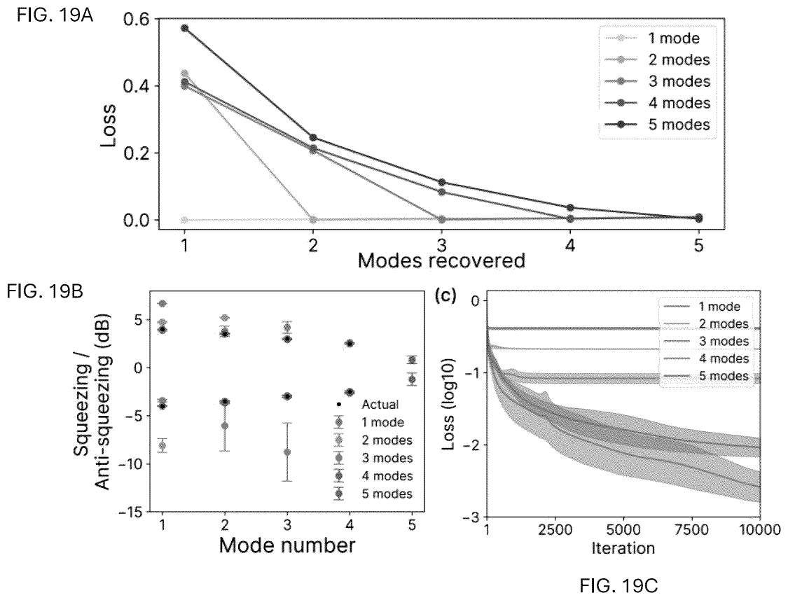

The number of modes in the state can be determined by sweeping the number of modes recovered and noting when it reaches a minimum and when some mode variances match that of vacuum. These indications are present when the number of modes recovered matches and then exceeds the number of modes in the spectrogram, as seen in FIG. 19.

i. Scaling

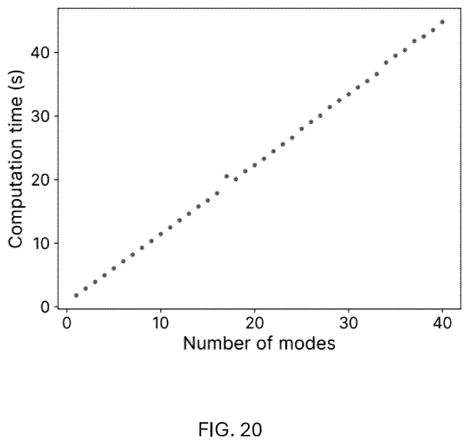

The linear scaling as a function of mode number appears to hold up until at least M=40. We plot the computation time vs. the number of modes in the retrieval in FIG. 20 for 200 iterations each, with 64 points along both frequency and delay. The small fluctuations are likely due to other processes on the computer.

### Hardware Environment

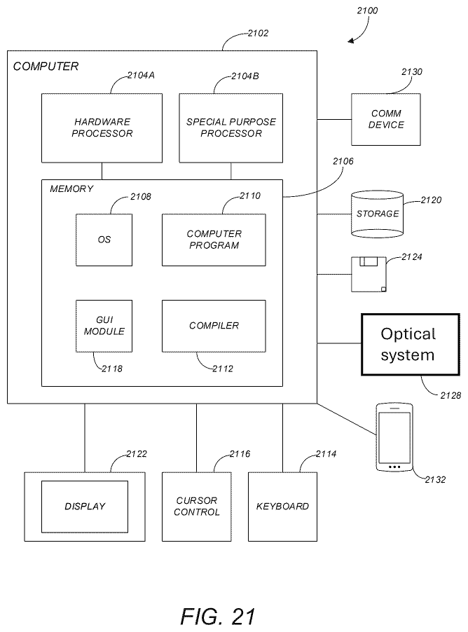

FIG. 21 is an exemplary hardware and software environment 2100 (referred to as a computer-implemented system and/or computer-implemented method) used to analyze information measured using optical system 2128, 100. The hardware and software environment includes a computer 2102 and may include peripherals. Computer 2102 may be a user/client computer, server computer, or may be a database computer. The computer 2102 comprises a hardware processor 2104A and/or a special purpose hardware processor 2104B (hereinafter alternatively collectively referred to as processor 2104) and a memory 2106, such as random access memory (RAM). The computer 2102 may be coupled to, and/or integrated with, other devices, including input/output (I/O) devices such as a keyboard 2114, a cursor control device 2116. In one or more embodiments, computer 2102 may be coupled to, or may comprise, a portable or multi-touch device, e.g., mobile phone or laptop, or other device executing on various platforms and operating systems.

In one embodiment, the computer 2102 operates by the hardware processor 2104A performing instructions defined by the computer program 2110 under control of an operating system 2108. The computer program 2110 and/or the operating system 2108 may be stored in the memory 2106 and may interface with the user and/or other devices to accept input and commands and, based on such input and commands and the instructions defined by the computer program 2110 and operating system 2108, to provide output and results.

Output/results may be presented on the display 2122 or provided to another device for presentation or further processing or action. The image may be provided through a graphical user interface (GUI) module 2118. Although the GUI module 2118 is depicted as a separate module, the instructions performing the GUI functions can be resident or distributed in the operating system 2108, the computer program 2110, or implemented with special purpose memory and processors.

Some or all of the operations performed by the computer 2102 according to the computer program 2110 instructions may be implemented in a special purpose processor 2104B. In this embodiment, some or all of the computer program 2110 instructions may be implemented via firmware instructions stored in a read only memory (ROM), a programmable read only memory (PROM) or flash memory within the special purpose processor 2104B or in memory 2106. The special purpose processor 2104B may also be hardwired through circuit design to perform some or all of the operations to implement the present invention. Further, the special purpose processor 2104B may be a hybrid processor, which includes dedicated circuitry for performing a subset of functions, and other circuits for performing more general functions such as responding to computer program 2110 instructions. In one embodiment, the special purpose processor 2104B is an application specific integrated circuit (ASIC), field programmable gate array, graphics processing unit, neural processing unit or processor, accelerator or circuit adapted for performing machine learning or artificial intelligence.

The computer 2102 may also implement a compiler 2112 that allows an application or computer program 2110 written in a programming language such as C, C++, Assembly, SQL, PYTHON, PROLOG, MATLAB, RUBY, RAILS, HASKELL, or other language to be translated into processor 2104 readable code. Alternatively, the compiler 2112 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 2110 accesses and manipulates data accepted from I/O devices and stored in the memory 2106 of the computer 2102 using the relationships and logic that were generated using the compiler 2112.

The computer 2102 also optionally comprises an external communication device such as a modem, satellite link, Ethernet card, or other device for accepting input from, and providing output to, other computers 2102.

In one embodiment, instructions implementing the operating system 2108, the computer program 2110, and the compiler 2112 are tangibly embodied in a non-transitory computer-readable medium, e.g., data storage device 2120, which could include one or more fixed or removable data storage devices, such as a zip drive, floppy disc drive 2124, hard drive, CD-ROM drive, tape drive, etc. Further, the operating system 2108 and the computer program 2110 are comprised of computer program 2110 instructions which, when accessed, read and executed by the computer 2102, cause the computer 2102 to perform the steps necessary to implement and/or use the present invention or to load the program of instructions into a memory 2106, thus creating a special purpose data structure causing the computer 2102 to operate as a specially programmed computer executing the method steps described herein. Computer program 2110 and/or operating instructions may also be tangibly embodied in memory 2106 and/or data communications devices 2130, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 2102.

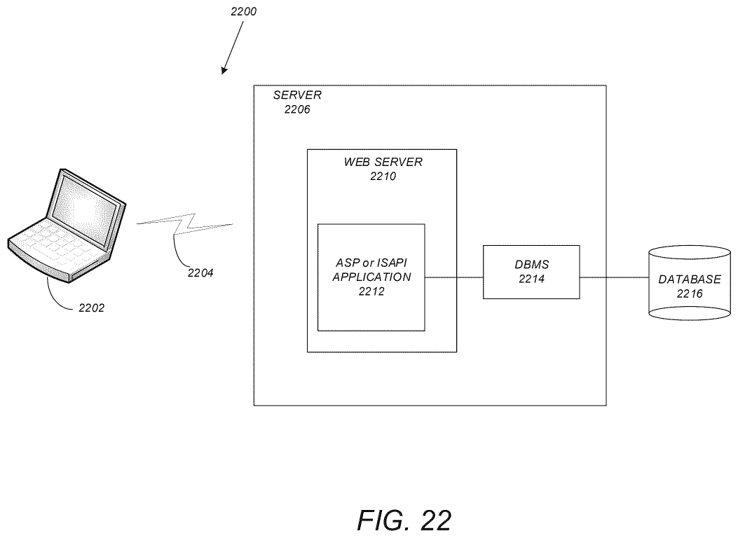

FIG. 22 schematically illustrates a typical distributed/cloud-based computer system 2200 using a network 2204 to connect client computers 2202 to server computers 2206. A typical combination of resources may include a network 2204 comprising the Internet, LANs (local area networks), WANs (wide area networks), SNA (systems network architecture) networks, or the like, clients 2202 that are personal computers or workstations (as set forth in FIG. 9), and servers 2206 that are personal computers, workstations, minicomputers, or mainframes (as set forth in FIG. 9). However, it may be noted that different networks such as a cellular network (e.g., GSM [global system for mobile communications] or otherwise), a satellite based network, or any other type of network may be used to connect clients 2202 and servers 2206 in accordance with embodiments of the invention.

A network 2204 such as the Internet connects clients 2202 to server computers 2206. Network 2204 may utilize ethernet, coaxial cable, wireless communications, radio frequency (RF), etc. to connect and provide the communication between clients 2202 and servers 2206. Further, in a cloud-based computing system, resources (e.g., storage, processors, applications, memory, infrastructure, etc.) in clients 2202 and server computers 2206 may be shared by clients 2202, server computers 2206, and users across one or more networks. Resources may be shared by multiple users and can be dynamically reallocated per demand. In this regard, cloud computing may be referred to as a model for enabling access to a shared pool of configurable computing resources.

Clients 2202 may execute a client application or web browser and communicate with server computers 2206 executing web servers 2210. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2202 may be downloaded from server computer 2206 to client computers 2202 and installed as a plug-in or ACTIVEX control of a web browser. Accordingly, clients 2202 may utilize ACTIVEX components/component object model (COM) or distributed COM (DCOM) components to provide a user interface on a display of client 2202. The web server 2210 is typically a program such as MICROSOFT'S INTERNET INFORMATION SERVER.

Web server 2210 may host an Active Server Page (ASP) or Internet Server Application Programming Interface (ISAPI) application 2212, which may be executing scripts. The scripts invoke objects that execute business logic (referred to as business objects). The business objects then manipulate data in database 2216 through a database management system (DBMS) 2214. Alternatively, database 2216 may be part of, or connected directly to, client 2202 instead of communicating/obtaining the information from database 2216 across network 2204. When a developer encapsulates the business functionality into objects, the system may be referred to as a component object model (COM) system. Accordingly, the scripts executing on web server 2210 (and/or application 2212) invoke COM objects that implement the business logic. Further, server 2206 may utilize MICROSOFT'S TRANSACTION SERVER (MTS) to access required data stored in database 2216 via an interface such as ADO (Active Data Objects), OLE DB (Object Linking and Embedding DataBase), or ODBC (Open DataBase Connectivity).

Generally, these components 2200-2216 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2202 and 2206 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2202 and 2206. Embodiments of the invention are implemented as a software/application on a client 2202 or server computer 2206. Further, as described above, the client 2202 or server computer 2206 may comprise a thin client device or a portable device that has a multi-touch-based display.

### Process Steps

### Method of Fabricating a System

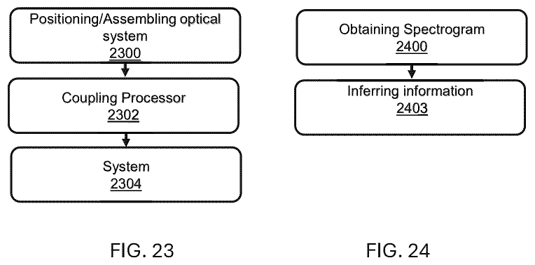

FIG. 23 illustrates a method of fabricating a system comprises assembling an optical system configured for outputting a spectrogram comprising time dependent magnitudes of frequency components in response to, and dependent on, an input photonic quantum state. In one embodiment, the assembling/configuring (Block 2300) comprises positioning a delay mechanism delaying the input photonic quantum state relative to an auxiliary photonic state; positioning one or more nonlinear media interacting the two states through nonlinear optical processes to generate a third photonic state; and positioning a detector to detect/measure the spectrum of the third photonic state for different relative delays.

The assembly further comprises coupling (Block 2302) and configuring a processor (e.g,. computer, ASIC, FPGA) operable to infer, calculate, and/or determine information about the input photonic quantum state from the spectrogram, wherein the information includes temporal frequency structure and/or quantum state information about the input photonic quantum state. Block 2304 represents the end result, a system as described herein (see e.g., examples 1-36 and 1-22 in the system embodiments below).

### Method of Measuring

FIG. 24 illustrates a method of measuring a quantum state can comprise obtaining (Block 2400) a spectrogram comprising time dependent magnitudes of frequency components in response to, and dependent on, an input photonic quantum state; and inferring, calculating, and/or determining (Block 2402) information about the input photonic quantum state from the spectrogram, wherein the information includes temporal frequency structure and/or quantum state information about the input photonic quantum state. In one embodiment, obtaining the spectrogram comprises delaying the input photonic quantum state relative to an auxiliary photonic state; interacting the two states through nonlinear optical processes to generate a third photonic state; and detecting/measuring the spectrum of the third photonic state for different relative delays.

1. Inference Technique for Example 3 (e.g. Third Example on Page 19)

The third example described herein illustrates the inference models the measured spectrogram as a weighted sum of individual mode spectrograms. Each mode contributes proportionally to its mean photon number (energy). The algorithm uses an iterative phase-retrieval technique: it starts with random mode guesses, calculates what spectrogram they would produce, compares this to the measured data, then updates the modes (temporal modes?) to reduce the mismatch. A critical constraint enforces orthonormality—the modes must remain mathematically independent (perpendicular vectors). After convergence, the algorithm returns the complex temporal mode profiles (amplitude and phase) and their relative energies.

To extract quantum information, the process runs twice: once on amplified vacuum (to characterize the amplifier's transformation) and once on the amplified squeezed state. The amplifier can be modeled as linear transformation on the quantum field's quadrature operators and is characterized using the amplified vacuum measurement. By inverting this transformation mathematically, the algorithm reconstructs the input state's quadrature correlation matrix—a covariance matrix whose diagonal elements give the variance (noise level) in each mode's position and momentum-like quadratures. Values below 1 (in units of vacuum noise) indicate squeezing.

The outputs are the temporal mode shapes and their squeezing levels, obtained by first characterizing the amplifier, then measuring the amplified squeezed state, and finally inverting the amplification transformation to recover the input quantum state properties.

### 2. Inference Technique for Example 4 (e.g., Fourth Example on Page 40):

The fourth example described herein shows an approach directly recovers both mode shapes and quadrature variances from a single spectrogram by modeling the spectrogram as a sum over modes, where each mode contributes four terms corresponding to position variance (X²), momentum variance (P²), and their products with the gate pulse. The algorithm uses gradient descent to simultaneously optimize the mode shapes and variances to match the measured data, while enforcing orthonormality via Gram-Schmidt decomposition at each iteration.

The variance terms directly encode the quantum statistics-they represent the spread in the quantum state's position and momentum quadratures. By subtracting the vacuum contribution (shot noise baseline), the algorithm isolates the squeezing: variances below 1 indicate noise suppression (squeezing), while values above 1 indicate amplification (anti-squeezing). The relative phase between modes, encoded in their complex profiles, determines the squeezing angle in phase space, completing the characterization. So the outputs are variances of x, p, and amount of squeezing.

The measured data is collected in discrete time bins (due to finite detector sampling), but the temporal modes span across multiple bins—each mode is a specific weighted combination of many time bins. The algorithms reconstruct which patterns (modes) of time-bin combinations are present in the spectrogram. The spectrogram is modeled as the spectra of the cross-correlation of the gate pulse and input state (decomposed into orthonormal temporal modes), with the separability constraint allowing decomposition into single-mode spectrograms and the nonlinearity constraint enforcing the physical form of the interaction.

### 3. Inference Technique/Algorithm Example (Valid for Examples 3, 4, for Example.

The algorithm performs constrained iterative optimization on the measured spectrogram to reconstruct temporal modes of the photonic quantum state, wherein the constrained iterative optimization enforces: (a) an orthonormality constraint requiring the temporal modes to remain mathematically independent, (b) a separability constraint requiring the spectrogram to decompose as a weighted sum of single-mode spectrograms, and (c) a nonlinearity constraint requiring the spectrogram to satisfy a mathematical form corresponding to a physical nonlinear optical process used to generate the spectrogram.

Example systems that that can be used to implement these inference examples 1-3 include systems described herein (see e.g., examples 1-36 and 1-22 in the system embodiments below), although other inference/algorithm/determination techniques can be used.

### First System Embodiments

Illustrative embodiments include, but are not limited to, the following.
1. A system (e.g., as illustrated in FIGS. 1A-1C, 2, 11, and 15), comprising:
an optical system outputting a spectrogram comprising time dependent magnitudes of frequency components in response to, and dependent on, an input photonic quantum state;
an processor (e.g,. computer, ASIC, FPGA) inferring, calculating, and/or determining information about the input photonic quantum state from the spectrogram, wherein the information includes temporal and/or frequency structure and/or quantum state information about the input photonic quantum state.
2. The system of clause 1, wherein the optical system comprises
a delay mechanism delaying the input photonic quantum state relative to an auxiliary photonic state;
one or more nonlinear media interacting the two states through nonlinear optical processes to generate a third photonic state;
a spectrometer measuring the spectrum of the third photonic state for different relative delays.
3. The system of clause 1 or 2 wherein the processor performs the inferring by executing an algorithm through non-iterative, iterative, phase-retrieval, machine learning, or deep learning techniques.
4. The system of any of the clauses 1-3 wherein the processor calculates quantum state properties by comparing the measured spectrogram to a calculated spectrogram using optimization, estimation, or inverse methods.
5. The system of any of the clauses 2-4, wherein the delay mechanism comprises a mechanically moving stage.
6. The system of any of the clauses 2-4, wherein the delay mechanism comprises a photonic dual-comb configuration. Components can comprise optical frequency comb source(s) including locking schemes (PID servos) applying controllable repetition rates as known in the art.
7. The system of any of the clauses 2-6, wherein the delay mechanism maps temporal delays to distinct spatial locations.
8. The system of any of the clauses 1-7 wherein auxiliary photonic state is a copy of the input photonic quantum state, Gaussian or non-Gaussian, and may or may not be characterized apriori.
9. The system of any of the clauses 2-8, wherein the optical nonlinearity is implemented through parametric or non-parametric processes that involve phase sensitive or phase insensitive interaction.
10. The system of any of the clauses 2-9 wherein the optical system performs an optical Fourier transform and a detector measures an output of the Fourier transform in the photon number or quadrature basis (e.g,. as illustrated in FIG. 2).
11. The system of any of the clauses 1-10 wherein the optical system comprises a dispersive element, an interferometer or imaging spectrometer implementing the optical Fourier transform, e.g, as illustrated in FIG. 2
12. The system of any of the clauses 2-11 wherein the detector comprises a single photon or photon number resolving detectors operable to measure in the photon number basis or a homodyne or a phase sensitive nonlinear interaction with auxiliary radiation as a local oscillator/gate/pump for detection in the quadrature basis.
13. The system of any of the clauses 1-12 wherein the optical system is operable to measure the spectrogram in a pulse-by-pulse format or averaged over many pulses.
14. The system of any of the clauses 1-13 wherein the optical system comprises a Frequency Resolved Optical Gating (FROG)- based scheme comprising the nonlinear medium wherein the optical nonlinear process comprises a phase-sensitive parametric amplification process such that the information inferred includes the expectation values of second order polynomials of quadrature operators (second-order quadrature moments) and the complex temporal envelope describing a temporally localized quantum state (temporal mode profiles), e.g, as illustrated in FIGS. 11 and 15.
15. The system of any of the clauses 1-13 wherein the optical system comprises a FROG-based scheme comprising the nonlinear medium wherein the nonlinear optical process comprises a phase-insensitive process, such as sum-frequency generation, such that the information inferred includes the temporal mode profiles and mean photon number per mode, e.g., as illustrated in FIG. 1B and FIG. 2.
16. The system of any of the clauses 1-13 wherein the optical system comprises a FROG-based scheme comprising the nonlinear medium wherein the nonlinear process is a second- or higher-order process in which the state interacts with itself, giving information on fourth- or higher-order operator moments, e.g, as illustrated in FIGS. 1B and 2..
17. The system of any of the clauses 1-13 wherein the optical system comprises one or more nonlinear media implementing at least two nonlinear processes, where one or more processes map physical parameters of the input quantum state to other parameters of an intermediate state to prepare the state for spectrographic measurement using a final nonlinear optical process, wherein physical parameters being mapped include at least one of quadrature information, photon number, frequency, polarization, and temporal or spatial characteristics, e.g., as illustrated in FIG. 2.
18. The system of clause 16 wherein the optical system comprises one or more nonlinear media wherein phase sensitive amplification process is followed by sum frequency generation cross FROG wherein the information inferred includes at least one of characterization of the phase sensitive amplification process, second order quadrature moments of the input photonic quantum state in the temporal, amplifier, and independent bases, and the temporal mode profiles, e.g., as illustrated in FIG. 1C and FIG. 2.
19. The system of any of the clauses 1-18 wherein the information extracted can characterize the auxiliary photonic state used for the spectrogram measurement.
20. The system of any of the clauses 1-19 wherein the information extracted can include correlations of multimode annihilation and quadrature operators in the temporal, frequency, independent, or an arbitrary basis along with the associated unitary transformations describing the associated mode profiles.
21. The system of any of the clauses 1-20 wherein the information extracted can include multimode entanglement criteria and entanglement structure reconstruction including those for Gaussian and non-Gaussian states.
22. The system of any of the clauses 1-21 wherein the information extracted can include quantum quasi-probability distribution functions, such as the Wigner, Q-, and P-functions.
23. The system of any of the clauses including clause 2 wherein the spectrometer can measure the spectrum of the third photonic state in the photon number basis using single photon detectors or photon number resolving detectors.
24. The system of any of the clauses including clause 2 wherein the spectrometer can measure the spectrum of the third photonic state in the quadrature basis using homodyne, heterodyne, or a phase-sensitive nonlinear interaction with auxiliary radiation as a local oscillator/gate/pump.
25. The system of any of the clauses including clause 2 wherein the spectrometer is operable to measure the spectrogram in a pulse-by-pulse format and wherein at least one of the photonic states comprises periodic pulses.
26. The system of any of the clauses including clause 2 wherein the temporal delays are mapped to distinct spatial locations within a nonlinear crystal followed by an imaging spectrometer that measures the spectrogram of the resulting photonic state.
27. The system of any of the clauses including clause 2 wherein the optical system comprises one or more nonlinear media implementing at least two nonlinear processes, where one or more processes map physical parameters of the input quantum state to other parameters of an intermediate state to prepare the state for spectrographic measurement using a final nonlinear optical process, wherein physical parameters being mapped include at least one of quadrature information, photon number, frequency, polarization, and temporal or spatial characteristics.
28. The system of any of the clauses including clause 2 wherein the optical system comprises one or more of the nonlinear media implementing at least two nonlinear processes, where one or more of the nonlinear processes map one or more physical parameters of the input quantum state to one or more physical parameters of one or more intermediate states generated through these processes to prepare the state for spectrographic measurement using a final nonlinear optical process, wherein physical parameters being mapped include at least one of quadrature information, photon number, frequency, polarization, temporal characteristics, or spatial characteristics. Auxiliary state can be a photonic state that is independent of the input photonic quantum state to be measured; Intermediate state is a photonic state that is generated when the input photonic quantum state is passed through some nonlinear process (as an example, this process can involve the input photonic quantum state interacting with an auxiliary photonic state through an optical nonlinear medium).
29. The system of any of the clauses wherein the optical system comprises one or more nonlinear media wherein the input state goes through a phase sensitive amplification process followed by sum frequency generation cross-FROG wherein the information inferred includes at least one of characterization of the phase sensitive amplification process, second order quadrature moments of the input photonic quantum state in the temporal, amplifier, and independent bases, and the temporal mode profiles.
30. The system of any of the clauses 1-29 being used as sub-system for implementing quantum information processing, communication, and sensing (or a quantum information processing system, quantum communication system, or quantum sensing system including or coupled to the system of any of the clauses 1-29.
31. A non-transitory computer-readable medium storing instructions that, when executed by a processor, cause the apparatus or system of any of the clauses 1-23 to perform the methods or functionalities of any of the clauses 1-23.
32. The system of any of the clauses 1-30, wherein the inference system or processor is performed on a computer comprising a memory storing instructions and the processor executing the instructions.
33. Example nonlinear material or media or crystal in any of the clauses having the (e.g., second order) nonlinearity, include but are not limited to, lithium niobate, lithium tantalate, Potassium Titanyl Phosphate (KTP), aluminum nitride, gallium arsenide, indium phosphide, aluminum gallium arsenide, GaP, or InGaP. The invention is not limited to second order or parameteric nonlinearities, other non linear materials can be used, including, but not limited to, third-order nonlinear materials, such as SiN and Si, can be used. Additionally materials implementing nonparametric nonlinear processes such as two photon absorption can be used. In one or more examples, the substrate comprises lithium niobate on silicon dioxide, and the waveguides are patterned in the lithium niobate (monolithic integration of the waveguides). Other examples of nonlinear media include lithium iodate and beta barium borate.
34. The system of any of the clauses 1-33 wherein the optical system comprises a FROG system, or a family of “FROG variants” that use the same fundamental principles but a modified hardware+retrieval system such as FROG-CRAB, GRENOUILLE, single-shot-FROG, TADPOLE, XFROG etc.
35. The system of any of the clauses 1-34, wherein the optical system comprises a photonic integrated circuit, e.g., on a chip.
36. The system of any of the clauses 1-35, wherein the processor comprises an ASIC.

Further information on one or more embodiments of the present invention can be found in

Quantum Frequency Resolved Optical Gating of Few-Cycle Squeezed Vacuum by Thomas Zacharias, Elina Sendonaris, Robert Gray, James Williams, Ryoto Sekine, Maximilian Shen, Selina Zhou, Alireza Marandi, https://arxiv.org/abs/2604.07637 and supplementary information, and

Frequency resolved optical gating using parametric amplification for characterizing ultrafast temporally multimode squeezed states, Elina Sendonaris, Thomas Zacharias, Robert Gray, James Williams, Alireza Marandi https://arxiv.org/abs/2604.08717 and supplementary information, all of which references are incorporated by reference herein.

### Additional System Embodiments

Illustrative embodiments include, but are not limited to, the following.
1. A system for measuring the temporal-frequency structure and/or quadrature information of an input photonic quantum state, comprising:
a spectrogram measurement (e.g., system) in which a time-dependent spectrum is measured which is dependent on the input photonic quantum state; and
an inference system wherein the information about the photonic quantum state is inferred from the measured spectrogram.
2. The system of clause 1, wherein:
the input photonic quantum state is at least one of the following: a Gaussian state, non-Gaussian state, pure state, mixed state, single mode, multi-mode, microscopic, mesoscopic, macroscopic, a Fock state, a Schrodinger's cat state, or a Gottesman-Kitaev-Preskill (GKP) state,
and the quantum state is generated using a system comprising parametric down conversion, parametric amplification, quadratic or Kerr squeezing; quantum dots, color centers, or heralded non-Gaussian operation.
3. The system of clause 1 or 2, wherein the spectrogram:
contains complete or partial information about the time-dependent frequency content of the photonic quantum state;
can be realized through a direct or indirect measurement, series of measurements, or post processing of measurements.
4. The system of any of the clauses 1-3, wherein the spectrogram measurement comprises one or more of an optical nonlinearity, a delay mechanism for generating the time-dependent measurement, auxiliary electromagnetic radiation, or spectrum measurements.
5. The system of clause 4, wherein the optical nonlinearity is implemented through one or more parametric or non-parametric processes that involve phase sensitive or phase insensitive interaction including sum-frequency generation, difference frequency generation, cross phase modulation, degenerate four-wave mixing, degenerate parametric amplification, and two-photon absorption.
6. The system of clause 4 or 5, wherein the delay mechanism is realized using
a mechanically moving stage,
a dual-comb configuration,
or temporal delays to distinct spatial locations such as a single-shot frequency resolved optical gating (FROG) approach.
7. The system of any of the clauses 4-6 wherein the auxiliary electromagnetic radiation is in a Gaussian state such as that generated by a coherent laser source, vacuum fluctuations, squeezed light, or a non-Gaussian such as a Fock state, a Schrodinger's cat state, or a GKP state and can have known or unknown properties such as a temporal-frequency waveform, quadrature statistics, or photon number statistics.
8. The system of any of the clauses 1-7 wherein the spectrum measurement is implemented through:
dispersive spectrometry including spatial dispersion through a prism or a grating based spectrometry and temporally dispersive schemes such as dispersive Fourier transforms,
interferometric spectrometry such as a Fourier transform infrared spectrometry or dual comb spectroscopy,
imaging spectrometry such as using a hyperspectral spectrometer,
or cross comb spectroscopy.
9. The system of any of the clauses 1-8 wherein the spectrometer detectors can measure the light:
in the Fock basis using single photon detectors or photon number resolving detectors, or
in a quadrature basis using a homodyne or a phase sensitive nonlinear interaction with an
auxiliary radiation as a local oscillator/gate/pump, and/or
in a pulse-by-pulse format or averaged over many pulses.
10. The system of any of the clauses 4-9,
wherein the auxiliary electromagnetic radiation can be delayed relative to the photonic quantum state, and/or
wherein the auxiliary radiation can interact with the photonic quantum state through an optical nonlinearity, and/or
wherein the photonic quantum state can be copied or split and delayed relative to the copy of itself, and/or
wherein the photonic quantum state can interact with its copy through an optical nonlinearity.
11. The system of any of the clauses 1-10, wherein the inferred information from the spectrogram:
completely or partially describes properties of the photonic quantum state including the temporal/frequency structure, quadrature statistics, and/or photon number statistics, and
can be directly accessed through the spectrogram or can be indirectly accessed through additional algorithmic processing to enable learning properties of the photonic quantum state.
12. The system of any of the clauses 1-11 wherein the algorithmic inference can be implemented through non-iterative or iterative techniques, phase retrieval techniques, or machine learning/deep learning-based techniques.
13. The system of any of the clauses 1-12 wherein the information extracted can include:
correlations of multimode annihilation and quadrature operators describing the quantum state including first, second, higher order correlations, and/or
multimode correlation matrices including multimode covariance matrix, Mandel matrix, and higher order correlation matrices, and/or
temporal modes, frequency modes, Schmidt modes, Schmidt coefficients, and Schmidt number, and/or
the measured correlations in the temporal/frequency basis, uncorrelated basis, or an arbitrary basis.
entanglement criteria including those for Gaussian and non-Gaussian states, and/or
information on the quantum quasi-probability distribution functions, such as the Wigner, Q-, and P-functions, of Gaussian and non-Gaussian states.
14. The system of any of the clauses wherein the optical system or spectrogram measurement system is implemented in:
a bulk platform, wherein light interacts with bulk materials or undergoes free space propagation including reflections from free space mirrors, spatial focusing from parabolic mirrors or lenses, and nonlinear medium interaction in gas, liquid or solid, or
a waveguide platform, wherein light is guided through waveguides including optical fiber, slab, ridge, channel, buried, diffused, or slot waveguides, or
a hybrid platform including a system with components from one or more of the bulk and waveguide platforms.
15. The system of clause 14 wherein the waveguided platform can be implemented in:
A fiber platform, wherein light is guided through optical fibers including fibers for communication, nonlinear fibers, fiber splitters, a
nanophotonic platform, wherein light is guided through nanophotonic waveguides and systems on a chip (any material platform) including linear and nonlinear waveguides, couplers.
16. The system of any of the clauses 1-15 wherein the system for spectrogram measurement comprises at least one of:
a FROG-based scheme wherein the optical nonlinearity comprises a phase-sensitive parametric amplification process such that the information inferred includes second-order quadrature moments and temporal mode shapes,
a FROG-based scheme wherein the optical nonlinearity comprises a phase-insensitive process, such as sum-frequency generation, such that the information inferred includes the temporal mode shapes and mean photon number per mode,
a FROG-based scheme wherein the optical nonlinearity is a second- or higher-order process in which the state interacts with itself, giving information on fourth- or higher-order operator moments, or
a phase sensitive amplification process followed by sum frequency generation cross FROG wherein the information inferred can include characterization of the phase sensitive amplification process, second order quadrature moments of the input photonic quantum state in the temporal, amplifier, and independent bases, and the temporal mode shapes.
17. The system of any of the clauses wherein the system for spectrogram measurement comprises at least two nonlinear processes, where one or more processes map physical parameters of the input quantum state to other parameters of an intermediate state to prepare the state for spectrographic measurement using a final nonlinear optical process. The physical parameters being mapped may include quadrature information, photon number, frequency, polarization, and/or temporal or spatial characteristics.
18. The system of any of the clauses 14-17, wherein the waveguide design allows for control over the dispersion engineering including low dispersion linear propagation and spectrally broadband nonlinear optical interaction.
19. The system of any of the clauses 1-18, wherein the information retrieval methods can contain:
algorithms whose steps implement generalized projections including principal component analysis, gradient descent, and adaptations of these methods to single- and multi-mode quantum state characterization, or
optimization and estimation techniques such as convex optimization and maximum-likelihood estimation.
20. The system of any of the clauses being used as sub-system for implementing
quantum information processing including continuous variable and discrete variable quantum computation, use of photonic quantum states in neutral atom or hybrid quantum computing hardware,
quantum communication including quantum key distribution, and quantum networks, or
quantum sensing including quantum enhanced spectroscopy, microscopy, interferometry, gyroscopy.
21. A non-transitory computer-readable medium storing instructions that, when executed
by a processor, cause the apparatus or system of any of the clauses 1-20 to perform the
methods or functionalities of any of the clauses 1-20.
22. The system of any of the clauses 1-36 in the first system embodiments implemented using the system of any of the clauses 1-21 in the additional system embodiments.

### REFERENCES

The following references are incorporated by reference herein.

### REFERENCES FOR FIRST AND SECOND EXAMPLES

[1] Charles Bourassin-Bouchet and M-E Couprie. “Partially coherent ultrafast spectrography”. In: Nature communications 6.1 (2015), p. 6465.
[2] Benjamin Brecht et al. “Photon temporal modes: a complete framework for quantum information science”. In: Physical Review X 5.4 (2015), p. 041017.
[3] Andreas Christ et al. “Probing multimode squeezing with correlation functions”. In: New Journal of Physics 13.3 (2011), p. 033027.
[4] Alex O C Davis, Valerian Thiel, and Brian J Smith. “Measuring the quantum state of a photon pair entangled in frequency and time”. In: Optica 7.10 (2020), pp. 1317-1322.
[5] Alex O C Davis et al. “Experimental single-photon pulse characterization by electro-optic shearing interferometry”. In: Physical Review A 98.2 (2018), p. 023840.
[6] Esmerando Escoto et al. “Retrieving the coherent artifact in frequency-resolved optical gating”. In: Optics Letters 44.12 (2019), pp. 3142-3145.
[7] Claude Fabre and Nicolas Treps. “Modes and states in quantum optics”. In: Reviews of Modern Physics 92.3 (2020), p. 035005.
[8] Xueshi Guo et al. “Complete temporal mode analysis in pulse-pumped fiber-optical parametric amplifier for continuous variable entanglement generation”. In: Optics express 23.23 (2015), pp. 2936929383.
[9] Gil Ilan Haham et al. “Multiplexed FROG”. In: Optics Express 25.26 (2017), pp. 33007-33017.
[10] Nan Huo et al. “Direct temporal mode measurement for the characterization of temporally multiplexed high dimensional quantum entanglement in continuous variables”. In: Physical Review Letters 124.21 (2020), p. 213603.
[11] Chris Iaconis and Ian A Walmsley. “Spectral phase interferometry for direct electric-field reconstruction of ultrashort optical pulses”. In: Optics letters 23.10 (1998), pp. 792-794.
[12] Olivier Morin, Claude Fabre, and Julien Laurat. “Experimentally accessing the optimal temporal mode of traveling quantum light states”. In: Physical review letters 111.21 (2013), p. 213602.
[13] Constantina Polycarpou et al. “Adaptive detection of arbitrarily shaped ultrashort quantum light states”. In: Physical review letters 109.5 (2012), p. 053602.
[14] Zhongzhong Qin et al. “Complete temporal characterization of a single photon”. In: Light: Science & Applications 4.6 (2015), e298-e298.
[15] Michelle Rhodes et al. “Pulse-shape instabilities and their measurement”. In: Laser & Photonics Reviews 7.4 (2013), pp. 557-565.
[16] Laura Serino et al. “Self-guided tomography of time-frequency qudits”. In: Quantum Science and Technology (2025).
[17] P R Sharapova et al. “Bright squeezed vacuum in a nonlinear interferometer: Frequency and temporal Schmidt-mode description”. In: Physical Review A 97.5 (2018), p. 053827.
[18] Valery Shchesnovich. “Distinguishability in quantum interference with multimode squeezed states”. In: Physical Review A 105.6 (2022), p. 063703.
[19] Yoshitaka Taguchi and Yasuyuki Ozeki. “Time-domain analysis on the pulsed squeezed vacuum detected with picosecond pulses”. In: JOSA B 37.5 (2020), pp. 1535-1539.
[20] Tobias Witting et al. “Retrieval of attosecond pulse ensembles from streaking experiments using mixed state time-domain ptychography”. In: Journal of Physics B: Atomic, Molecular and Optical Physics 53.19 (2020), p. 194001.
[21] Victor Wong and Ian A Walmsley. “Analysis of ultrashort pulse-shape measurement using linear interferometers”. In: Optics letters 19.4 (1994), pp. 287-289.
[22] Thomas Zacharias et al. “Energy-Efficient Ultrashort-Pulse Characterization using Nanophotonic Parametric Amplification”. In: arXiv preprint arXiv:2501.11152 (2025).
[23] Han-Sen Zhong et al. “Quantum computational advantage using photons”. In: Science 370.6523 (2020), pp. 1460-1463.

### REFERENCES FOR THIRD EXAMPLE AND BACKGROUND

[1] Riek, C., Seletskiy, D. V., Moskalenko, Aₘₑₐₛ. S., Schmidt, J., Krauspe, P., Eckart, S., Eggert, S., Burkard, G., Leitenstorfer, A.: Direct sampling of electric-field vacuum fluctuations. Science 350(6259), 420-423 (2015)
[2] Riek, C., Sulzer, P., Seeger, M., Moskalenko, A. S., Burkard, G., Seletskiy, D. V., Leitenstorfer, A. Nature 541(7637), 376-379 (2017)
[3] Benea-Chelmus, I.-C., Settembrini, F. F., Scalari, G., Faist, J.: Electric field correlation measurements on the electromagnetic vacuum state. Nature 568(7751), 202-206 (2019)
[4] Herman, D. I., Walsh, M., Kreider, M. K., Lordi, N., Tsao, E. J., Lind, A. J., Heyrich, M., Combes, J., Genest, J., Diddams, S. A.: Squeezed dual-comb spectroscopy. Science 387(6734), 653-658 (2025)
[5] Casacio, C. A., Madsen, L. S., Terrasson, A., Waleed, M., Barnscheidt, K, Hage, B., Taylor, M. A., Bowen, W. P. Nature 594(7862), 201-206 (2021)
[6] Siday, T., Hayes, J., Schiegl, F., Sandner, F., Menden, P., Bergbauer, V., Zizlsperger, M., Nerreter, S., Lingl, S., Repp, J., et al.: All-optical subcycle microscopy on atomic length scales. Nature 629(8011), 329-334 (2024)
[7] Rasputnyi, A., Chen, Z., Birk, M., Cohen, O., Kaminer, I., Krüger, M., Seletskiy, D., Chekhova, M., Tani, F.: High-harmonic generation by a bright squeezed vacuum. Nature Physics 20(12), 1960-1965 (2024)
[8] Feist, A., Echternkamp, K. E., Schauss, J., Yalunin, S. V., Schafer, S., Ropers, C.: Quantum coherent optical phase modulation in an ultrafast transmission electron microscope. Nature 521(7551), 200-203 (2015)
[9] Peller, D., Roelcke, C., Kastner, L. Z., Buchner, T., Neef, A., Hayes, J., Bonafé, F., Sidler, D., Ruggenthaler, M., Rubio, A., et al.: Quantitative sampling of atomic-scale electromagnetic waveforms. Nature Photonics 15(2), 143-147 (2021)
[10] Jia, X., Zhai, C., Zhu, X., You, C., Cao, Y., Zhang, X., Zheng, Y., Fu, Z., Mao, J., Dai, T., et al.: Continuous-variable multipartite entanglement in an integrated microcomb. Nature, 1-8 (2025)
[11] Roslund, J., De Araujo, R. M., Jiang, S., Fabre, C., Treps, N. Nature Photonics 8(2), 109-112 (2014)
[12] Kawasaki, A., Brunel, H., Ide, R., Suzuki, T., Kashiwazaki, T., Inoue, A., Umeki, T., Yamashima, T., Sakaguchi, A., Takase, K., et al.: Real-time observation of picosecond-timescale optical quantum entanglement towards ultrafast quantum information processing. Nature Photonics 19(3), 271-276 (2025)
[13] Roh, C., Gwak, G., Yoon, Y.-D., Ra, Y.-S.: Generation of three-dimensional cluster entangled state. Nature Photonics, 1-7 (2025)
[14] Gwak, G., Roh, C., Yoon, Y.-D., Kim, M., Ra, Y.-S.: Completely characterizing multimode second-order nonlinear optical quantum processes. Nature Photonics, 1-7 (2025)
[15] Ra, Y.-S., Dufour, A., Walschaers, M., Jacquard, C., Michel, T., Fabre, C., Treps, N.: Non-gaussian quantum states of a multimode light field. Nature Physics 16(2), 144-147 (2020)
[16] Cai, Y., Roslund, J., Ferrini, G., Arzani, F., Xu, X., Fabre, C., Treps, N.: Multimode entanglement in reconfigurable graph states using optical frequency combs. Nature communications 8(1), 15645 (2017)
[17] Pinel, O., Jian, P., De Araujo, R. M., Feng, J., Chalopin, B., Fabre, C., Treps, N.: Generation and characterization of multimode quantum frequency combs. Physical review letters 108(8), 083601 (2012)
[18] Chen, M., Menicucci, N. C., Pfister, O.: Experimental realization of multipartite entanglement of 60 modes of a quantum optical frequency comb. Physical review letters 112(12), 120505 (2014)
[19] Xie, Z., Zhong, T., Shrestha, S., Xu, X., Liang, J., Gong, Y.-X., Bienfang, J. C., Restelli, A., Shapiro, J. H., Wong, F. N., et al.: Harnessing high-dimensional hyperentanglement through a biphoton frequency comb. Nature Photonics 9(8), 536-542 (2015)
[20] Nehra, R., Sekine, R., Ledezma, L., Guo, Q., Gray, R. M., Roy, A., Marandi, A. Science 377(6612), 1333-1337 (2022)
[21] Yanagimoto, R., Ng, E., Yamamura, A., Onodera, T., Wright, L. G., Jankowski, M., Fejer, M., McMahon, P. L., Mabuchi, H.: Onset of non-gaussian quantum physics in pulsed squeezing with mesoscopic fields. Optica 9(4), 379-390 (2022)
[22] Paparelle, I., Henaff, J., Garcia-Beni, J., Gillet, E., Montesinos, D., Giorgi, G. L., Soriano, M. C., Zambrini, R., Parigi, V.: Experimental memory control in continuous-variable optical quantum reservoir computing. Nature Photonics, 1-8 (2026)
[23] Roman-Rodriguez, V., Fainsin, D., Zanin, G. L., Treps, N., Diamanti, E., Parigi, V.: Multimode squeezed state for reconfigurable quantum networks at telecommunication wavelengths. Physical Review Research 6(4), 043113 (2024)
[24] Kalash, M., Han, U.-N., Ra, Y.-S., Chekhova, M. V.: Efficient detection of spectrally multimode squeezed light through optical parametric amplification. arXiv preprint arXiv:2508.04502 (2025)
[25] Serino, L., Eigner, C., Brecht, B., Silberhorn, C.: Programmable time-frequency mode-sorting of single photons with a multi-output quantum pulse gate. Optics Express 33(3), 5577-5586 (2025)
[26] Polycarpou, C., Cassemiro, K., Venturi, G., Zavatta, A., Bellini, M.: Adaptive detection of arbitrarily shaped ultrashort quantum light states. Physical review letters 109(5), 053602 (2012)
[27] Huo, N., Liu, Y., Li, J., Cui, L., Chen, X., Palivela, R., Xie, T., Li, X., Ou, Z.: Direct temporal mode measurement for the characterization of temporally multiplexed high dimensional quantum entanglement in continuous variables. Physical Review Letters 124(21), 213603 (2020)
[28] Aranjo, R., Roslund, J., Cai, Y., Ferrini, G., Fabre, C., Treps, N.: Full characterization of a highly multimode entangled state embedded in an optical frequency comb using pulse shaping. Physical Review A 89(5), 053828 (2014)
[29] Serino, L., Rambach, M., Brecht, B., Romero, J., Silberhorn, C.: Self-guided tomography of time-frequency qudits. Quantum Science and Technology (2025)
[30] Benea-Chelmus, I.-C., Faist, J., Leitenstorfer, A., Moskalenko, A. S., Pupeza, I., Seletskiy, D. V., Vodopyanov, K. L.: Electro-optic sampling of classical and quantum light. Optica 12(4), 546-563 (2025)
[31] Trebino, R. Springer (2000)
[32] Kane, D. J., Trebino, R.: Characterization of arbitrary femtosecond pulses using frequency-resolved optical gating. IEEE Journal of Quantum Electronics 29(2), 571-579 (2002)
[33] Gu, X., Xu, L., Kimmel, M., Zeek, E., O'Shea, P., Shreenath, A. P., Trebino, R., Windeler, R. S.: Frequency-resolved optical gating and single-shot spectral measurements reveal fine structure in microstructure-fiber continuum. Optics letters 27 (13), 1174-1176 (2002)
[34] Baltuska, A., Pshenichnikov, M. S., Wiersma, D. A.: Amplitude and phase characterization of 4.5-fs pulses by frequency-resolved optical gating. Optics letters 23(18), 1474-1476 (1998)
[35] Wirth, A., Hassan, M. T., Grguras, I., Gagnon, J., Moulet, A., Luu, T. T., Pabst, S., Santra, R., Alahmed, Z., Azzeer, A., et al.: Synthesized light transients. Science 334(6053), 195-200 (2011)
[36] Zhang, J.-y., Shreenath, A. P., Kimmel, M., Zeek, E., Trebino, R., Link, S.: Measurement of the intensity and phase of attojoule femtosecond light pulses using optical-parametric-amplification cross-correlation frequency-resolved optical gating. Optics Express 11(6), 601-609 (2003)
[37] Fittinghoff, D. N., Bowie, J. L., Sweetser, J. N., Jennings, R. T., Krumbugel, M. A., DeLong, K. W., Trebino, R., Walmsley, I. A.: Measurement of the intensity and phase of ultraweak, ultrashort laser pulses. Optics letters 21(12), 884-886 (1996)
[38] Mairesse, Y., Quere, F.: Frequency-resolved optical gating for complete reconstruction of attosecond bursts. Physical Review A: Atomic, Molecular, and Optical Physics 71(1), 011401 (2005)
[39] Eto, Y., Nuriya, M., Kano, H.: Quantum frequency-resolved optical gating measurement for ultranarrow temporal correlation of twin beams. Optica Quantum 2(6), 468-474 (2024)
[40] MacLean, J.-P. W., Schwarz, S., Resch, K. J.: Reconstructing ultrafast energy-time-entangled two-photon pulses. Physical Review A 100(3), 033834 (2019)
[41] Davis, A. O., Thiel, V., Smith, B. J.: Measuring the quantum state of a photon pair entangled in frequency and time. Optica 7(10), 1317-1322 (2020)
[42] Shaked, Y., Michael, Y., Vered, R. Z., Bello, L., Rosenbluh, M., Pe'er, A.: Lifting the bandwidth limit of optical homodyne measurement with broadband parametric amplification. Nature communications 9 (1), 609 (2018)
[43] Takanashi, N., Inoue, A., Kashiwazaki, T., Kazama, T., Enbutsu, K., Kasahara, R., Umeki, T., Furusawa, A.: All-optical phase-sensitive detection for ultra-fast quantum computation. Optics Express 28(23), 34916-34926 (2020)
[44] Wasilewski, W., Lvovsky, A. I., Banaszek, K., Radzewicz, C.: Pulsed squeezed light: Simultaneous squeezing of multiple modes. Physical Review A-Atomic, Molecular, and Optical Physics 73(6), 063819 (2006)
[45] Gray, R. M., Sekine, R., Shen, M., Zacharias, T., Williams, J., Zhou, S., Chawlani, R., Ledezma, L., Englebert, N., Marandi, A.: Two-optical-cycle pulses from nanophotonic two-color soliton compression. arXiv preprint arXiv:2501.15381 (2025)
[46] Witting, T., Furch, F. J., Kornilov, O., Osolodkov, M., Schulz, C. P., Vrakking, M. J.: Retrieval of attosecond pulse ensembles from streaking experiments using mixed state time-domain ptychography. Journal of Physics B: Atomic, Molecular and Optical Physics 53(19), 194001 (2020)
[47] Zeng, Y., He, Z., Guo, X., Zhu, G., Zhu, X.: Deep learning reconstruction algorithm for frequency-resolved optical gating. Optics Letters 49(13), 3741-3744 (2024)
[48] Zacharias, T., Gray, R., Sekine, R., Williams, J., Zhou, S., Marandi, A.: Energy-efficient ultrashort-pulse characterization using nanophotonic parametric amplification. arXiv preprint arXiv:2501.11152 (2025)
[49] Yu, H., Lun, Y., Lin, J., Li, Y., Huang, X., Liu, B., Wu, W., Wang, C., Cheng, Y., Li, Z.-y., et al.: Frequency-resolved optical gating in transverse geometry for on-chip optical pulse diagnostics. Laser & Photonics Reviews 17(12), 2201017 (2023)
[50] Kane, D. J., Trebino, R.: Single-shot measurement of the intensity and phase of an arbitrary ultrashort pulse by using frequency-resolved optical gating. Optics letters 18(10), 823-825 (1993)
[51] Zhang, J.-Y., Lee, C.-K., Huang, J. Y., Pan, C.-L.: Sub femto-joule sensitive single-shot opa-xfrog and its application in study of white-light supercontinuum generation. Optics Express
   12(4), 574-581 (2004)
[52] Arzani, F., Fabre, C., Treps, N.: Versatile engineering of multimode squeezed states by optimizing the pump spectral profile in spontaneous parametric downconversion. Physical Review A 97(3),033808 (2018)
[53] Hurvitz, I., Karnieli, A., Arie, A.: Frequency-domain engineering of bright squeezed vacuum for continuous-variable quantum information. Optics Express 31(12), 20387-20397 (2023)
[54] Ou, Z.: Enhancement of the phase-measurement sensitivity beyond the standard quantum limit by a nonlinear interferometer. Physical Review A: Atomic, Molecular, and Optical Physics 85(2), 023815 (2012)
[55] Escoto, E., Jafari, R., Trebino, R., Steinmeyer, G.: Retrieving the coherent artifact in frequency-resolved optical gating. Optics Letters 44(12), 3142-3145 (2019)
[56] Rhodes, M., Steinmeyer, G., Ratner, J., Trebino, R.: Pulse-shape instabilities and their measurement. Laser & Photonics Reviews 7(4), 557-565 (2013)
[57] Haham, G. I., Sidorenko, P., Lahav, O., Cohen, O.: Multiplexed frog. Optics Express 25(26),
   33007-33017 (2017)
[58] Bourassin-Bouchet, C., Couprie, M.-E.: Partially coherent ultrafast spectrography. Nature communications 6(1),6465 (2015)
[59] Williams, J., Sendonaris, E., Nehra, R., Gray, R. M., Sekine, R., Ledezma, L., Marandi, A.: Ultrafast all-optical measurement of squeezed vacuum in a lithium niobate nanophotonic circuit. Physical Review Research 7(4), 043006 (2025)
[60] J. Tiedau, V. S. Shchesnovich, D. Mogilevtsev, V. Ansari, G. Harder, T. J. Bartley, N. Korolkova, and C. Silberhorn, Quantum state and mode profile tomography by the overlap, New Journal of Physics 20, 033003 (2018).
[61] J. Gil-Lopez, Y. S. Teo, S. De, B. Brecht, H. Jeong, C. Silberhorn, and L. L. Sanchez-Soto, Universal compressive tomography in the time-frequency domain, Optica 8, 1296 (2021).
[62] L. Serino, J. Gil-Lopez, M. Stefszky, R. Ricken, C. Eigner, B. Brecht, and C. Silberhorn, Realization of a multi-output quantum pulse gate for decoding high-dimensional temporal modes of single-photon states, PRX Quantum 4, 020306 (2023).
[63] L. Serino, W. Ridder, A. Bhattacharjee, J. Gil-Lopez, B. Brecht, and C. Silberhorn, Orchestrating time and color: a programmable source of high-dimensional entanglement, Optica Quantum 2, 339 (2024).
[64] A. Karnieli, P.-A. Mor, C. Roques-Carmes, E. Lustig, J. Sloan, J. Vuckovid, D. A. B. Miller, and S. Fan, Variational processing of multimode squeezed light (2025), 2509.16753 [quant-ph].

### REFERENCES FOR THIRD EXAMPLE (SUPPLEMENTAL SECTION)

[1] Fabre, C., Treps, N.: Modes and states in quantum optics. Reviews of Modern Physics 92(3), 035005 (2020)
[2] Wasilewski, W., Lvovsky, A. I., Banaszek, K., Radzewicz, C.: Pulsed squeezed light: Simultaneous squeezing of multiple modes. Physical Review A-Atomic, Molecular, and Optical Physics 73(6), 063819 (2006)
[3] Trebino, R. Springer (2000)
[4] Perez, A., Iskhakov, T. S., Sharapova, P., Lemieux, S., Tikhonova, O., Chekhova, M., Leuchs, G.: Bright squeezed-vacuum source with 1.1 spatial mode. Optics Letters 39(8), 2403-2406 (2014)
[5] Sharapova, P., Perez, A. M., Tikhonova, O. V., Chekhova, M. V.: Schmidt modes in the angular spectrum of bright squeezed vacuum. Physical Review A 91(4), 043816 (2015)
[6] Sharapova, P., Tikhonova, O., Lemieux, S., Boyd, R., Chekhova, M.: Bright squeezed vacuum in a nonlinear interferometer: Frequency and temporal schmidtmode description. Physical Review A 97(5), 053827 (2018)
[7] Zacharias, T., Gray, R., Sekine, R., Williams, J., Zhou, S., Marandi, A.: Energy-efficient ultrashort-pulse characterization using nanophotonic parametric amplification. arXiv preprint arXiv:2501.11152 (2025)
[8] Stibenz, G., Steinmeyer, G.: Interferometric frequency-resolved optical gating. Optics express 13(7), 2617-2626 (2005)
[9] Gray, R. M., Sekine, R., Shen, M., Zacharias, T., Williams, J., Zhou, S., Chawlani, R., Ledezma, L., Englebert, N., Marandi, A.: Two-optical-cycle pulses from nanophotonic two-color soliton compression. arXiv preprint arXiv: 2501.15381 (2025)
[10] Simon, R., Mukunda, N., Dutta, B.: Quantum-noise matrix for multimode systems: U (n) invariance, squeezing, and normal forms. Physical Review A 49(3), 1567 (1994)
[11] Cai, Y., Roslund, J., Ferrini, G., Arzani, F., Xu, X., Fabre, C., Treps, N.: Multimode entanglement in reconfigurable graph states using optical frequency combs. Nature communications 8(1), 15645 (2017)
[12] Shaked, Y., Michael, Y., Vered, R. Z., Bello, L., Rosenbluh, M., Pe'er, A.: Lifting the bandwidth limit of optical homodyne measurement with broadband parametric amplification. Nature communications 9 (1), 609 (2018).

### References Fourth Example

[1] J. L. O'Brien, Optical quantum computing, Science 318, 1567 (2007).
[2] W. Asavanant, Y. Shiozawa, S. Yokoyama, B. Charoensombutamon, H. Emura, R. N. Alexander, S. Takeda, J.-i. Yoshikawa, N. C. Menicucci, H. Yonezawa, and A. Furusawa, Generation of time-domain-multiplexed two-dimensional cluster state, Science 366, 373 (2019).
[3] M. V. Larsen, X. Guo, C. R. Breum, J. S. NeergaardNielsen, and U. L. Andersen, Deterministic generation of a two-dimensional cluster state, Science 366, 369 (2019).
[4] H.-S. Zhong, H. Wang, Y.-H. Deng, M.-C. Chen, L.-C. Peng, Y.-H. Luo, J. Qin, D. Wu, X. Ding, Y. Hu, P. Hu, X.-Y. Yang, W.-J. Zhang, H. Li, Y. Li, X. Jiang, L. Gan, G. Yang, L. You, Z. Wang, L. Li, N.-L. Liu, C.-Y. Lu, and J.-W. Pan, Quantum computational advantage using photons, Science 370, 1460 (2020).
[5] S. Pirandola, U. L. Andersen, L. Banchi, M. Berta, D. Bunandar, R. Colbeck, D. Englund, T. Gehring,
C. Lupo, C. Ottaviani, J. L. Pereira, M. Razavi, J. S. Shaari, M. Tomamichel, V. C. Usenko, G. Vallone, P. Villoresi, and P. Wallden, Advances in quantum cryptography, Advances in Optics and Photonics 12, 1012 (2020).
[6] M. V. Larsen, J. E. Bourassa, S. Kocsis, J. F. Tasker, R. S. Chadwick, C. Gonzilez-Arciniegas, J. Hastrup, C. E. Lopetegui-Gonzilez, F. M. Miatto, A. Motamedi, R. Noro, G. Roeland, R. Baby, H. Chen, P. Contu, I. Di Luch, C. Drago, M. Giesbrecht, T. Grainge, I. Krasnokutska, M. Menotti, B. Morrison, C. Puviraj, K. Rezaei Shad, B. Hussain, J. McMahon, J. E. Ortmann, M. J. Collins, C. Ma, D. S. Phillips, M. Seymour, Q. Y. Tang, B. Yang, Z. Vernon, R. N. Alexander, and D. H. Mahler, Integrated photonic source of gottesman-kitaev-preskill qubits, Nature 642, 587 (2025).
[7] B. Brecht, D. V. Reddy, C. Silberhorn, and M. Raymer, Photon temporal modes: A complete framework for quantum information science, Physical Review X 5, 041017 (2015).
[8] L. Serino, W. Ridder, A. Bhattacharjee, J. Gil-Lopez, B. Brecht, and C. Silberhorn, Orchestrating time and color: a programmable source of high-dimensional entanglement, Optica Quantum 2, 339 (2024).
[9] L. Cruz-Rodriguez, D. Dey, A. Freibert, and P. Stammer, Quantum phenomena in attosecond science, Nature Reviews Physics 6, 691 (2024).
[10] M. E. Tzur, C. Mor, N. Yaffe, M. Birk, A. Rasputnyi, O. Kneller, I. Nisim, I. Kaminer, M. Chekhova, M. Krueger, M. Ivanov, N. Dudovich, and O. Cohen, Attosecond-resolved quantum fluctuations of light and matter (2025), 2511.18362 [physics].
[11] M. E. Tzur, C. Mor, N. Yaffe, M. Birk, A. Rasputnyi, O. Kneller, I. Nisim, I. Kaminer, M. Krüger, N. Dudovich, et al., Measuring and controlling the birth of quantum attosecond pulses, arXiv preprint arXiv: 2502.09427 (2025).
[12] N. C. Menicucci, P. Van Loock, M. Gu, C. Weedbrook, T. C. Ralph, and M. A. Nielsen, Universal quantum computation with continuous-variable cluster states, Physical Review Letters 97, 110501 (2006).
[13] N. C. Menicucci, Fault-tolerant measurement-based quantum computing with continuous-variable cluster states, Physical Review Letters 112, 120504 (2014).
[14] T. C. Ralph, Continuous variable quantum cryptography, Physical Review A 61, 010303 (1999).
[15] A. Leverrier and P. Grangier, Unconditional security proof of long-distance continuous-variable quantum key distribution with discrete modulation, Physical Review Letters 102, 180504 (2009).
[16] J. Williams, E. Sendonaris, R. Nehra, R. M. Gray, R. Sekine, L. Ledezma, and A. Marandi, Ultrafast all-optical measurement of squeezed vacuum in a lithium niobate nanophotonic circuit, Physical Review Research 7, 043006 (2025).
[17] I. Barakat, M. Kalash, D. Scharwald, P. Sharapova, N. Lindlein, and M. Chekhova, Simultaneous measurement of multimode squeezing through multimode phase-sensitive amplification, Optica Quantum 3, 36 (2025).
[18] M. Kalash, U.-N. Han, Y.-S. Ra, and M. V. Chekhova, Efficient detection of spectrally multimode squeezed light through optical parametric amplification (2025), 2508.04502 [quant-ph].
[19] W. Wasilewski, A. I. Lvovsky, K. Banaszek, and C. Radzewicz, Pulsed squeezed light: Simultaneous squeezing of multiple modes, Physical Review A 73, 063819 (2006).
[20] Y. Shaked, Y. Michael, R. Z. Vered, L. Bello, M. Rosenbluh, and A. Pe'er, Lifting the bandwidth limit of optical homodyne measurement with broadband parametric amplification, Nature Communications 9, 609 (2018).
[21] R. Nehra, R. Sekine, L. Ledezma, Q. Guo, R. M. Gray, A. Roy, and A. Marandi, Few-cycle vacuum squeezing in nanophotonics, Science 377, 1333 (2022).
[22] M. Kalash and M. V. Chekhova, Wigner function tomography via optical parametric amplification, Optica 10, 1142 (2023).
[23] L. Ledezma, R. Sekine, Q. Guo, R. Nehra, S. Jahani, and A. Marandi, Intense optical parametric amplification in dispersion-engineered nanophotonic lithium niobate waveguides, Optica 9, 303 (2022).
[24] E. Ng, R. Yanagimoto, M. Jankowski, M. M. Fejer, and H. Mabuchi, Quantum noise dynamics in nonlinear pulse propagation (2023), 2307.05464 [physics, physics:quantph].
[25] Y. Cai, J. Roslund, G. Ferrini, F. Arzani, X. Xu, C. Fabre, and N. Treps, Multimode entanglement in reconfigurable graph states using optical frequency combs, Nature Communications 8, 15645 (2017).
[26] C. Polycarpou, Adaptive detection of arbitrarily shaped ultrashort quantum light states, Physical Review Letters 109, 10.1103/PhysRevLett. 109.053602 (2012).
[27] A. Karnieli, P.-A. Mor, C. Roques-Carmes, E. Lustig, J. Sloan, J. Vuckovid, D. A. B. Miller, and S. Fan, Variational processing of multimode squeezed light (2025), 2509.16753 [quant-ph].
[28] J. Tiedau, V. S. Shchesnovich, D. Mogilevtsev, V. Ansari, G. Harder, T. J. Bartley, N. Korolkova, and C. Silberhorn, Quantum state and mode profile tomography by the overlap, New Journal of Physics 20, 033003 (2018).
[29] K. Takase, M. Okada, T. Serikawa, S. Takeda, J.-i. Yoshikawa, and A. Furusawa, Complete temporal mode characterization of non-gaussian states by a dual homodyne measurement, Physical Review A 99, 033832 (2019).
[30] J. Gil-Lopez, Y. S. Teo, S. De, B. Brecht, H. Jeong, C. Silberhorn, and L. L. Sanchez-Soto, Universal compressive tomography in the time-frequency domain, Optica 8, 1296 (2021).
[31] L. Serino, J. Gil-Lopez, M. Stefszky, R. Ricken, C. Eigner, B. Brecht, and C. Silberhorn, Realization of a multi-output quantum pulse gate for decoding highdimensional temporal modes of single-photon states, PRX Quantum 4, 020306 (2023).
[32] L. Serino, W. Ridder, A. Bhattacharjee, J. Gil-Lopez, B. Brecht, and C. Silberhorn, Orchestrating time and color: a programmable source of high-dimensional entanglement, Optica Quantum 2, 339 (2024).
[33] L. Serino, M. Rambach, B. Brecht, J. Romero, and C. Silberhorn, Self-guided tomography of time-frequency qudits, Quantum Science and Technology 10, 025024 (2025).
[34] C. Riek, P. Sulzer, M. Seeger, A. S. Moskalenko, G. Burkard, D. V. Seletskiy, and A. Leitenstorfer, Subcycle quantum electrodynamics, Nature 541, 376 (2017).
[35] G. Yang, M. Kizmann, A. Leitenstorfer, and A. S. Moskalenko, Subcycle tomography of quantum light (2023), 2307.12812 [physics, physics: quant-ph].
[36] E. Hubenschmid, T. L. Guedes, and G. Burkard, Optical time-domain quantum state tomography on a subcycle scale, Physical Review X 14, 041032 (2024).
[37] E. Hubenschmid and G. Burkard, Time-domain field correlation measurements enable tomography of highly multimode quantum states of light (2025), 2506.10483 [quant-ph].
[38] J. Roslund, R. M. de Aranjo, S. Jiang, C. Fabre, and N. Treps, Wavelength-multiplexed quantum networks with ultrafast frequency combs, Nature Photonics 8, 109 (2014).
[39] R. Trebino, Frequency-Resolved Optical Gating: The Measurement of Ultrashort Laser Pulses (Springer US, 2000).
[40] J.-y. Zhang, A. Shreenath, M. Kimmel, E. Zeek, R. Trebino, and S. Link, Measurement of the intensity and phase of attojoule femtosecond light pulses using optical-parametric-amplification cross-correlation frequency-resolved optical gating, Optics Express 11, 601 (2003).
[41] J.-Y. Zhang, C.-K. Lee, J. Y. Huang, and C.-L. Pan, Sub femto-joule sensitive single-shot OPA-XFROG and its application in study of white-light supercontinuum generation, Optics Express 12, 574 (2004).
[42] T. Zacharias, R. Gray, R. Sekine, J. Williams, S. Zhou, and A. Marandi, Energy-efficient ultrashort-pulse characterization using nanophotonic parametric amplification, ACS Photonics
   12, 1316 (2025).
[43] Y. Eto, M. Nuriya, and H. Kano, Quantum frequencyresolved optical gating measurement for ultranarrow temporal correlation of twin beams, Optica Quantum 2, 468 (2024).
[44] T. Zacharias, R. Gray, E. Sendonaris, J. Williams, M. Shen, S. Zhou, and A. Marandi, Temporal characterization of ultrashort-pulse squeezed vacuum using frequency resolved optical gating, in 2025 Conference on Lasers and Electro-Optics (CLEO) (IEEE, 2025) pp. 12.
[45] C. Fabre and N. Treps, Modes and states in quantum optics, Reviews of Modern Physics 92, 035005 (2020).
[46] C. Bourassin-Bouchet and M.-E. Couprie, Partially coherent ultrafast spectrography, Nature Communications 6, 6465 (2015).
[47] Z. Wang, E. Zeek, R. Trebino, and P. Kvam, Beyond error bars: Understanding uncertainty in ultrashort-pulse frequency-resolved-optical-gating measurements in the presence of ambiguity, Optics Express 11, 3518 (2003).

### References Fourth Example Supplementary Information

[1] A. I. Lvovsky, Reviews of Modern Physics 81, 299 (2009).
[2] C. Bourassin-Bouchet and M.-E. Couprie, Nature Communications 6, 6465 (2015), ISSN 2041-1723, URL lus/wwntr o/rce/cms45
[3] R. Trebino, Frequency-Resolved Optical Gating: The Measurement of Ultrashort Laser Pulses (Springer US, 2000), ISBN 978-1-4613-5432-1 978-1-4615-1181-6, URL http://link.springer. com/10.1007/978-1-4615-1181-6.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system, comprising:
an optical system outputting a spectrogram comprising time dependent magnitudes of frequency components in response to, and dependent on, an input photonic quantum state; and
a processor inferring information about the input photonic quantum state from the spectrogram, wherein the information includes temporal and/or frequency structure and/or quantum state information about the input photonic quantum state.

2. The system of claim 1, wherein the optical system comprises:
a delay mechanism delaying the input photonic quantum state relative to an auxiliary photonic state;
one or more nonlinear media interacting the input photonic state and the auxiliary photonic state states through one or more nonlinear optical processes to generate a third photonic state; and
a spectrometer measuring the spectrum of the third photonic state for different relative delays.

3. The system of claim 1 wherein the inferring comprises the processor executing an algorithm through non-iterative, iterative, phase-retrieval, machine learning, or deep learning techniques.

4. The system of claim 1 wherein the processor calculates quantum state properties by comparing the measured spectrogram to a calculated spectrogram using optimization, estimation, or inverse methods.

5. The system of claim 2, wherein the delay mechanism comprises a mechanically moving stage.

6. The system of claim 2, wherein the delay mechanism is produced using a photonic dual-comb configuration.

7. The system of claim 2, wherein the delay mechanism further comprises a system to map temporal delays to distinct spatial locations.

8. The system of claim 2 wherein auxiliary photonic state is a copy of the input photonic quantum state, Gaussian or non-Gaussian, and may or may not be characterized apriori.

9. The system of claim 2 wherein the spectrometer can measure the spectrum of the third photonic state in the photon number basis using one or more single photon detectors or one or more photon number resolving detectors.

10. The system of claim 2 wherein the spectrometer can measure the spectrum of the third photonic state in a quadrature basis using homodyne, heterodyne, or a phase-sensitive nonlinear interaction with auxiliary radiation as a local oscillator/gate/pump.

11. The system in claim 2 wherein the spectrometer is operable to measure the spectrogram in a pulse-by-pulse format and wherein at least one of the photonic states comprises periodic pulses.

12. The system in claim 2 wherein the temporal delays are mapped to distinct spatial locations within a nonlinear crystal followed by an imaging spectrometer that measures the spectrogram of the resulting photonic state.

13. The system of claim 2 wherein the optical system comprises one or more of the nonlinear media implementing at least two nonlinear processes, where one or more of the nonlinear processes map physical parameters of the input quantum state to physical parameters of intermediate states generated through these processes to prepare the state for spectrographic measurement using a final nonlinear optical process, wherein physical parameters being mapped include at least one of quadrature information, photon number, frequency, polarization, temporal characteristics, or spatial characteristics.

14. The system of claim 1 wherein the optical system comprises a Frequency Resolved Optical Gating (FROG)- based scheme comprising a nonlinear medium wherein the optical nonlinear process comprises a phase-sensitive parametric amplification process such that the information inferred includes the expectation values of second order polynomials of quadrature operators (second-order quadrature moments) and the complex temporal envelope describing a temporally localized quantum state (temporal mode profiles).

15. The system of claim 1 wherein the optical system comprises a FROG-based scheme comprising a nonlinear medium wherein the nonlinear optical process comprises a phase-insensitive process, such as sum-frequency generation, such that the information inferred includes the temporal mode profiles and mean photon number per mode.

16. The system of claim 1 wherein the optical system comprises a FROG-based scheme comprising a nonlinear medium wherein the nonlinear process is a second- or higher-order process in which the state interacts with itself, giving information on fourth- or higher-order operator moments.

17. The system of claim 1 wherein the optical system comprises one or more nonlinear media wherein the input photonic state goes through a phase sensitive amplification process followed by sum frequency generation cross-FROG wherein the information inferred includes at least one of (1) characterization of the phase sensitive amplification process, (2) characterization of the second order quadrature moments of the input photonic quantum state in the temporal, amplifier, and/or independent bases, or (3) the temporal mode profiles.

18. The system of claim 2 wherein the information extracted can characterize the auxiliary photonic state used for the spectrogram measurement.

19. The system of claim 1 wherein the information extracted can include correlations of multimode annihilation and quadrature operators in the temporal, frequency, independent, or an arbitrary basis along with the associated unitary transformations describing the associated mode profiles.

20. The system of claim 1 wherein the information extracted can include multimode entanglement criteria and entanglement structure reconstruction including those for Gaussian or non-Gaussian states.

21. The system of claim 1 wherein the information extracted can include a quantum quasi-probability distribution function, such as the Wigner, Q-, and/or P-function.

22. The system of claim 1 configured or implemented as sub-system for implementing quantum information processing, communication, or sensing.
